(19) United States
(12) Patent Application Publication
(10) Pub. No.: US 2021/0294496 A1
(43) Pub. Date: Sep. 23, 2021

(54) DATA MIRRORING SYSTEM

(71) Applicant: Dell Products L.P., Round Rock, TX (US)

(72) Inventors: Gary Benedict Kotzur, Austin, TX (US); William Emmett Lynn, Round Rock, TX (US); Kevin Thomas Marks, Georgetown, TX (US); Chandrashekar Nelogal, Round Rock, TX (US); James Peter Giannoules, Round Rock, TX (US); Austin Patrick Bolen, Austin, TX (US)

(21) Appl. No.: 16/823,072

(22) Filed: Mar. 18, 2020

(51) Int. Cl. G06F 3/06; G06F 15/173

(52) U.S. Cl. CPC G06F 3/065; G06F 15/17331; G06F 3/0688; G06F 3/0619

(57) ABSTRACT

A data mirroring system includes a primary computing device with a primary memory system, a primary storage system, and a primary communication system. The primary computing device writes data to the primary memory system, copies the data from the primary memory system to the primary storage system, and transmits the data using the primary communication system. A secondary computing device is coupled to the primary computing device, includes a secondary memory system, a secondary storage system having a secondary buffer subsystem and a secondary storage subsystem, and a secondary communication system. The secondary computing system receives the data at the secondary communication system, performs a remote direct memory access operation to write the data to the secondary buffer subsystem such that the data is not stored in the secondary memory system, and copies the data from the secondary buffer subsystem to the secondary storage subsystem.

### BACKGROUND

The present disclosure relates generally to information handling systems, and more particularly to mirroring data in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems sometimes utilize data mirroring in order to store redundant copies of data to allow for access to that data in the event of the unavailability of a storage device or computing device upon which that data is stored. For example, a Redundant Array of Independent Disk (RAID) storage system may mirror data on multiple RAID data storage devices so that the data is accessible in the event one of the RAID data storage device upon which that data is stored becomes unavailable. Similarly, Software Defined Storage (SDS) systems may mirror data on multiple computing devices (also called computing “nodes”) so that the data is accessible in the event one of the computing devices upon which that data is stored becomes unavailable. However, the inventors of the present disclosure have found that conventional data mirroring operations are inefficient.

For example, in the RAID storage systems discussed above (e.g., provided in a RAID 1-10 configuration), data mirroring operations may include the RAID storage controller device receiving a write command from a host system and, in response, copying associated data from the host system to a RAID storage controller storage subsystem in the RAID storage controller device. Subsequently, the RAID storage controller device may issue a first command to a first RAID data storage device to retrieve the data from the RAID storage controller storage subsystem in the RAID storage controller device and write that data to a first storage subsystem in the first RAID data storage device, and the RAID storage controller device may also issue a second command to a second RAID data storage device to retrieve the data from the RAID storage controller storage subsystem in the RAID storage controller device and write that data to a second storage subsystem in the second RAID data storage device. As such, data mirroring in such RAID storage systems can be relatively processing and memory intensive for the RAID storage controller device.

In another example, in the SDS systems discussed above, data may be saved by first writing that data to a memory system in a primary computing device, with the primary computing device writing that data from the memory system in the primary computing device to a storage system in the primary computing device. The Transmission Control Protocol (TCP) or Remote Direct Memory Access (RDMA)-based protocols may be utilized to mirror that data to a second computing device by providing that data from the memory system in the primary computing device to the secondary computing device and writing that data to a memory system in the secondary computing device, with the secondary computing device then writing that data from the memory system in the secondary computing device to a storage system in the secondary memory device. As such, data mirroring in such SDS systems can involve a relatively high number of data transfers and memory access operations.

Accordingly, it would be desirable to provide a data mirroring system that addresses the issues discussed above.

### SUMMARY

According to one embodiment, an Information Handling System (IHS) includes a chassis; a Software Defined Storage (SDS) processing system that is included in the chassis; and an SDS memory subsystem that is included in the chassis, coupled to the SDS processing system, and that includes instructions that, when executed by the SDS processing system, cause the SDS processing system to provide a data mirroring engine that is configured to: receive, from a primary computing device via a communication system that is included in the chassis, data that has been stored in the primary computing device; perform a remote direct memory access operation to write the data to a buffer subsystem in a storage system that is included in the chassis such that the data is not stored in a main memory subsystem that is included in the chassis; and copy the data from the buffer subsystem in the storage system to a storage subsystem in the storage system.

### BRIEF DESCRIPTION OF THE DRAWINGS

FIG. 1 is a schematic view illustrating an embodiment of an Information Handling System (IHS).

FIG. 2A is a schematic view illustrating an embodiment of a RAID data mirroring system in a first configuration.

FIG. 2B is a schematic view illustrating an embodiment of a RAID data mirroring system in a second configuration.

FIG. 3 is a schematic view illustrating an embodiment of a RAID data storage device that may be provided in the RAID data mirroring systems of FIGS. 2A and 2B.

FIG. 4 is a schematic view illustrating an embodiment of a RAID storage controller device that may be provided in the RAID data mirroring systems of FIGS. 2A and 2B.

FIG. 5A is a schematic view illustrating an embodiment of the RAID data mirroring system of FIG. 2A performing conventional data mirroring operations.

FIG. 5B is a schematic view illustrating an embodiment of the RAID data mirroring system of FIG. 2A performing conventional data mirroring operations.

FIG. 5C is a schematic view illustrating an embodiment of the RAID data mirroring system of FIG. 2A performing conventional data mirroring operations.

FIG. 5D is a schematic view illustrating an embodiment of the RAID data mirroring system of FIG. 2A performing conventional data mirroring operations.

FIG. 5E is a schematic view illustrating an embodiment of the RAID data mirroring system of FIG. 2A performing conventional data mirroring operations.

FIG. 5F is a schematic view illustrating an embodiment of the RAID data mirroring system of FIG. 2A performing conventional data mirroring operations.

FIG. 5G is a schematic view illustrating an embodiment of the RAID data mirroring system of FIG. 2A performing conventional data mirroring operations.

FIG. 5H is a schematic view illustrating an embodiment of the RAID data mirroring system of FIG. 2A performing conventional data mirroring operations.

FIG. 5I is a schematic view illustrating an embodiment of the RAID data mirroring system of FIG. 2A performing conventional data mirroring operations.

FIG. 6A is a schematic view illustrating an embodiment of the RAID data mirroring system of FIG. 2B performing conventional data mirroring operations.

FIG. 6B is a schematic view illustrating an embodiment of the RAID data mirroring system of FIG. 2B performing conventional data mirroring operations.

FIG. 6C is a schematic view illustrating an embodiment of the RAID data mirroring system of FIG. 2B performing conventional data mirroring operations.

FIG. 6D is a schematic view illustrating an embodiment of the RAID data mirroring system of FIG. 2B performing conventional data mirroring operations.

FIG. 6E is a schematic view illustrating an embodiment of the RAID data mirroring system of FIG. 2B performing conventional data mirroring operations.

FIG. 6F is a schematic view illustrating an embodiment of the RAID data mirroring system of FIG. 2B performing conventional data mirroring operations.

FIG. 6G is a schematic view illustrating an embodiment of the RAID data mirroring system of FIG. 2B performing conventional data mirroring operations.

FIG. 6H is a schematic view illustrating an embodiment of the RAID data mirroring system of FIG. 2B performing conventional data mirroring operations.

FIG. 6I is a schematic view illustrating an embodiment of the RAID data mirroring system of FIG. 2B performing conventional data mirroring operations.

FIG. 7 is a flow chart illustrating an embodiment of a method for performing data mirroring in a RAID data mirroring system.

FIG. 8A is a schematic view illustrating an embodiment of the RAID data mirroring system of FIG. 2A operating during the method of FIG. 7.

FIG. 8B is a schematic view illustrating an embodiment of the RAID data mirroring system of FIG. 2A operating during the method of FIG. 7.

FIG. 8C is a schematic view illustrating an embodiment of the RAID storage controller device of FIG. 4 operating during the method of FIG. 7.

FIG. 8D is a schematic view illustrating an embodiment of the RAID data mirroring system of FIG. 2A operating during the method of FIG. 7.

FIG. 8E is a schematic view illustrating an embodiment of the RAID data mirroring system of FIG. 2A operating during the method of FIG. 7.

FIG. 8F is a schematic view illustrating an embodiment of the RAID data storage device of FIG. 3 operating during the method of FIG. 7.

FIG. 8G is a schematic view illustrating an embodiment of the RAID data mirroring system of FIG. 2A operating during the method of FIG. 7.

FIG. 8H is a schematic view illustrating an embodiment of the RAID data mirroring system of FIG. 2A operating during the method of FIG. 7.

FIG. 8I is a schematic view illustrating an embodiment of the RAID data mirroring system of FIG. 2A operating during the method of FIG. 7.

FIG. 8J is a schematic view illustrating an embodiment of the RAID data storage device of FIG. 3 operating during the method of FIG. 7.

FIG. 8K is a schematic view illustrating an embodiment of the RAID data mirroring system of FIG. 2A operating during the method of FIG. 7.

FIG. 8L is a schematic view illustrating an embodiment of the RAID data mirroring system of FIG. 2A operating during the method of FIG. 7.

FIG. 9A is a schematic view illustrating an embodiment of the RAID data mirroring system of FIG. 2B operating during the method of FIG. 7.

FIG. 9B is a schematic view illustrating an embodiment of the RAID data mirroring system of FIG. 2B operating during the method of FIG. 7.

FIG. 9C is a schematic view illustrating an embodiment of the RAID data mirroring system of FIG. 2B operating during the method of FIG. 7.

FIG. 9D is a schematic view illustrating an embodiment of the RAID data storage device of FIG. 3 operating during the method of FIG. 7.

FIG. 9E is a schematic view illustrating an embodiment of the RAID data mirroring system of FIG. 2B operating during the method of FIG. 7.

FIG. 9F is a schematic view illustrating an embodiment of the RAID data mirroring system of FIG. 2B operating during the method of FIG. 7.

FIG. 9G is a schematic view illustrating an embodiment of the RAID data mirroring system of FIG. 2B operating during the method of FIG. 7.

FIG. 9H is a schematic view illustrating an embodiment of the RAID data storage device of FIG. 3 operating during the method of FIG. 7.

FIG. 9I is a schematic view illustrating an embodiment of the RAID data mirroring system of FIG. 2B operating during the method of FIG. 7.

FIG. 9J is a schematic view illustrating an embodiment of the RAID data mirroring system of FIG. 2B operating during the method of FIG. 7.

FIG. 10 is a schematic view illustrating an embodiment of an SDS data mirroring system.

FIG. 11A is a schematic view illustrating the SDS data mirroring system of FIG. 10 performing conventional data mirroring operations.

FIG. 11B is a schematic view illustrating the SDS data mirroring system of FIG. 10 performing conventional data mirroring operations.

FIG. 11C is a schematic view illustrating the SDS data mirroring system of FIG. 10 performing conventional data mirroring operations.

FIG. 11D is a schematic view illustrating the SDS data mirroring system of FIG. 10 performing conventional data mirroring operations.

FIG. 12A is a schematic view illustrating the SDS data mirroring system of FIG. 10 performing conventional data recovery/rebuild/rebalance operations.

FIG. 12B is a schematic view illustrating the SDS data mirroring system of FIG. 10 performing conventional data recovery/rebuild/rebalance operations.

FIG. 12C is a schematic view illustrating the SDS data mirroring system of FIG. 10 performing conventional data recovery/rebuild/rebalance operations.

FIG. 12D is a schematic view illustrating the SDS data mirroring system of FIG. 10 performing conventional data recovery/rebuild/rebalance operations.

FIG. 13 is a flow chart illustrating an embodiment of a method for performing data mirroring in an SDS data mirroring system.

FIG. 14A is a schematic view illustrating the SDS data mirroring system of FIG. 10 operating during the method of FIG. 13.

FIG. 14B is a schematic view illustrating the SDS data mirroring system of FIG. 10 operating during the method of FIG. 13.

FIG. 14C is a schematic view illustrating the SDS data mirroring system of FIG. 10 operating during the method of FIG. 13.

FIG. 14D is a schematic view illustrating the SDS data mirroring system of FIG. 10 operating during the method of FIG. 13.

FIG. 15 is a flow chart illustrating an embodiment of a method for performing data recovery/rebuild/rebalance in an SDS data mirroring system.

FIG. 16A is a schematic view illustrating the SDS data mirroring system of FIG. 10 operating during the method of FIG. 15.

FIG. 16B is a schematic view illustrating the SDS data mirroring system of FIG. 10 operating during the method of FIG. 15.

FIG. 16C is a schematic view illustrating the SDS data mirroring system of FIG. 10 operating during the method of FIG. 15.

FIG. 16D is a schematic view illustrating the SDS data mirroring system of FIG. 10 operating during the method of FIG. 15.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

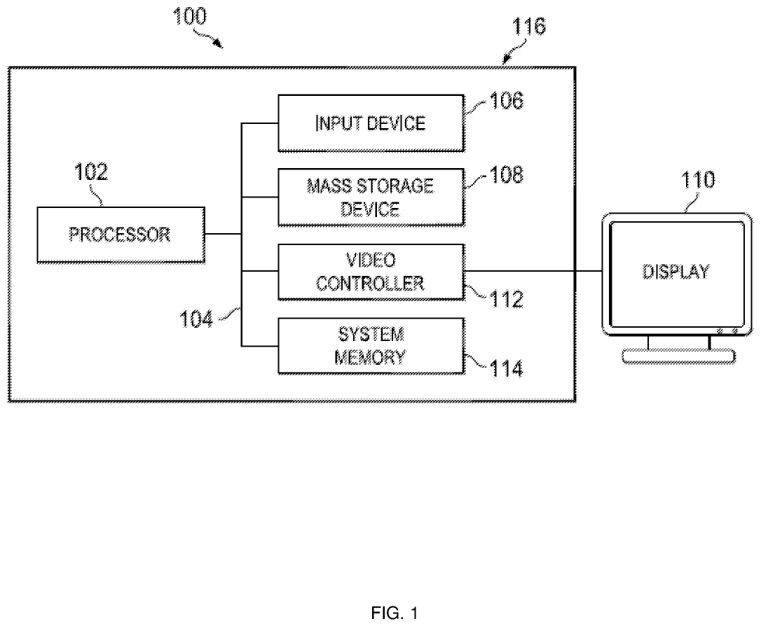

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

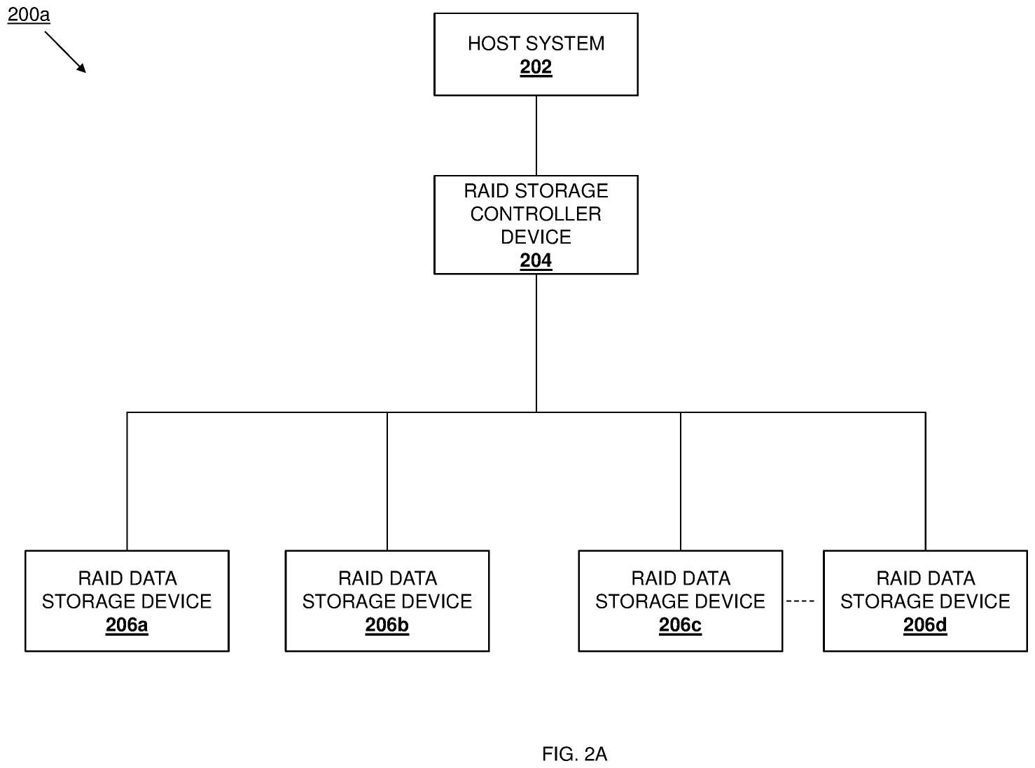

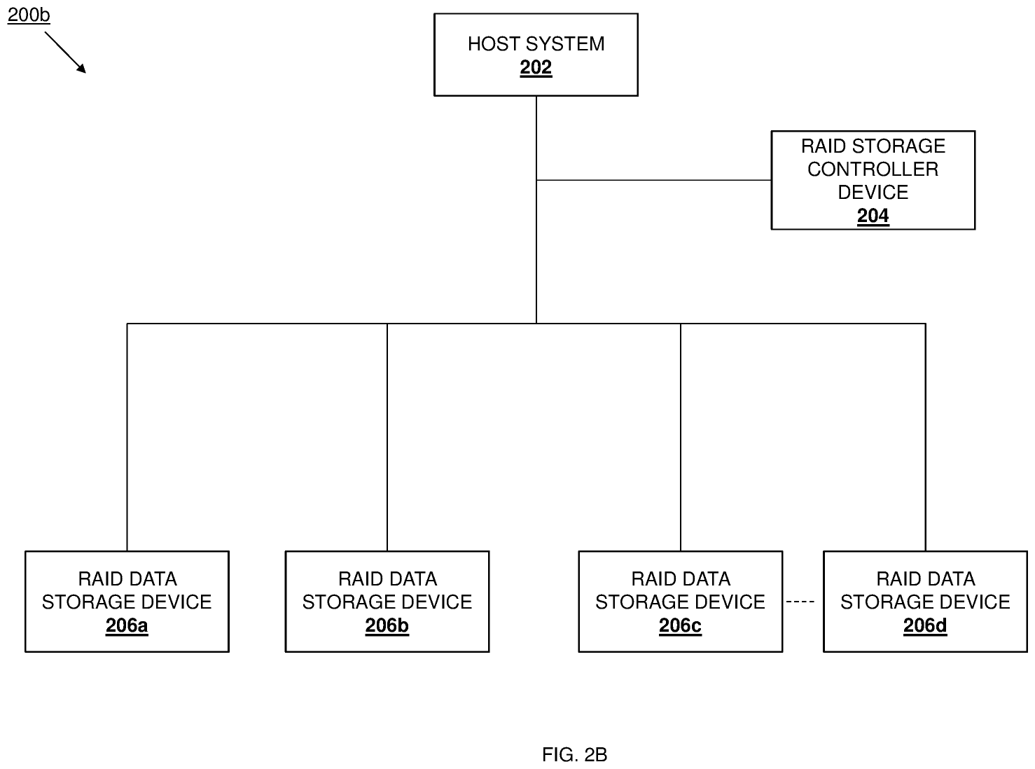

Referring now to FIG. 2A, an embodiment of a Redundant Array of Independent Disks (RAID) data mirroring system 200a is illustrated. In the illustrated embodiment, the RAID data mirroring system 200a includes a host system 202. In an embodiment, the host system 202 may be provided by the IHS 100 discussed above with reference to FIG. 1, and/or may include some or all of the components of the IHS 100. For example, the host system 202 may include server device(s), desktop computing device(s), a laptop/notebook computing device(s), tablet computing device(s), mobile phone(s), and/or any other host devices that one of skill in the art in possession of the present disclosure would recognize as operating similarly to the host system 202 discussed below. In the illustrated embodiment, the RAID data mirroring system 200a also includes a RAID storage controller device 204 that is coupled to the host system 202 in an “in-line” RAID storage controller device configuration that, as discussed below, couples the RAID storage controller device 204 between the host system 202 and each of a plurality of RAID data storage devices 206a, 206b, 206c, and up to 206d. In an embodiment, the RAID storage controller device 204 may be provided by the IHS 100 discussed above with reference to FIG. 1, and/or may include some or all of the components of the IHS 100. For example, the RAID storage controller device 204 may include any storage device/disk array controller device that is configured to manage physical storage devices and present them to host systems as logical units. As discussed below, the RAID storage controller device 204 includes a processing system, and a memory system that is coupled to the processing system and that includes instructions that, when executed by the processing system, cause the processing system to provide a RAID storage controller engine that is configured to perform the functions of the RAID storage controller engines and RAID storage controller devices discussed below.

In an embodiment, any or all of the RAID data storage devices 206a-206d may be provided by the IHS 100 discussed above with reference to FIG. 1, and/or may include some or all of the components of the IHS 100. Furthermore, while a few RAID data storage devices in a particular configuration are illustrated, one of skill in the art in possession of the present disclosure will recognize that many more storage devices may (and typically will) be coupled to the RAID storage controller device 204 (e.g., in a datacenter) and may be provided in other RAID configurations while remaining within the scope of the present disclosure. In the embodiments discussed below, the RAID data storage devices 206a-206d are described as being provided by Non-Volatile Memory express (NVMe) Solid State Drive (SSD) storage devices (or “drives”), but one of skill in the art in possession of the present disclosure will recognize that other types of storage devices with similar functionality as the NVMe SSD storage devices (e.g., NVMe PCIe add-in cards, NVMe M.2 cards, etc.) may be implemented according to the teachings of the present disclosure and thus will fall within its scope as well. While a specific RAID storage system 200a has been illustrated and described, one of skill in the art in possession of the present disclosure will recognize that the RAID storage system of the present disclosure may include a variety of components and component configurations while remaining within the scope of the present disclosure as well.

For example, referring now to FIG. 2B, an embodiment of a RAID data mirroring system 200b is illustrated that includes the same components of the RAID data mirroring system 200a discussed above with reference to FIG. 2A and, as such, those components are provided the same reference numbers as corresponding components in the RAID data mirroring system 200a. In the illustrated embodiment, the RAID data mirroring system 200b incudes the host system 202, with the RAID storage controller device 204 coupled to the host system 202 in a “look-aside” RAID storage controller device configuration that couples the RAID storage controller device 204 to the host system 202 and each of the RAID data storage devices 206a-206d without positioning the RAID storage controller device 204 between the host system 202 and the RAID data storage devices 206a-206d. As will be appreciated by one of skill in the art in possession of the present disclosure, the “in-line” RAID storage controller device configuration provided in the RAID data mirroring system 200a of FIG. 2A requires the RAID storage controller device 204 to manage data transfers between the host system 202 and the RAID data storage devices 206a-206d, thus increasing the number RAID storage controller operations that must be performed by the RAID storage controller device 204, while the “look-aside” RAID storage controller device configuration provided in the RAID data mirroring system 200b of FIG. 2B provides the RAID data storage devices 206a-206d direct access to the host system 202 independent of the RAID storage controller device 204, which allows many conventional RAID storage controller operations to be offloaded from the RAID storage controller device 204 by the RAID data storage devices 206a-206d.

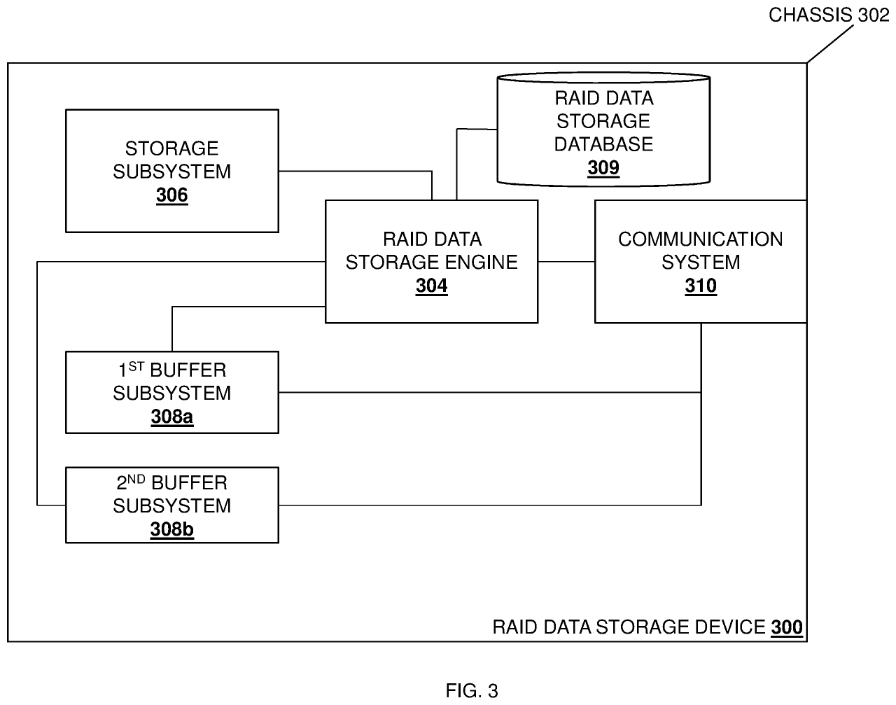

Referring now to FIG. 3, an embodiment of a RAID data storage device 300 is illustrated that may provide any or all of the RAID data storage devices 206a-206d discussed above with reference to FIG. 2. As such, the RAID data storage device 300 may be provided by an NVMe SSD storage device, but one of skill in the art in possession of the present disclosure will recognize that other types of storage devices with similar functionality as the NVMe SSD storage devices (e.g., NVMe PCIe add-in cards, NVMe M.2 cards, etc.) may be provided according to the teachings of the present disclosure and thus will fall within its scope as well. In the illustrated embodiment, the RAID data storage device 300 includes a chassis 302 that houses the components of the RAID data storage device 300, only some of which are illustrated below. For example, the chassis 302 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a RAID data storage engine 304 that is configured to perform the functionality of the RAID data storage engines and/or RAID data storage devices discussed below. While not illustrated, one of skill in the art in possession of the present disclosure will recognize that the RAID data storage engine 304 may include, or be coupled to, other components such as a queues (e.g., the submission queues and completion queues discussed below) and/or RAID data storage device components that would be apparent to one of skill in the art in possession of the present disclosure.

The chassis 302 may also house a storage subsystem 306 that is coupled to the RAID data storage engine 304 (e.g., via a coupling between the storage subsystem 306 and the processing system). Continuing with the example provided above in which the RAID data storage device 300 is an NVMe SSD storage device, the storage subsystem 306 may be provided by a flash memory array such as, for example, a plurality of NAND flash memory devices. However, one of skill in the art in possession of the present disclosure will recognize that the storage subsystem 306 may be provided using other storage technologies while remaining within the scope of the present disclosure as well. The chassis 302 may also house a first buffer subsystem 308a that is coupled to the RAID data storage engine 304 (e.g., via a coupling between the first buffer subsystem 308a and the processing system). Continuing with the example provided above in which the RAID data storage device 300 is an NVMe SSD storage device, the first buffer subsystem 308a may be provided by device buffer that is internal to the NVMe SSD storage device, not accessible via a PCIe bus connected to the NVMe SSD storage device, and conventionally utilized to initially store data received via write commands before writing them to flash media (e.g., NAND flash memory devices) in the NVMe SSD storage device. However, one of skill in the art in possession of the present disclosure will recognize that the first buffer subsystem 308a may be provided using other buffer technologies while remaining within the scope of the present disclosure as well.

The chassis 302 may also house a second buffer subsystem 308b that is coupled to the RAID data storage engine 304 (e.g., via a coupling between the second buffer subsystem 308b and the processing system). Continuing with the example provided above in which the RAID data storage device 300 is an NVMe SSD storage device, the second buffer subsystem 308b may be provided by a Controller Memory Buffer (CMB) subsystem. However, one of skill in the art in possession of the present disclosure will recognize that the second buffer subsystem 308b may be provided using a Persistent Memory Region (PMR) subsystem (e.g., a persistent CMB subsystem), and/or other memory technologies while remaining within the scope of the present disclosure as well. The chassis 302 may also house a storage system (not illustrated, but which may be provided by the storage device 108 discussed above with reference to FIG. 1) that is coupled to the RAID data storage engine 304 (e.g., via a coupling between the storage system and the processing system) and that includes a RAID storage database 309 that is configured to storage any of the information utilized by the RAID data storage engine 304 as discussed below.

The chassis 302 may also house a communication system 310 that is coupled to the RAID data storage engine 304 (e.g., via a coupling between the communication system 310 and the processing system), the first buffer subsystem 308a, and the second buffer subsystem 308b, and that may be provided by any of a variety of storage device communication technologies and/or any other communication components that would be apparent to one of skill in the art in possession of the present disclosure. Continuing with the example provided above in which the RAID data storage device 300 is an NVMe SSD storage device, the communication system 310 may include any NVMe SSD storage device communication components that enable the Direct Memory Access (DMA) operations described below, the submission and completion queues discussed below, as well as any other components that provide NVMe SDD storage device communication functionality that would be apparent to one of skill in the art in possession of the present disclosure. While a specific RAID data storage device 300 has been illustrated, one of skill in the art in possession of the present disclosure will recognize that RAID data storage devices (or other devices operating according to the teachings of the present disclosure in a manner similar to that described below for the RAID data storage device 300) may include a variety of components and/or component configurations for providing conventional RAID data storage device functionality, as well as the functionality discussed below, while remaining within the scope of the present disclosure as well.

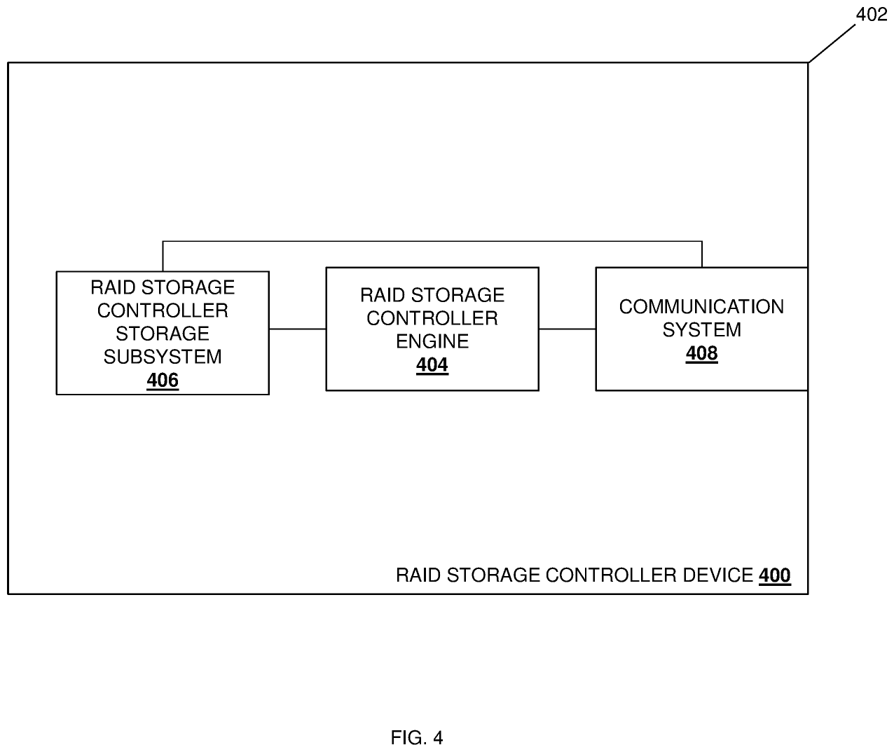

Referring now to FIG. 4, an embodiment of a RAID storage controller device 400 is illustrated that may provide the RAID storage controller device 204 discussed above with reference to FIG. 2. As such, the RAID storage controller device 400 may be provided by the IHS 100 discussed above with reference to FIG. 1 and/or may include some or all of the components of the IHS 100. Furthermore, while illustrated and discussed as a RAID storage controller device 400, one of skill in the art in possession of the present disclosure will recognize that the functionality of the RAID storage controller device 400 discussed below may be provided by other devices that are configured to operate similarly as discussed below. In the illustrated embodiment, the RAID storage controller device 400 includes a chassis 402 that houses the components of the RAID storage controller device 400, only some of which are illustrated below. For example, the chassis 402 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a RAID storage controller engine 404 that is configured to perform the functionality of the RAID storage controller engines and/or RAID storage controller devices discussed below.

The chassis 402 may also house a RAID storage controller storage subsystem 406 (e.g., which may be provided by the storage 108 discussed above with reference to FIG. 1) that is coupled to the RAID storage controller engine 404 (e.g., via a coupling between the storage system and the processing system) and the communication system 408. The chassis 402 may also house a communication system 408 that is coupled to the RAID storage controller engine 404 (e.g., via a coupling between the communication system 408 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure.

While a specific RAID storage controller device 400 has been illustrated, one of skill in the art in possession of the present disclosure will recognize that RAID storage controller devices (or other devices operating according to the teachings of the present disclosure in a manner similar to that described below for the RAID storage controller device 400) may include a variety of components and/or component configurations for providing conventional RAID storage controller device functionality, as well as the functionality discussed below, while remaining within the scope of the present disclosure as well. For example, while the RAID storage controller device 400 has been described as a hardware RAID storage controller device provided in a chassis, in other embodiments the RAID storage controller device may be a software RAID storage controller device provided by software (e.g., instructions stored on a memory system) in the host system 202 that is executed by a processing system in the host system 202 while remaining within the scope of the present disclosure as well. As such, in some embodiments, the operations of the RAID storage controller device 400 discussed below may be performed via the processing system in the host system 202.

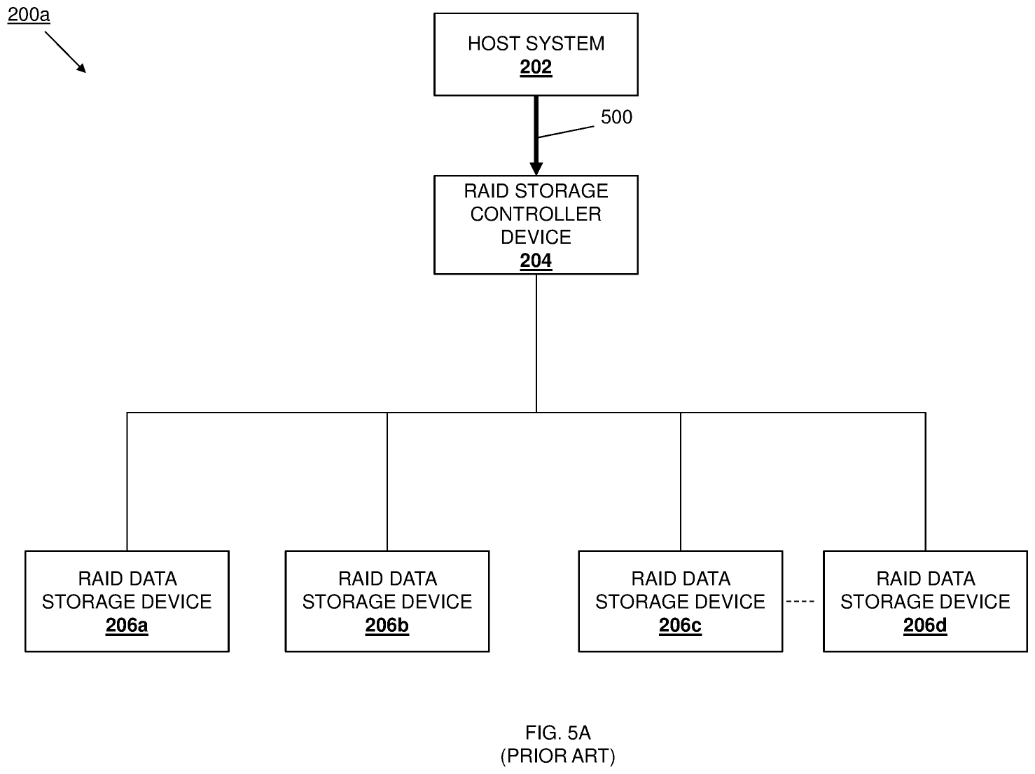

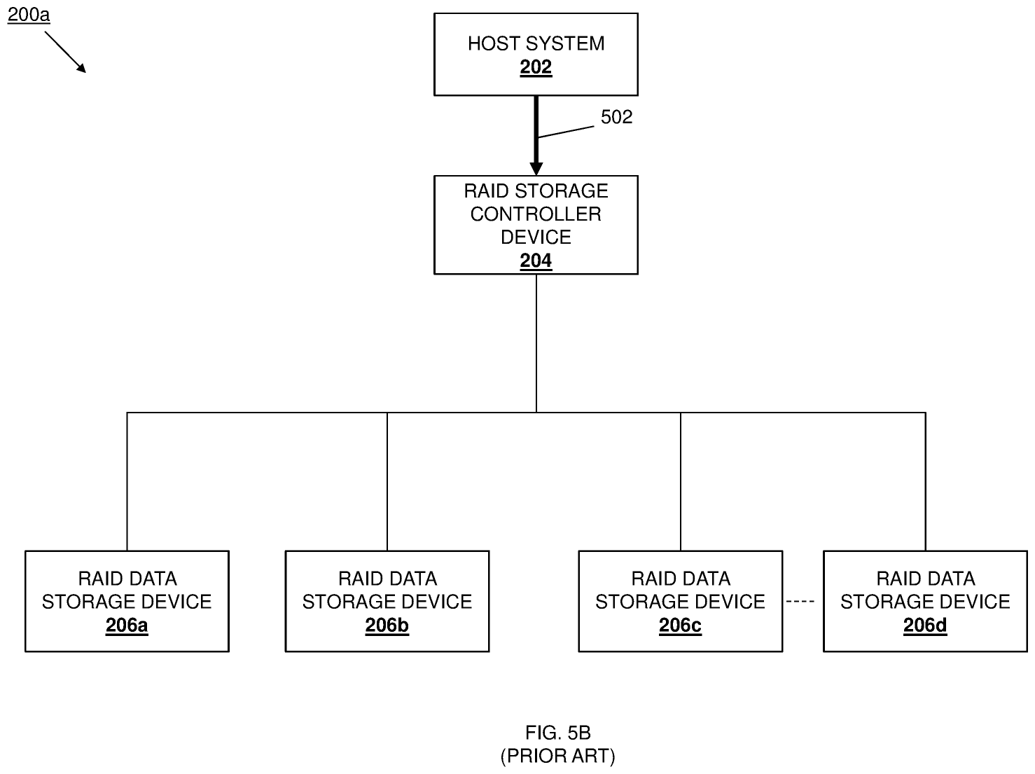

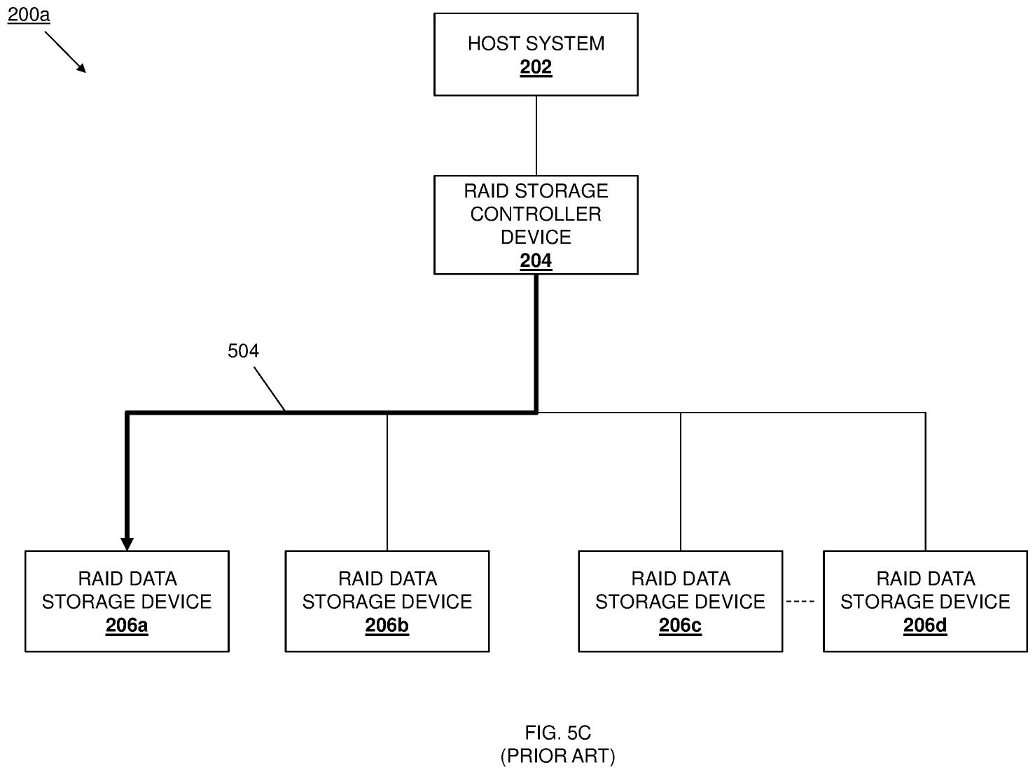

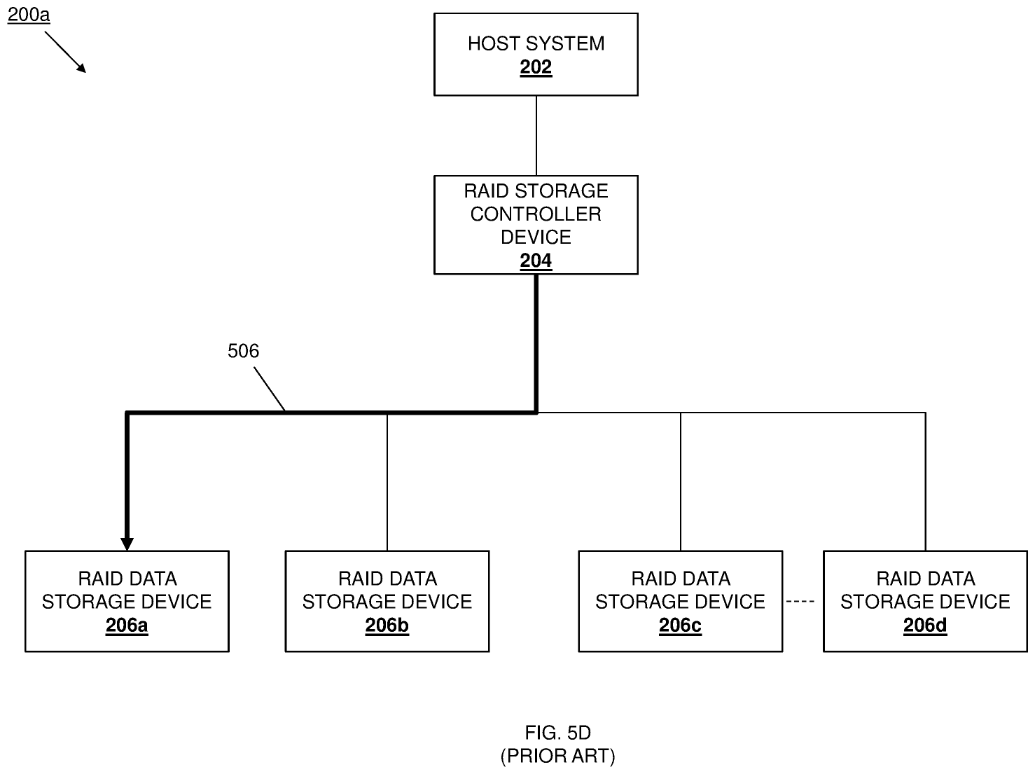

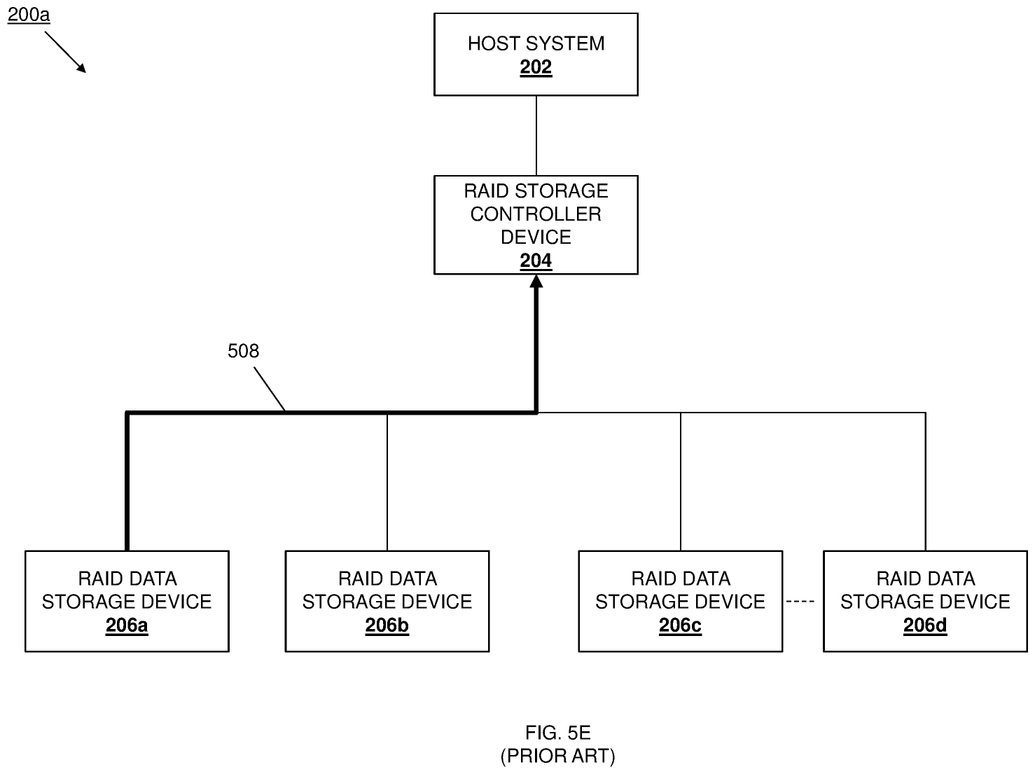

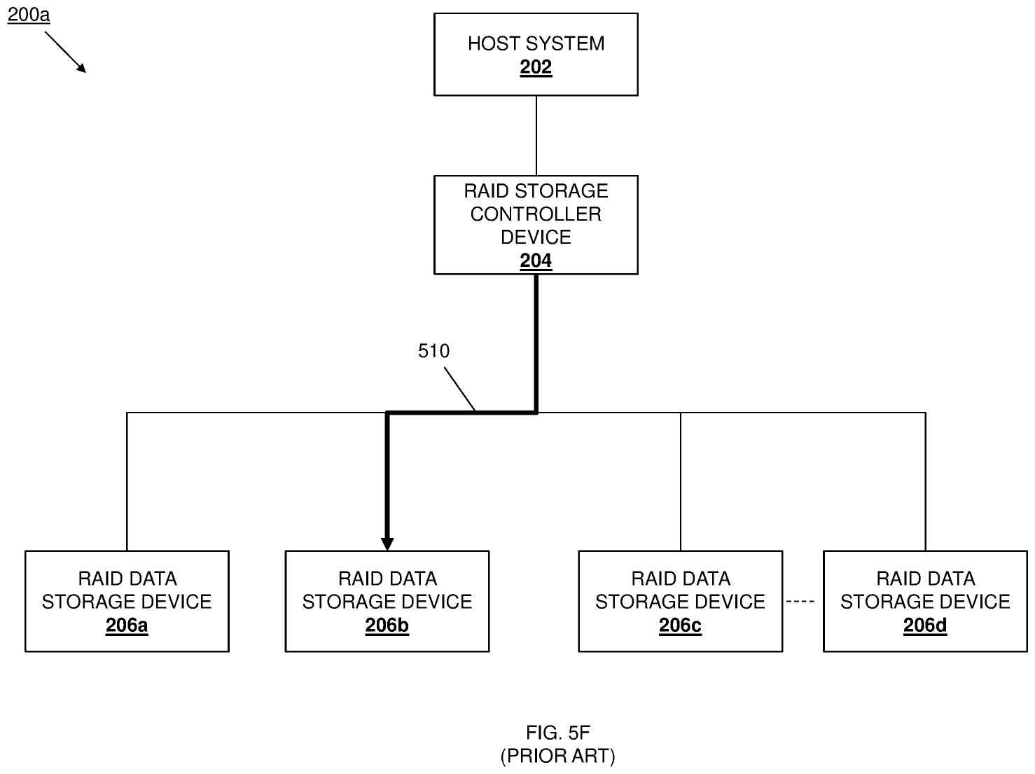

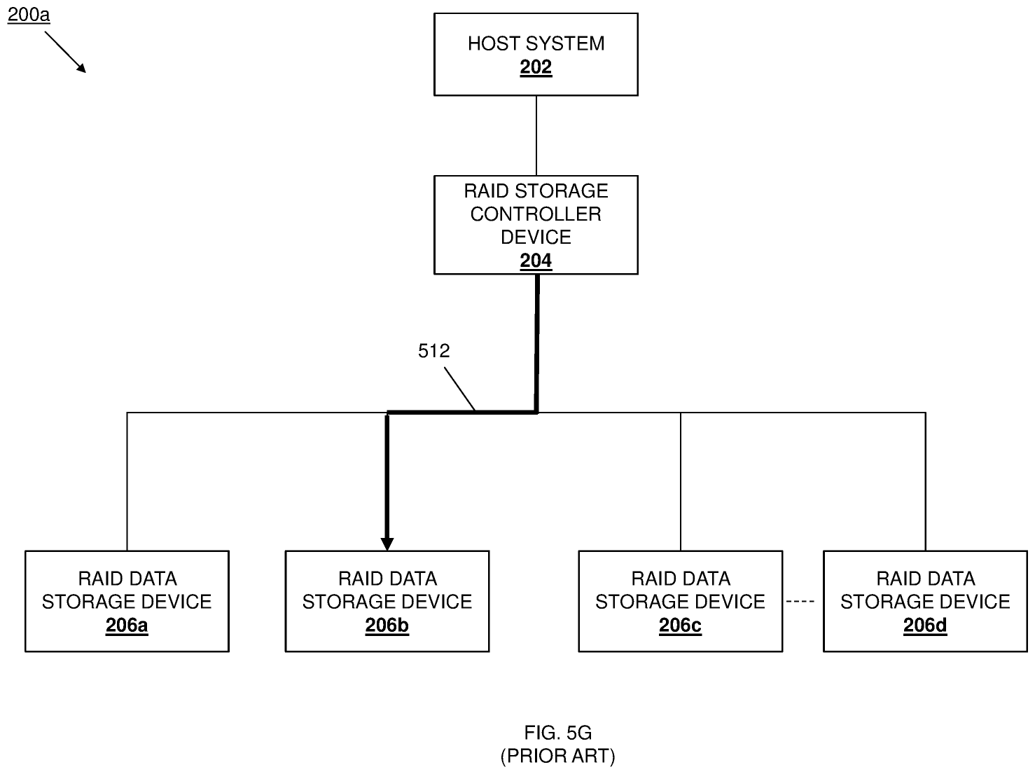

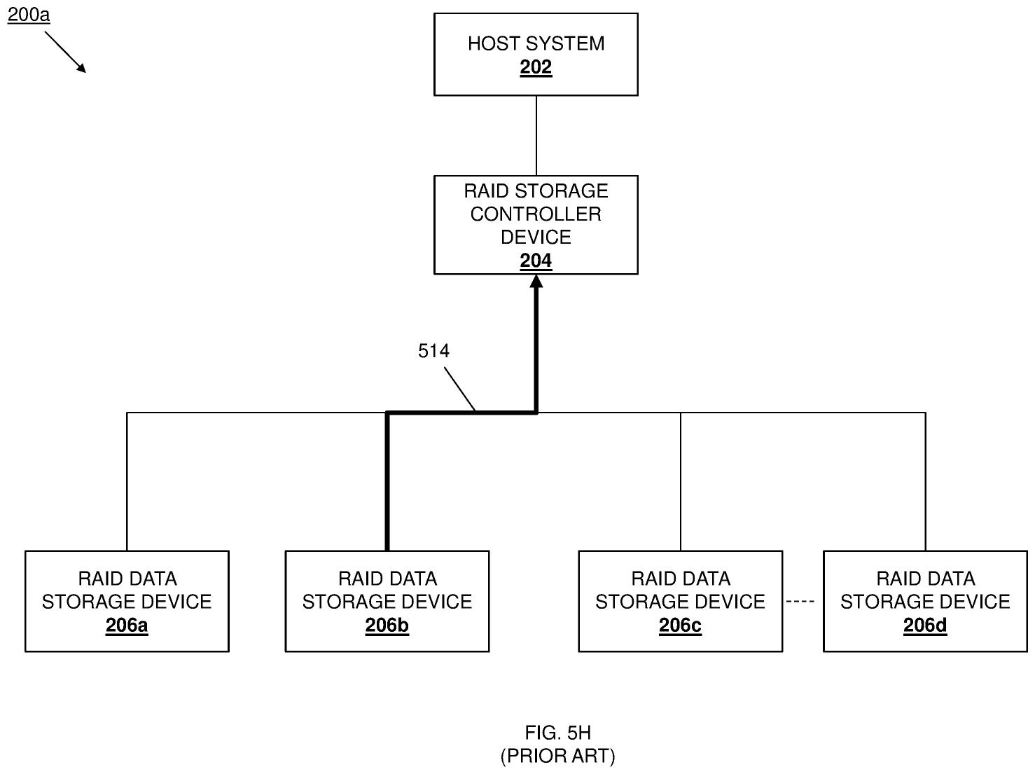

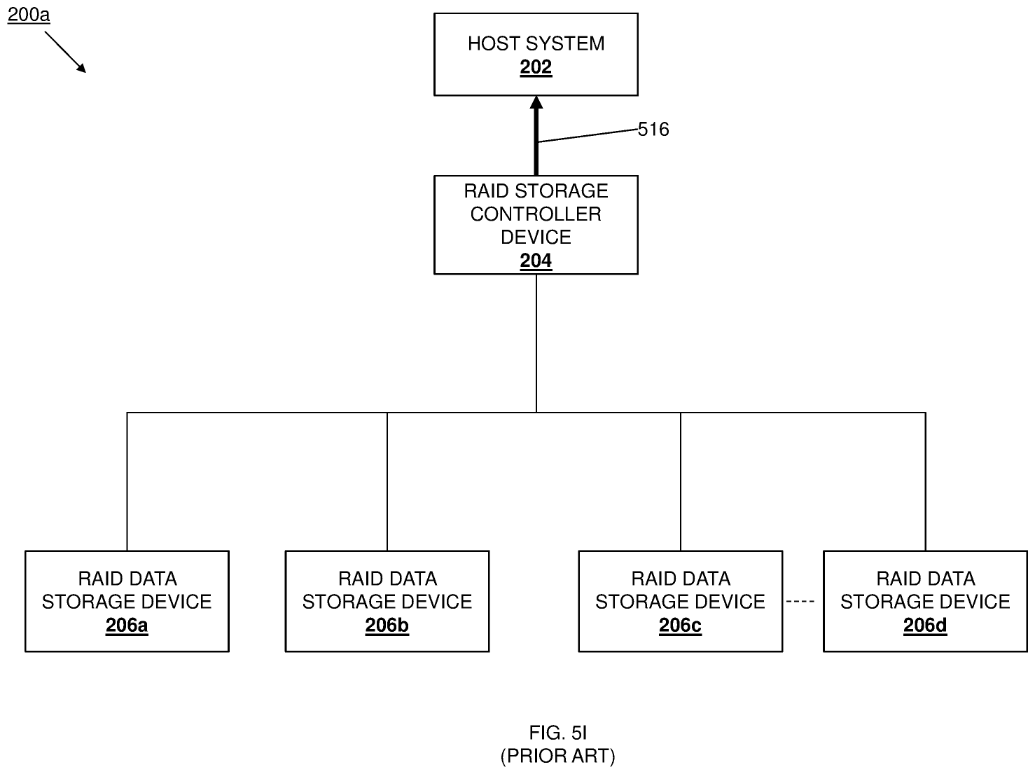

Referring now to FIGS. 5A, 5B, 5C, 5D, 5E, 5F, 5G, 5H, and 5I, conventional data mirroring operations for the RAID data mirroring system 200a are briefly described in order to contrast the data mirroring operations of the RAID data mirroring system 200a that are performed according to the teachings of the present disclosure, discussed in further detail below. As illustrated in FIG. 5A, the host system 202 may generate a write command that instructs the RAID storage controller device 204 to write data from the host system 202 to the RAID data storage device(s) 206a-206d, and may transmit that write command 500 to the RAID storage controller device 204. As illustrated in FIG. 5B, in response to receiving the write instruction from the host system 202, the RAID storage controller device 204 may perform data retrieval operations 502 to retrieve the data from the host system 202 and write that data to the RAID storage controller device 204 (e.g., to the RAID storage controller storage subsystem 406 in the RAID storage controller device 204/400.) As illustrated in FIG. 5C, the RAID storage controller device 204 may then transmit a first command 504 to the RAID data storage device 206a (a “primary RAID data storage device” for the data in this example) to store the data that was copied to the RAID storage controller device 204. As illustrated in FIG. 5D, in response to receiving the first command the RAID data storage device 206a may then perform data storage operations 506 to retrieve the data from the RAID storage controller device 204 (e.g., from the RAID storage controller storage subsystem 406 in the RAID storage controller device 204/400), and write that data to the RAID data storage device 206a (e.g., to the storage subsystem 306 in the RAID data storage device 206a/300). As such, a first copy of the data from the host system is stored in the RAID data storage device 206a, and following the storage of the data on the RAID data storage device 206a, the RAID data storage device 206a may transmit a completion communication 508 to the RAID storage controller device 204, as illustrated in FIG. 5E.

As illustrated in FIG. 5F, the RAID storage controller device 204 may also perform second command operations 510 to transmit a second command to the RAID data storage device 206b (a “secondary/backup RAID data storage device” for the data in this example) to store the data that was copied to the RAID storage controller device 204. As illustrated in FIG. 5G, in response to receiving the second command the RAID data storage device 206b may then perform data storage operations 512 to retrieve the data from the RAID storage controller device 204 (e.g., from the RAID storage controller storage subsystem 406 in the RAID storage controller device 204/400), and write that data to the RAID data storage device 206b (e.g., to the storage subsystem 306 in the RAID data storage device 206b/300). As will be appreciated by one of skill in the art in possession of the present disclosure, the first command and the second commands transmitted to the different RAID data storage devices 206a and 206b, respectively, may allow those RAID data storage devices 206a and 206b to perform some or all of their corresponding data storage operations 506 and 512 in parallel. As such, a second copy of the data from the host system is stored in the RAID data storage device 206b, and following the storage of the data on the RAID data storage device 206b, the RAID data storage device 206b may transmit a completion communication 514 to the RAID storage controller device 204, as illustrated in FIG. 5H. As illustrated in FIG. 5I, in response to receiving the completion communications 508 and 514, the RAID storage controller device 204 may transmit a completion communication 516 to the host system 202 to acknowledge completion of the write command 500. As discussed in further detail below, the conventional data mirroring operations described above are relatively processing and memory intensive for the RAID storage controller device 204, and the processing and memory requirements for the RAID storage controller device may be reduced while performing such data mirroring operations using the teachings of the present disclosure.

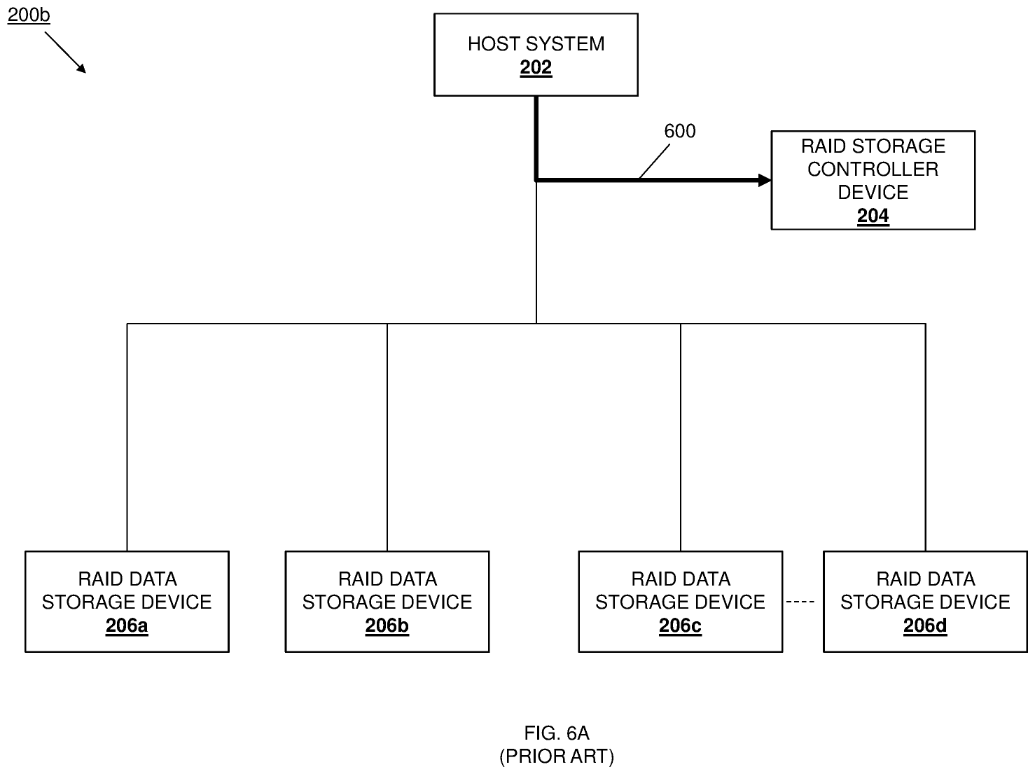

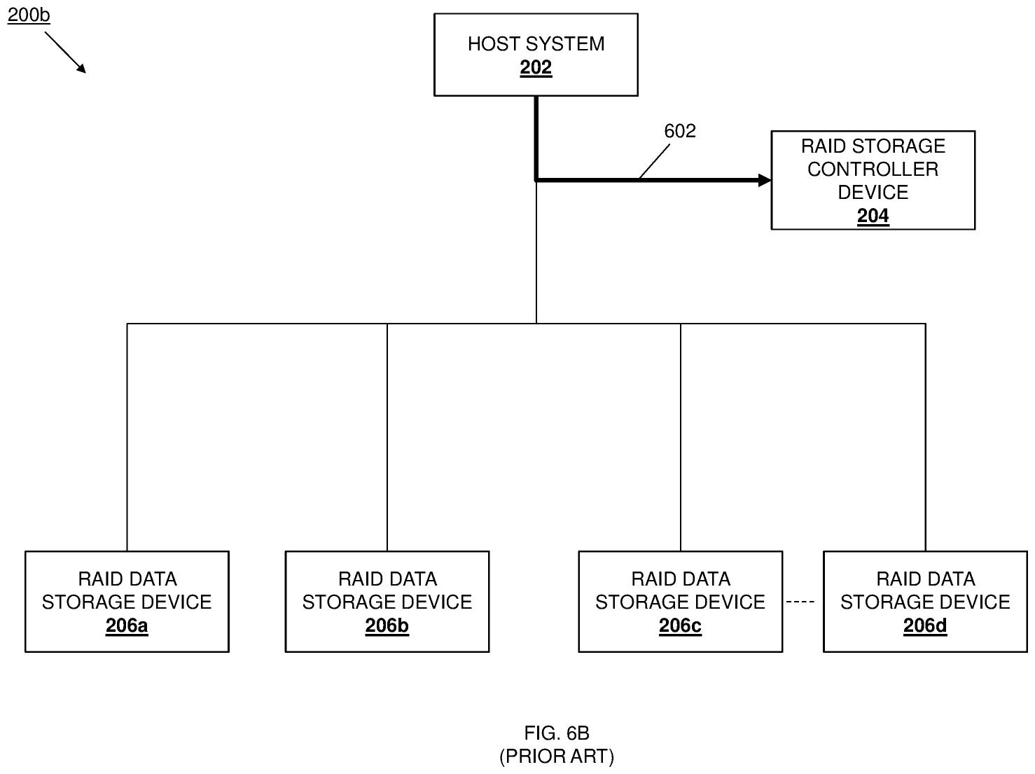

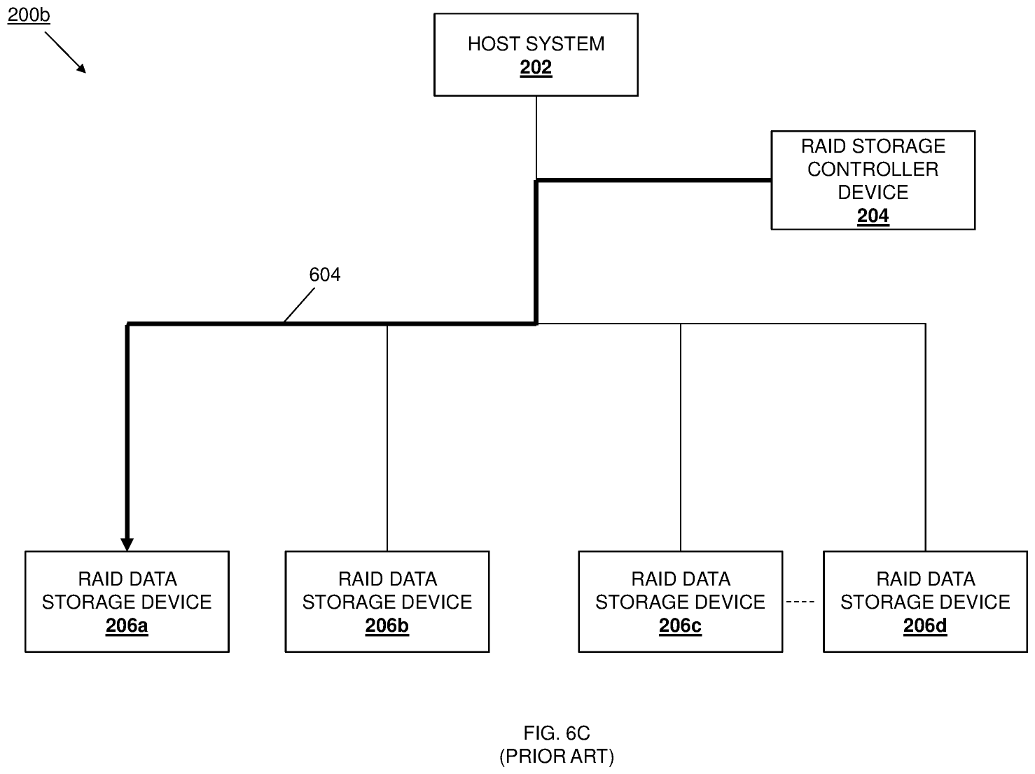

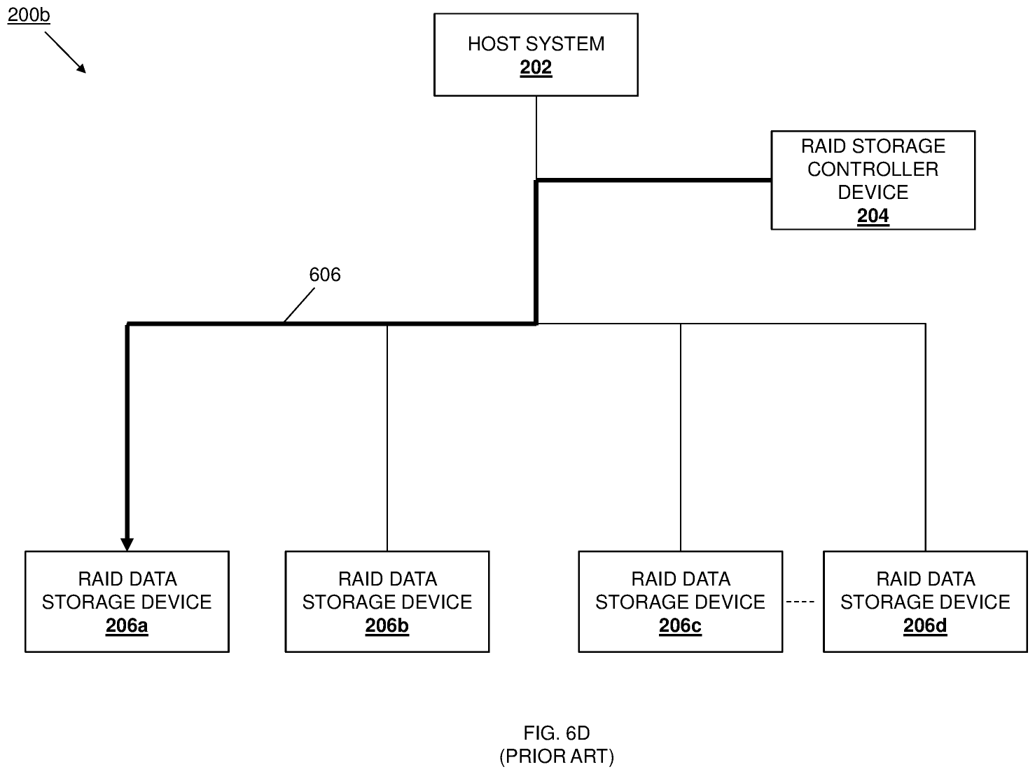

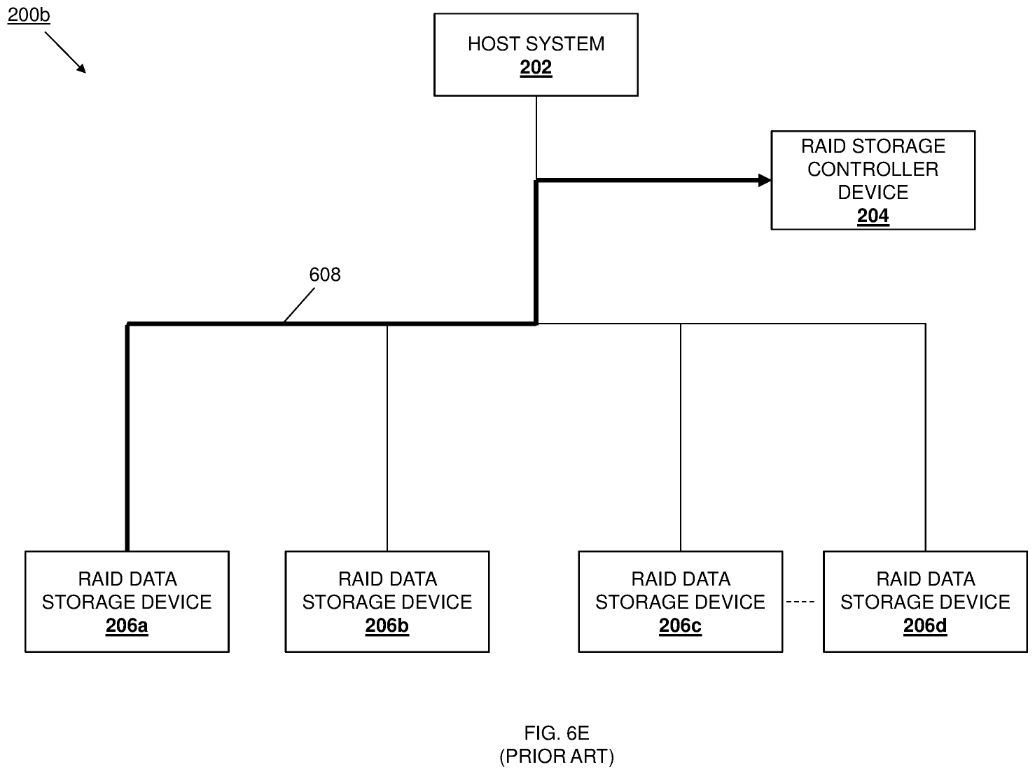

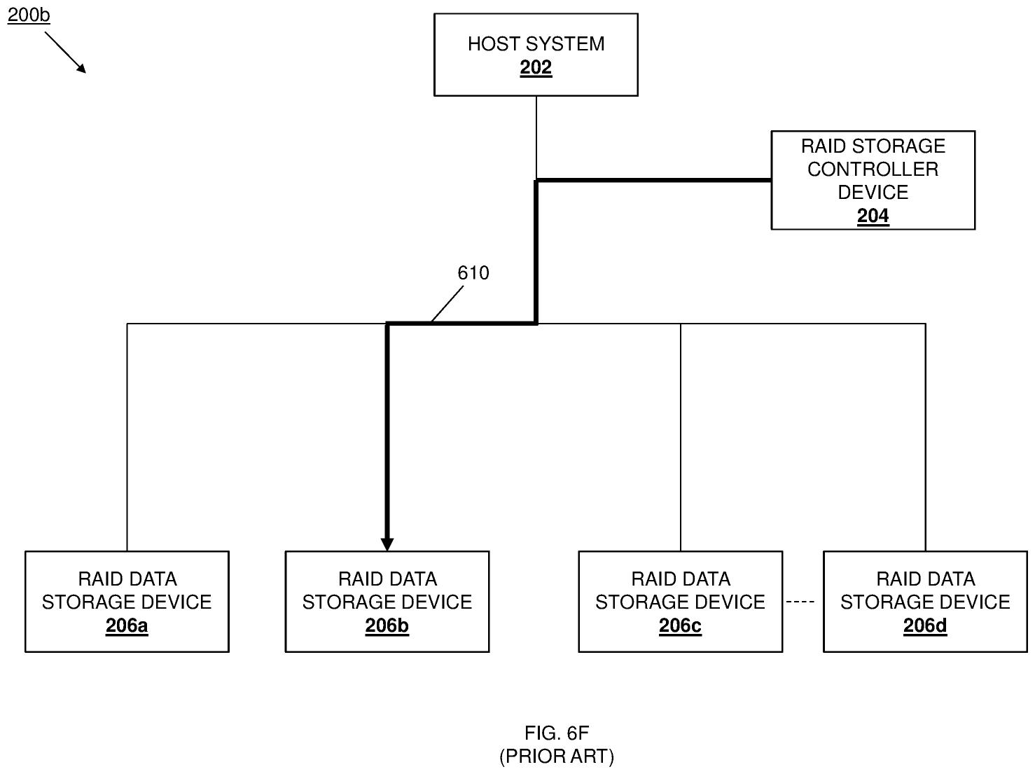

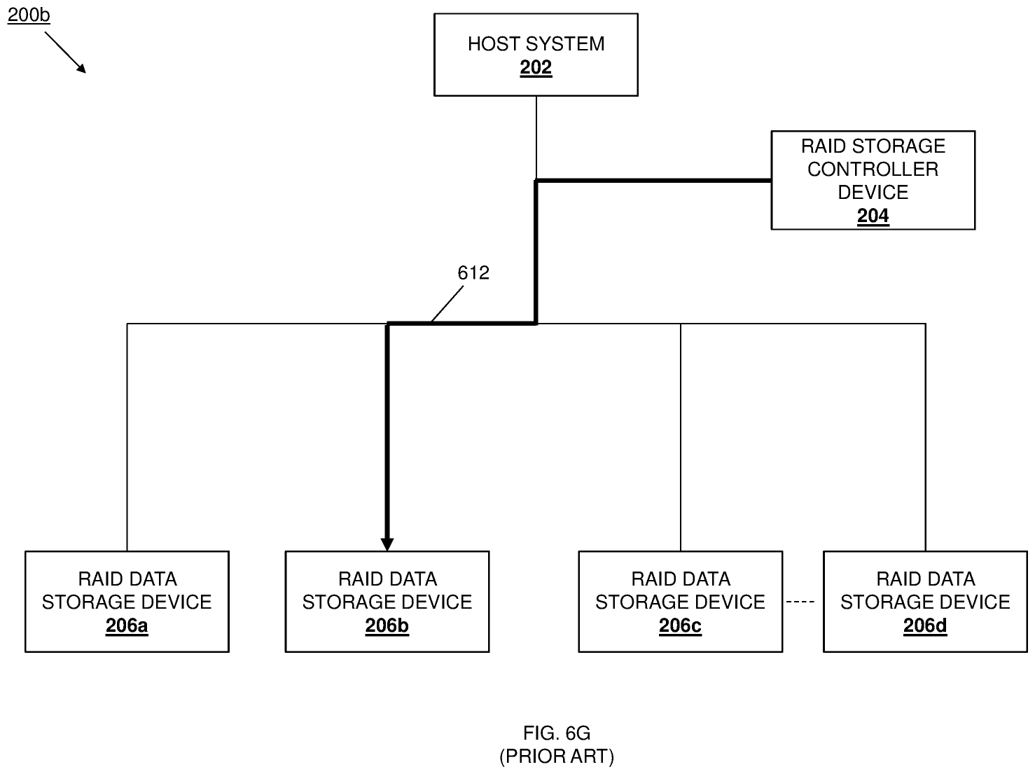

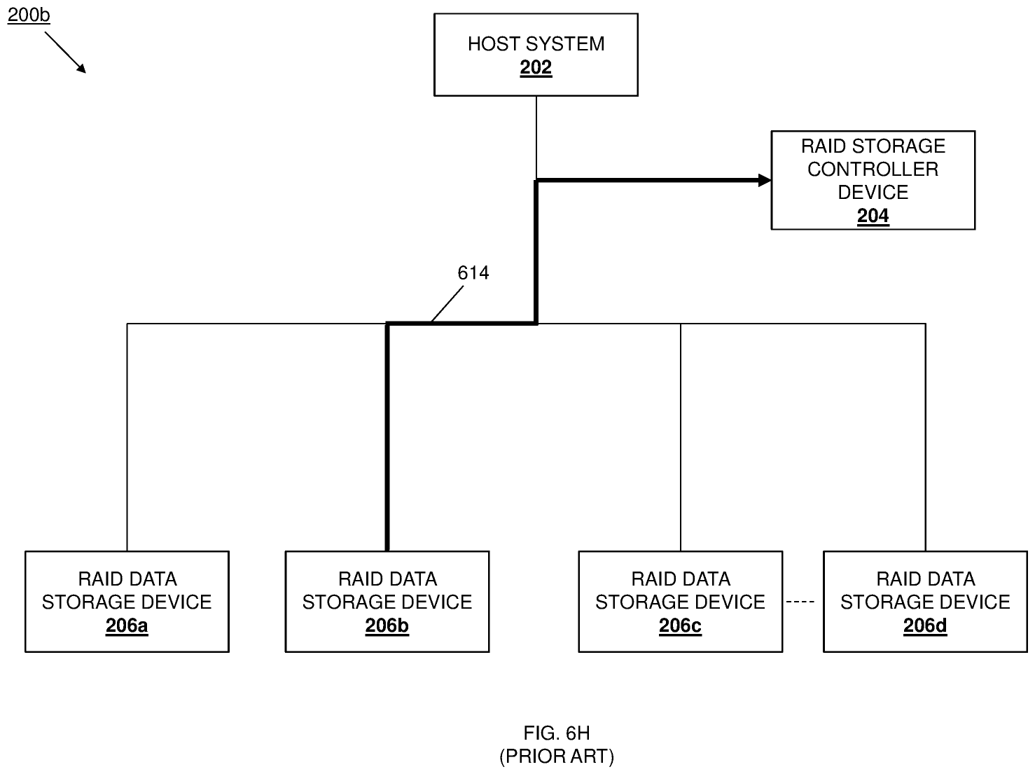

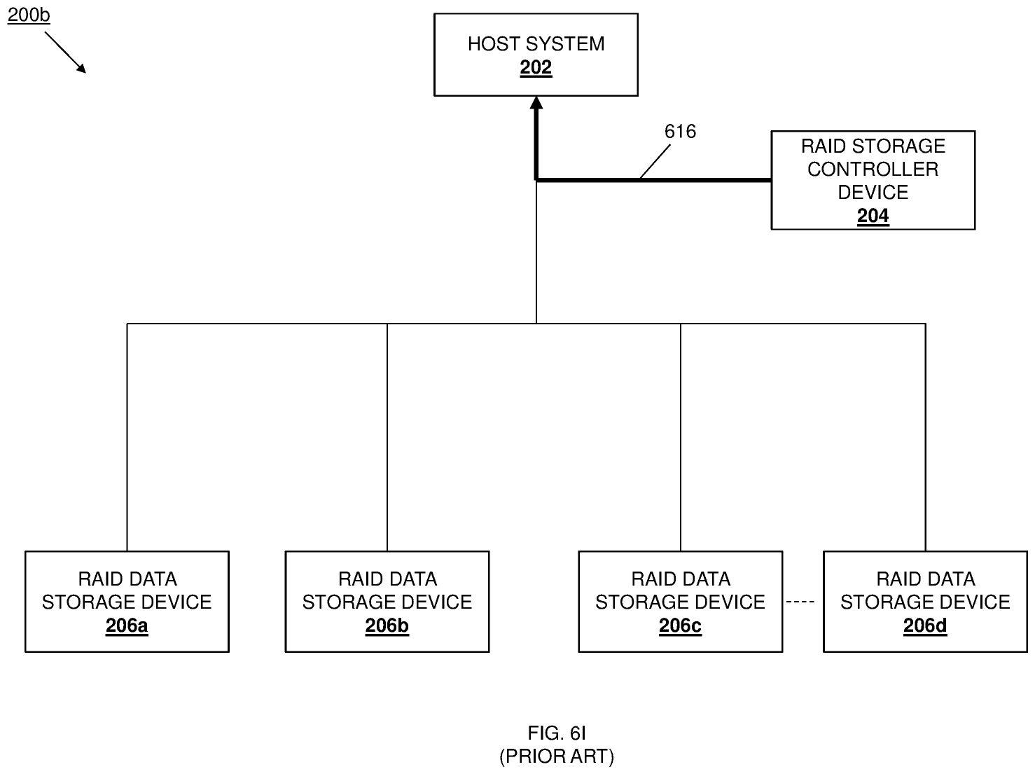

Referring now to FIGS. 6A, 6B, 6C, 6D, 6E, 6F, 6G, 6H, and 6I, conventional data mirroring operations for the RAID data mirroring system 200b are briefly described in order to contrast the data mirroring operations of the RAID data mirroring system 200b that are performed according to the teachings of the present disclosure, discussed in further detail below. As illustrated in FIG. 6A, the host system 202 may generate a write command that instructs the RAID storage controller device 204 to write data from the host system 202 to the RAID data storage device(s) 206a-206d, and may transmit that write command 600 to the RAID storage controller device 204. As illustrated in FIG. 6B, in response to receiving the write instruction from the host system 202, the RAID storage controller device 204 may perform data retrieval operations 602 to retrieve the data from the host system 202 and write that data to the RAID storage controller device 204 (e.g., to the RAID storage controller storage subsystem 406 in the RAID storage controller device 204/400.) As illustrated in FIG. 6C, the RAID storage controller device 204 may then transmit a first command 604 to the RAID data storage device 206a (a “primary RAID data storage device” for the data in this example) to store the data that was copied to the RAID storage controller device 204. As illustrated in FIG. 6D, in response to receiving the first command the RAID data storage device 206a may then perform data storage operations 606 to retrieve the data from the RAID storage controller device 204 (e.g., from the RAID storage controller storage subsystem 406 in the RAID storage controller device 204/400), and write that data to the RAID data storage device 206a (e.g., to the storage subsystem 306 in the RAID data storage device 206a/300). As such, a first copy of the data from the host system is stored in the RAID data storage device 206a, and following the storage of the data on the RAID data storage device 206a, the RAID data storage device 206a may transmit a completion communication 608 to the RAID storage controller device 204, as illustrated in FIG. 6E.

As illustrated in FIG. 6F, the RAID storage controller device 204 may also perform second command operations 610 to transmit a second command to the RAID data storage device 206b (a “secondary/backup RAID data storage device” for the data in this example) to store the data that was copied to the RAID storage controller device 204. As illustrated in FIG. 6G, in response to receiving the second command the RAID data storage device 206b may then perform data storage operations 612 to retrieve the data from the RAID storage controller device 204 (e.g., from the RAID storage controller storage subsystem 406 in the RAID storage controller device 204/400), and write that data to the RAID data storage device 206b (e.g., to the storage subsystem 306 in the RAID data storage device 206b/300). As such, a second copy of the data from the host system is stored in the RAID data storage device 206b, and following the storage of the data on the RAID data storage device 206b, the RAID data storage device 206b may transmit a completion communication 614 to the RAID storage controller device 204, as illustrated in FIG. 6H. As illustrated in FIG. 6I, in response to receiving the completion communications 608 and 614, the RAID storage controller device 204 may transmit a completion communication 616 to the host system 202 to acknowledge completion of the write command 600. As discussed in further detail below, the conventional data mirroring operations described above are relatively processing and memory intensive for the RAID storage controller device 204, and the processing and memory requirements for the RAID storage controller device may be reduced while performing such data mirroring operations using the teachings of the present disclosure.

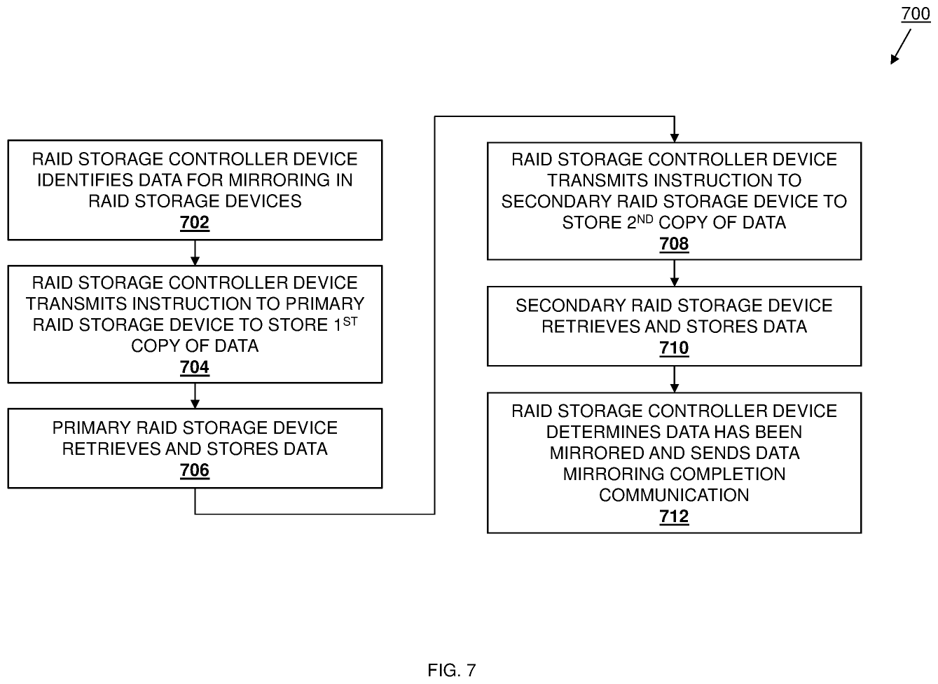

Referring now to FIG. 7, an embodiment of a method 400 for RAID data mirroring is illustrated. As discussed below, the systems and methods of the present disclosure provide for data mirroring in a RAID storage system with the assistance of the RAID data storage devices in order to offload processing operations, memory usage, and/or other functionality of the RAID storage controller device. For example, a RAID storage controller device that identifies data for mirroring may send a first instruction to a primary RAID data storage device to store a first copy of the data and, in response, the primary RAID data storage device will retrieve and store that data in its storage subsystem as well as its buffer subsystem. The RAID storage controller device may then send a second instruction to a secondary RAID data storage device to store a second copy of the data and, in response, the secondary RAID data storage device will retrieve that data directly from the buffer subsystem in the primary RAID data storage device, and store that data in its storage subsystem. As such, some data mirroring operations are offloaded from the RAID storage controller device, thus allowing the RAID storage controller device to scale with higher performance RAID data storage devices, and/or allowing relatively lower capability RAID storage controller devices to be utilized with the RAID storage system.

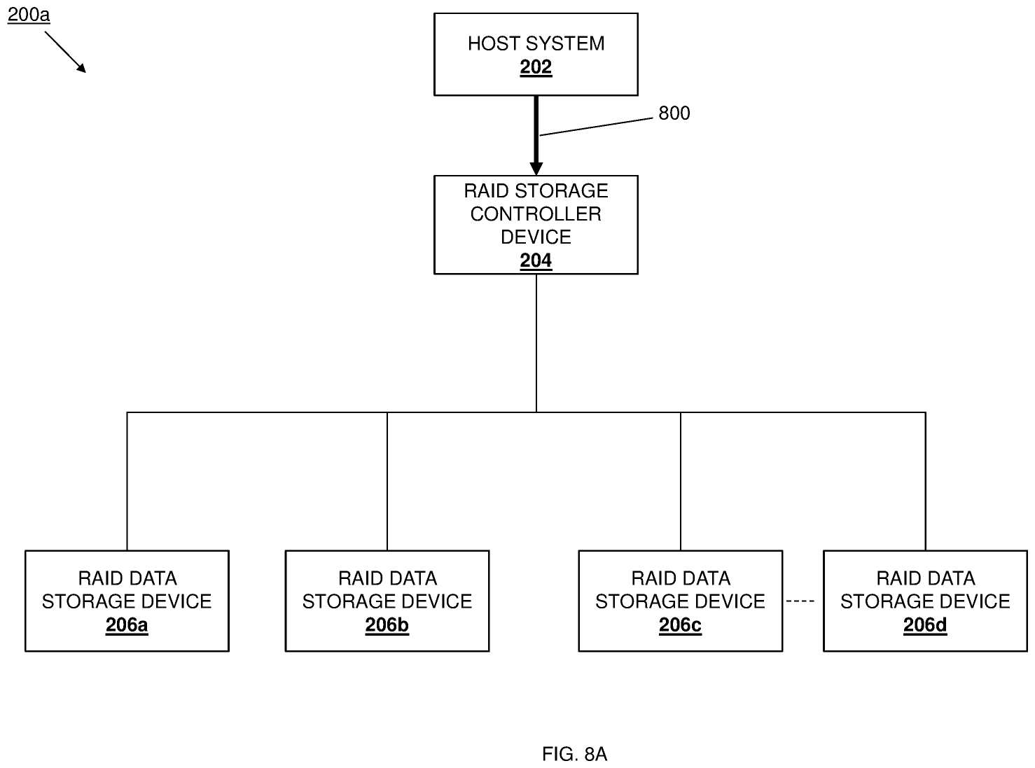

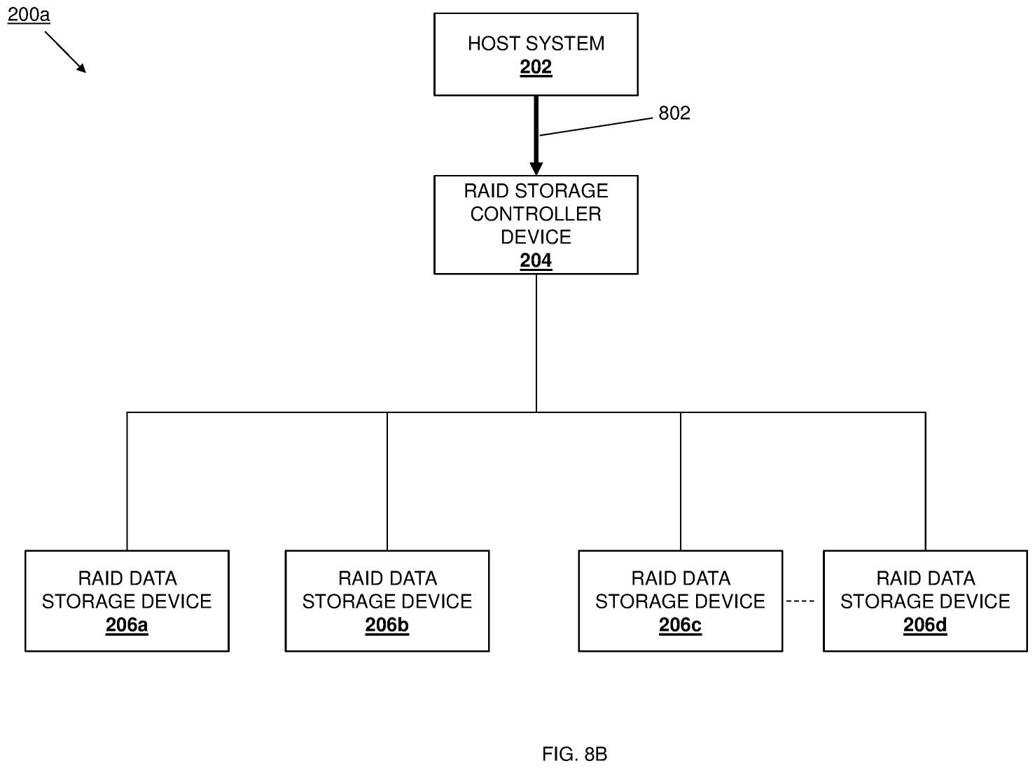

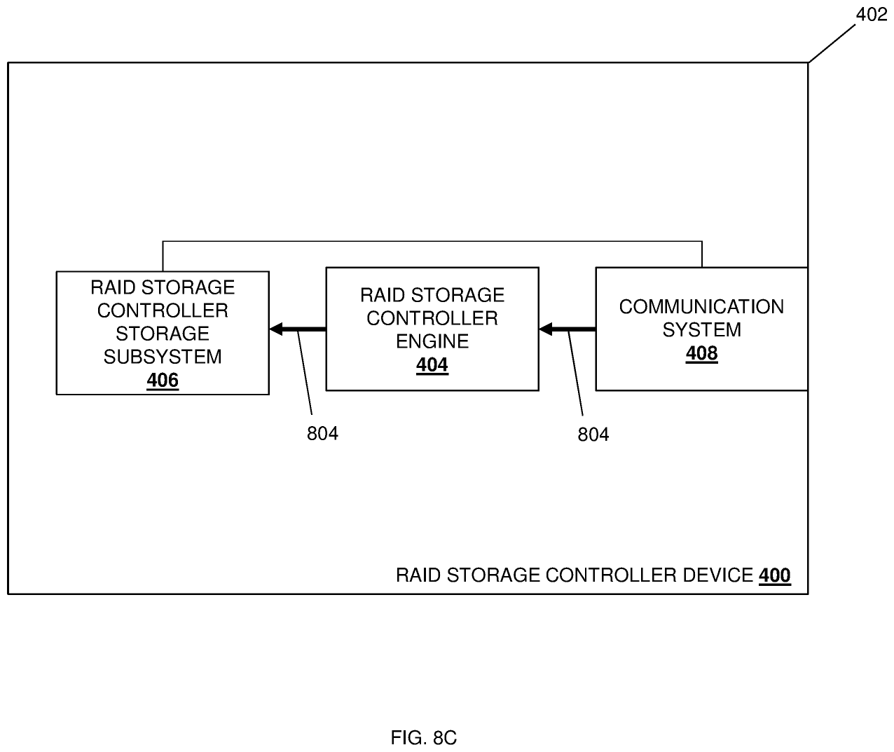

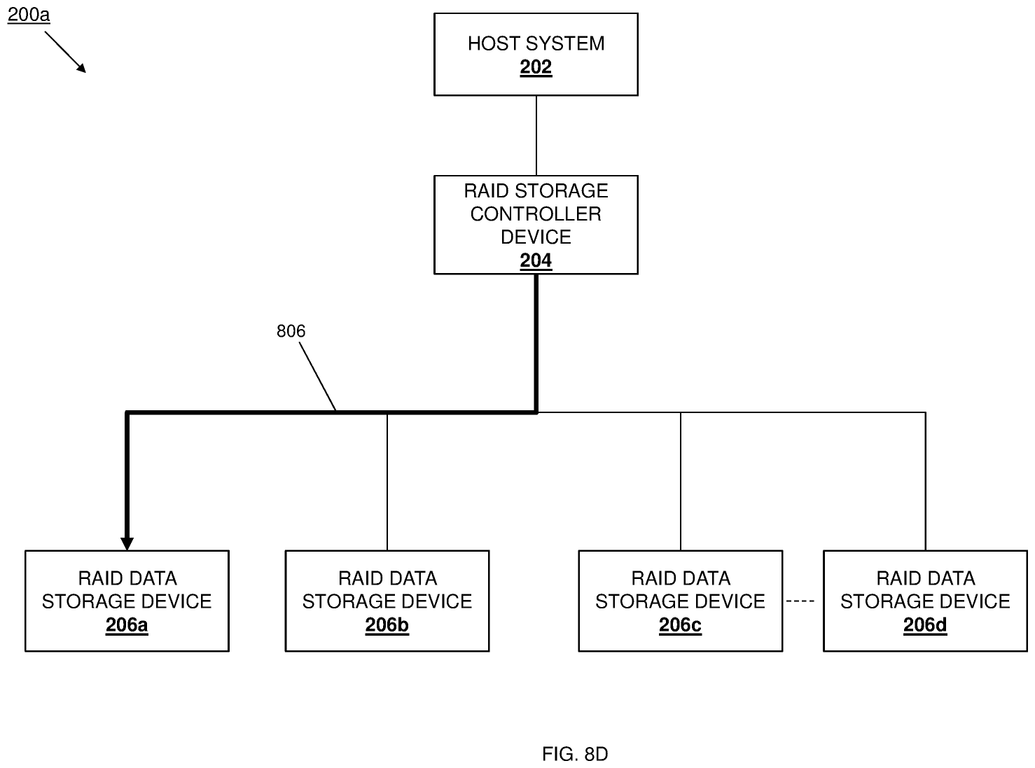

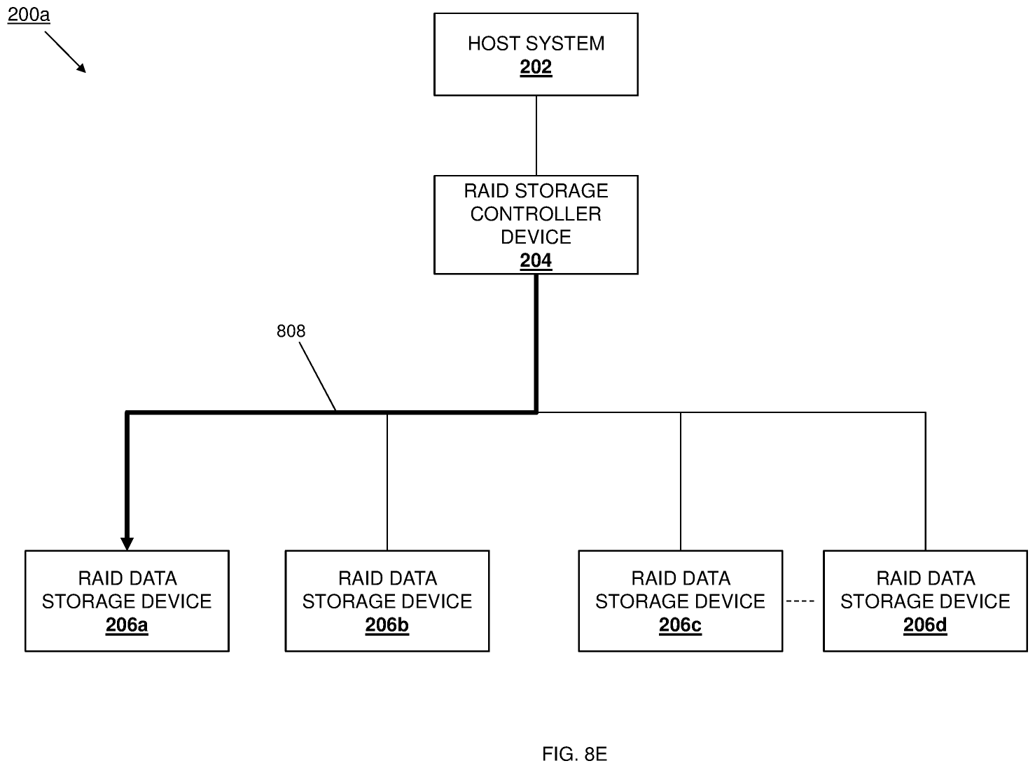

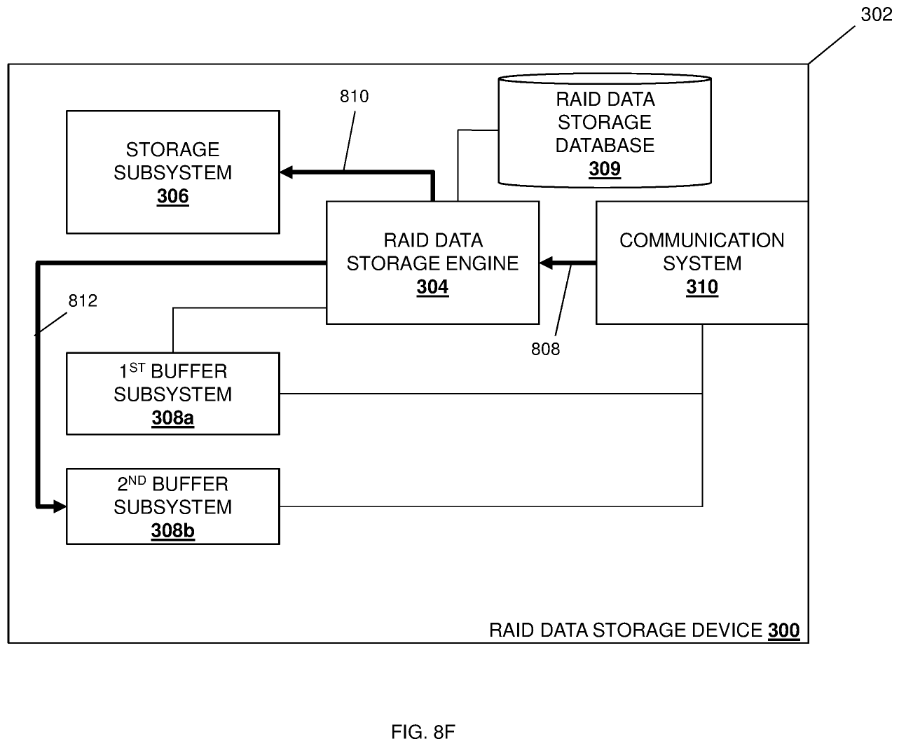

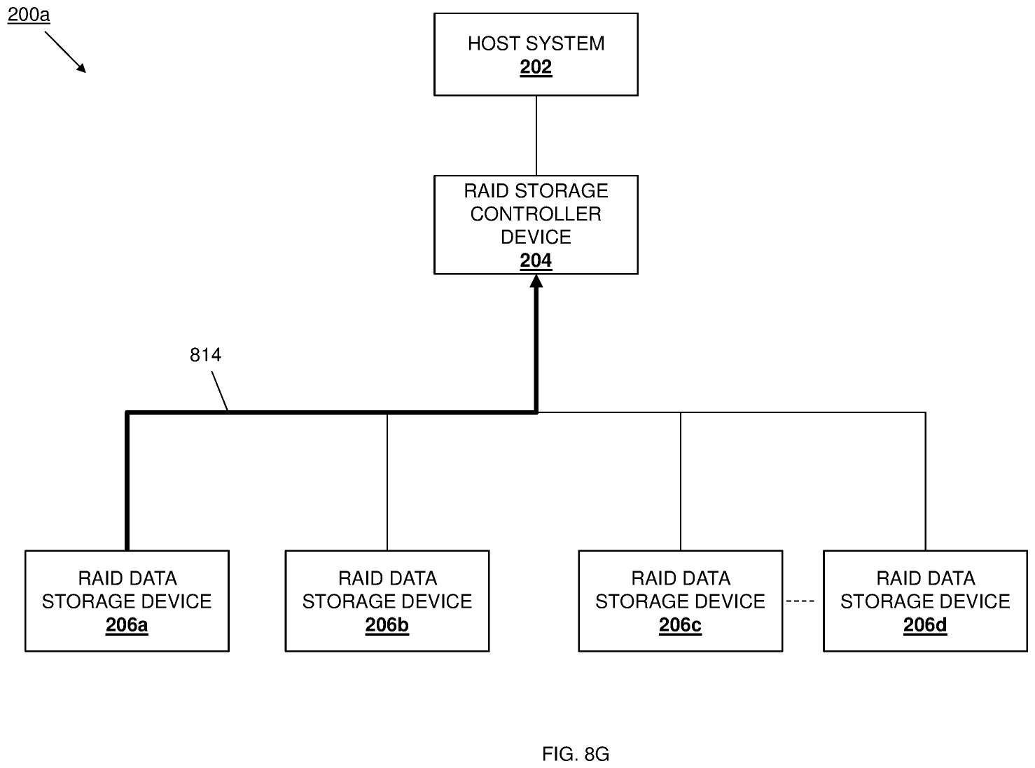

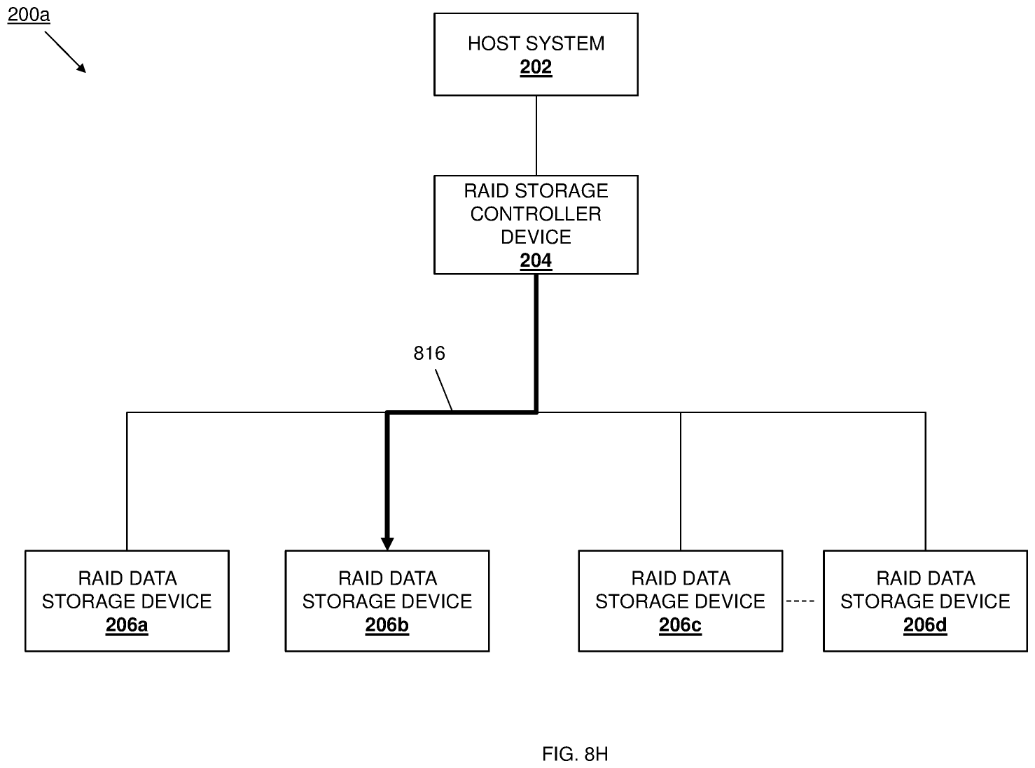

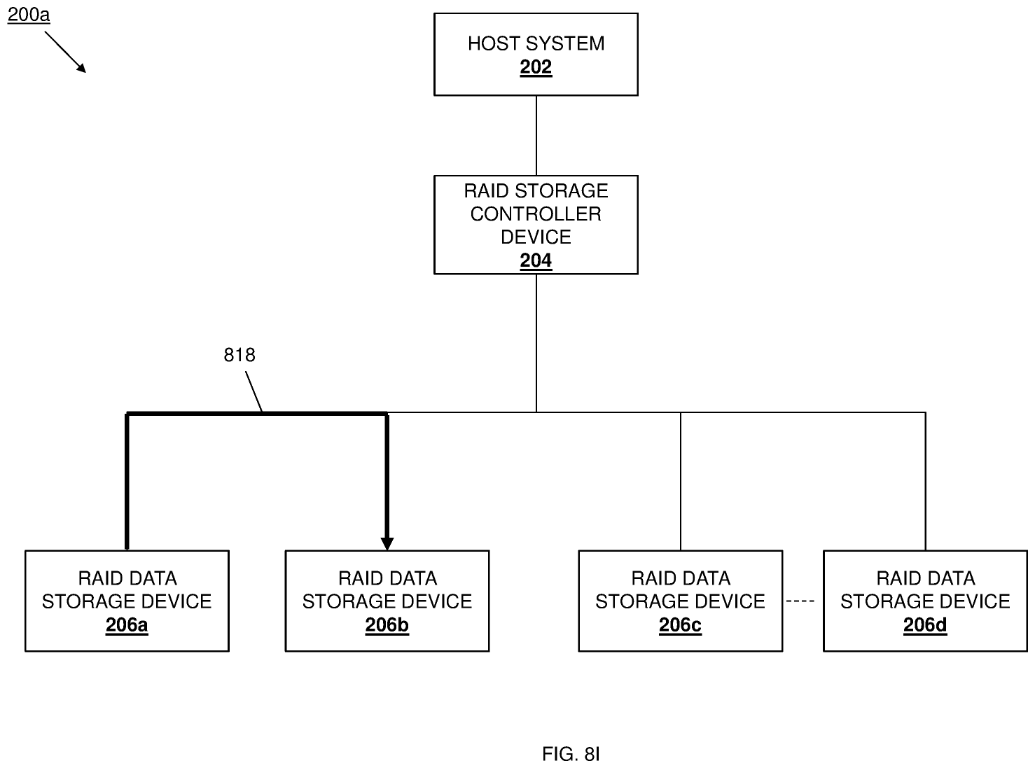

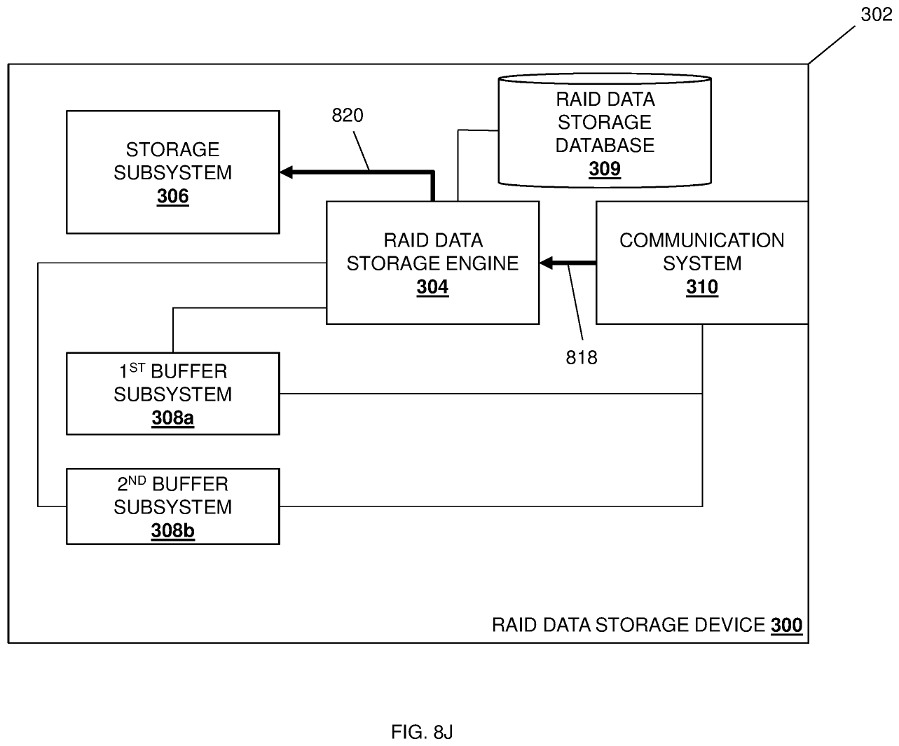

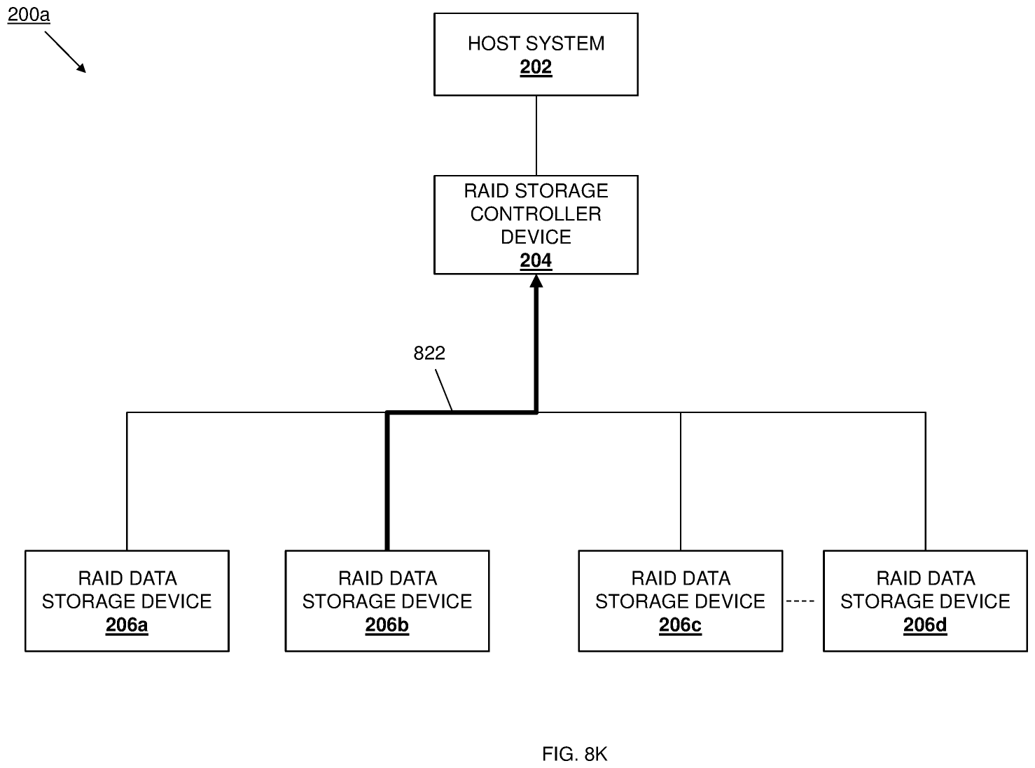

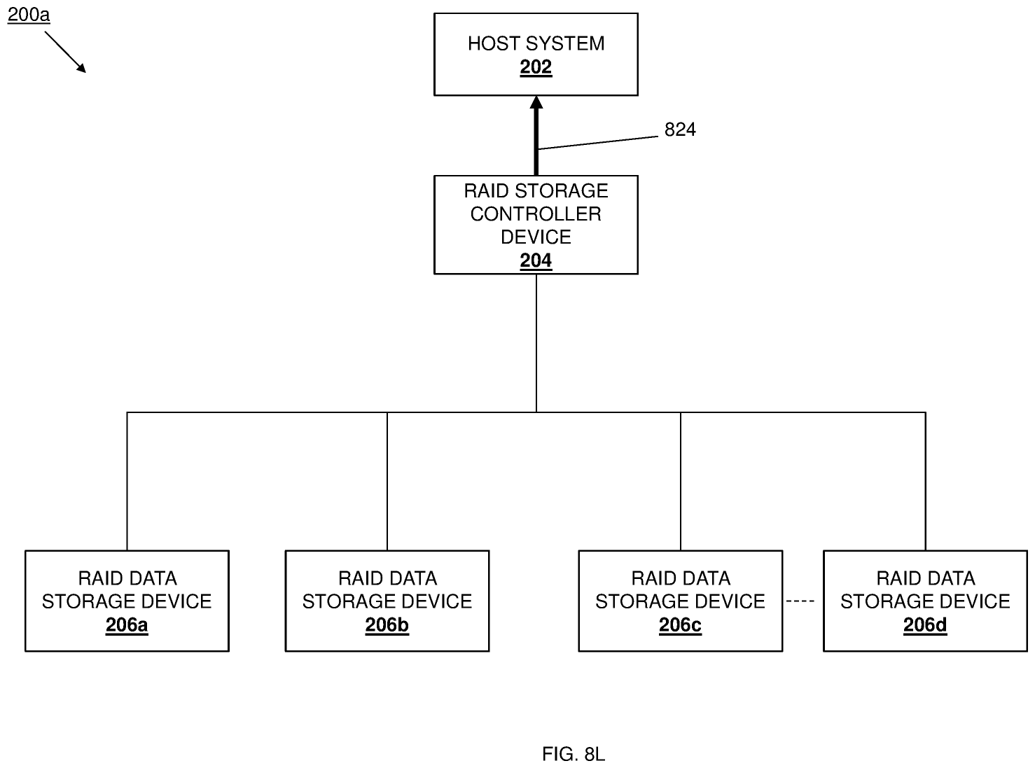

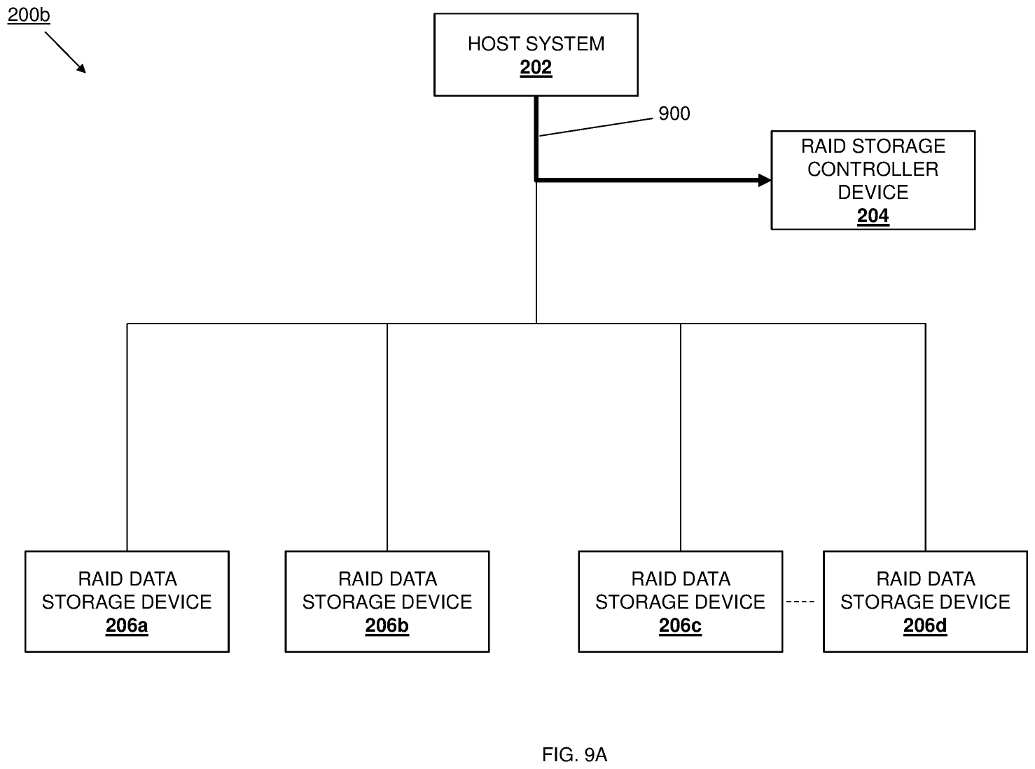

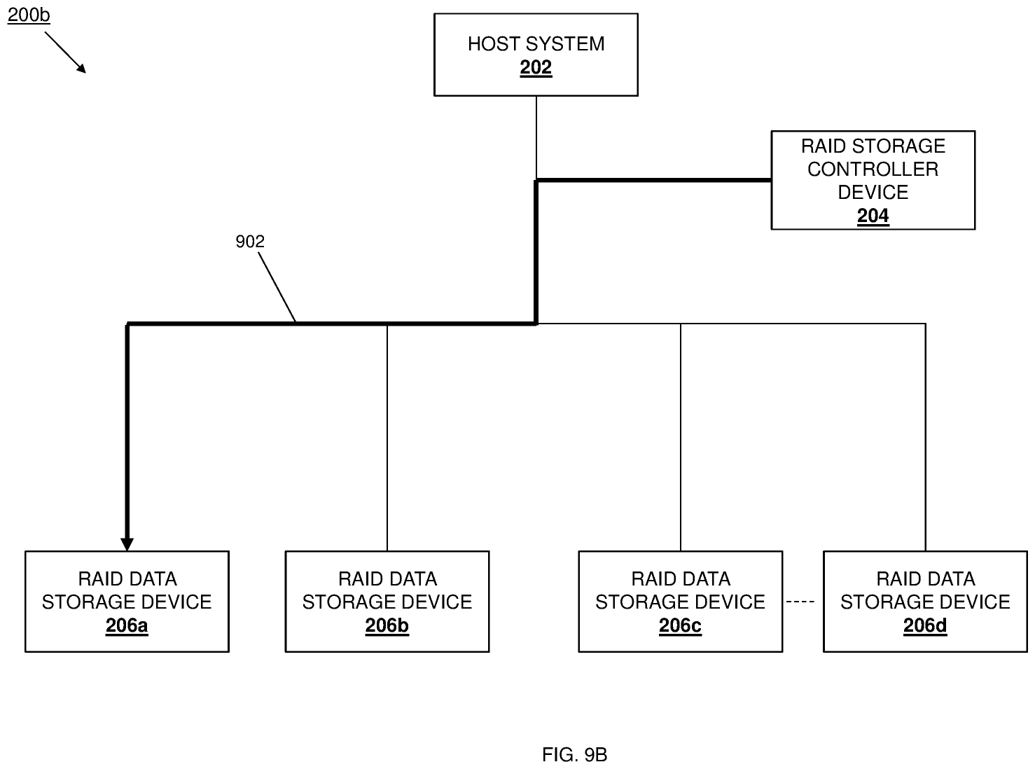

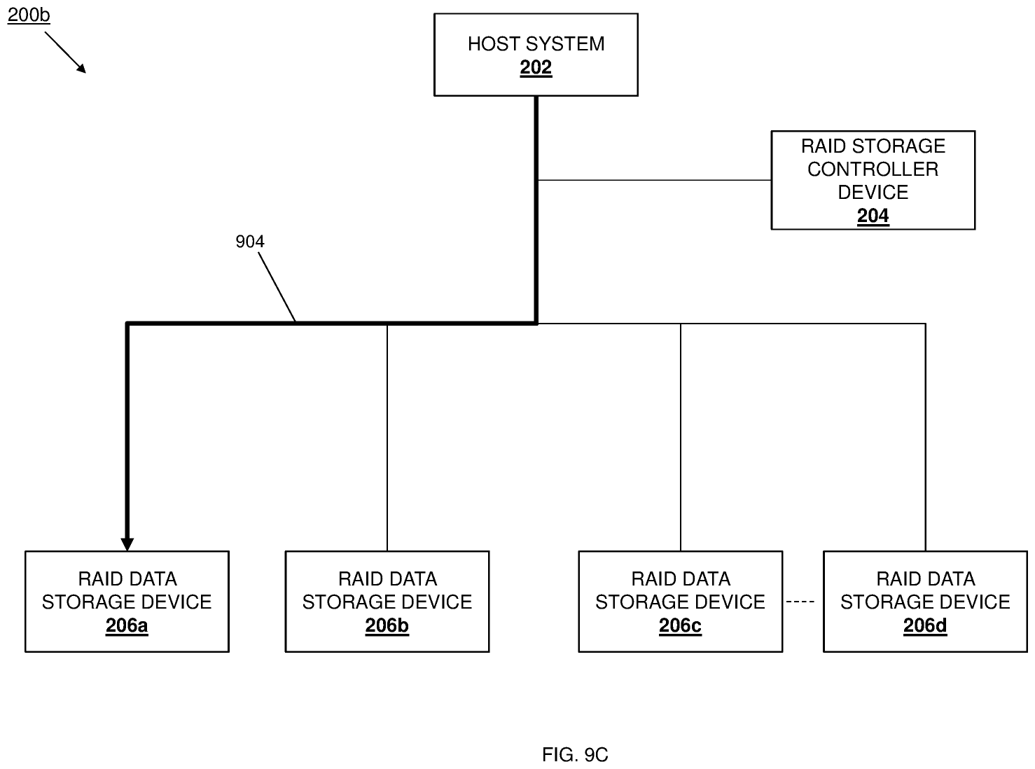

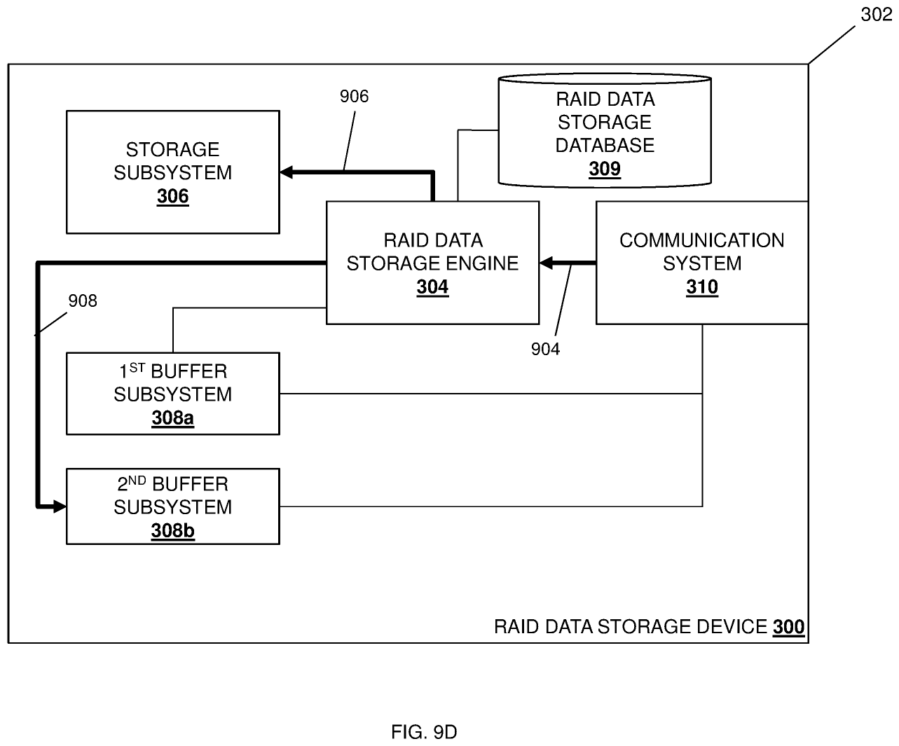

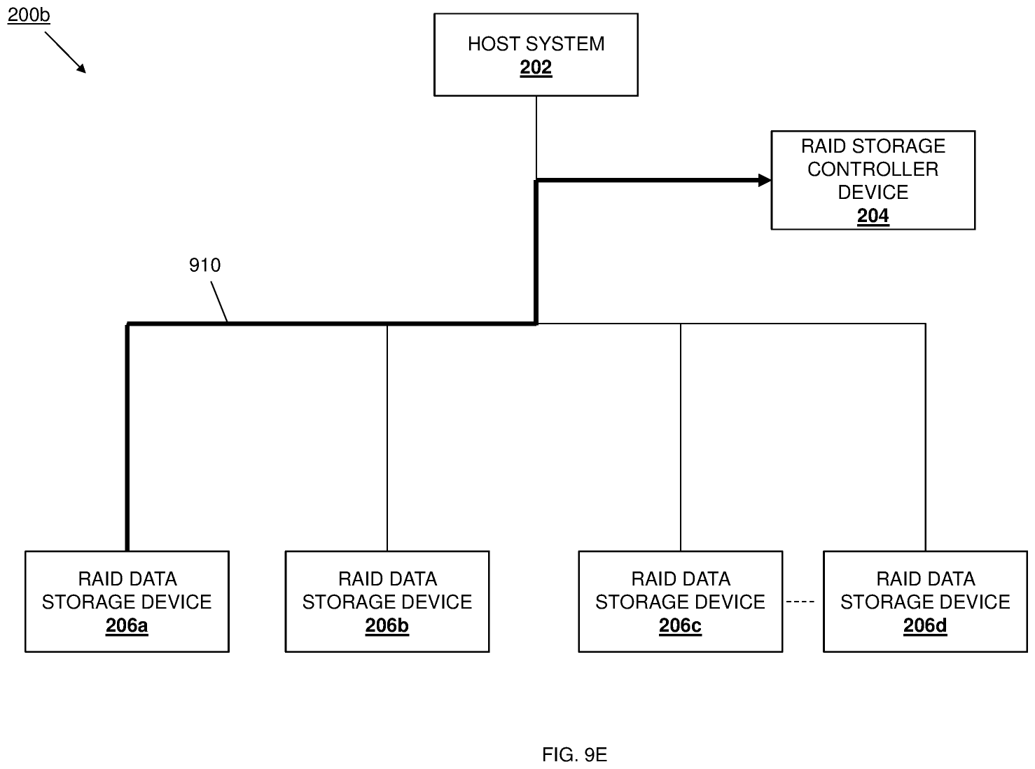

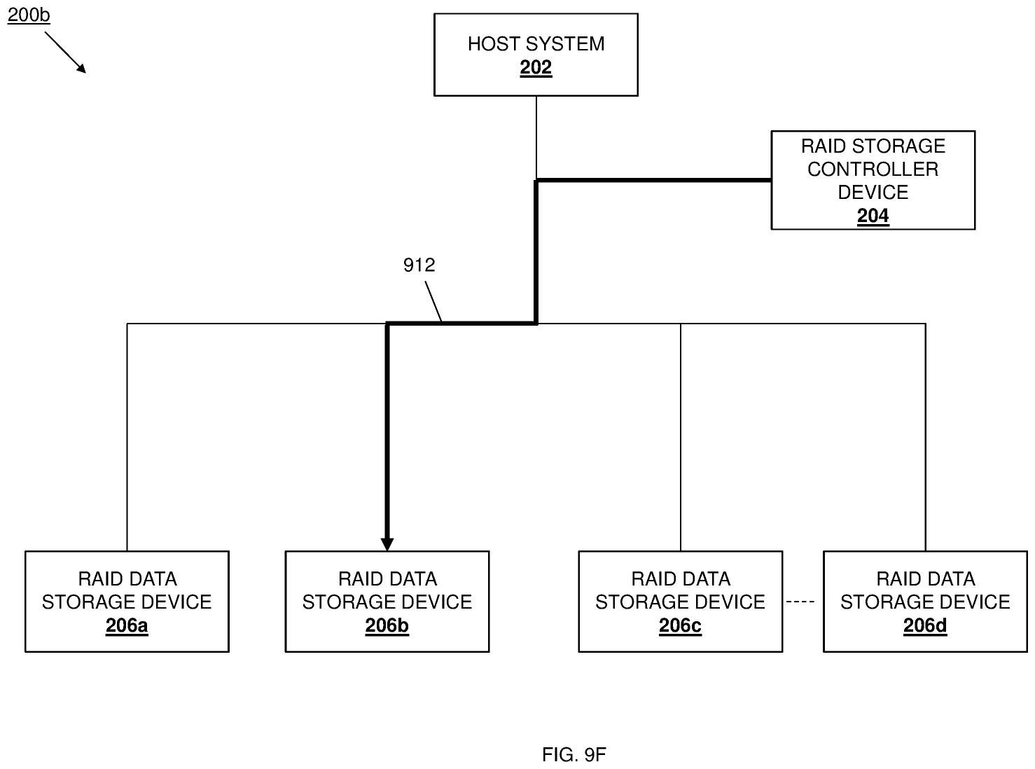

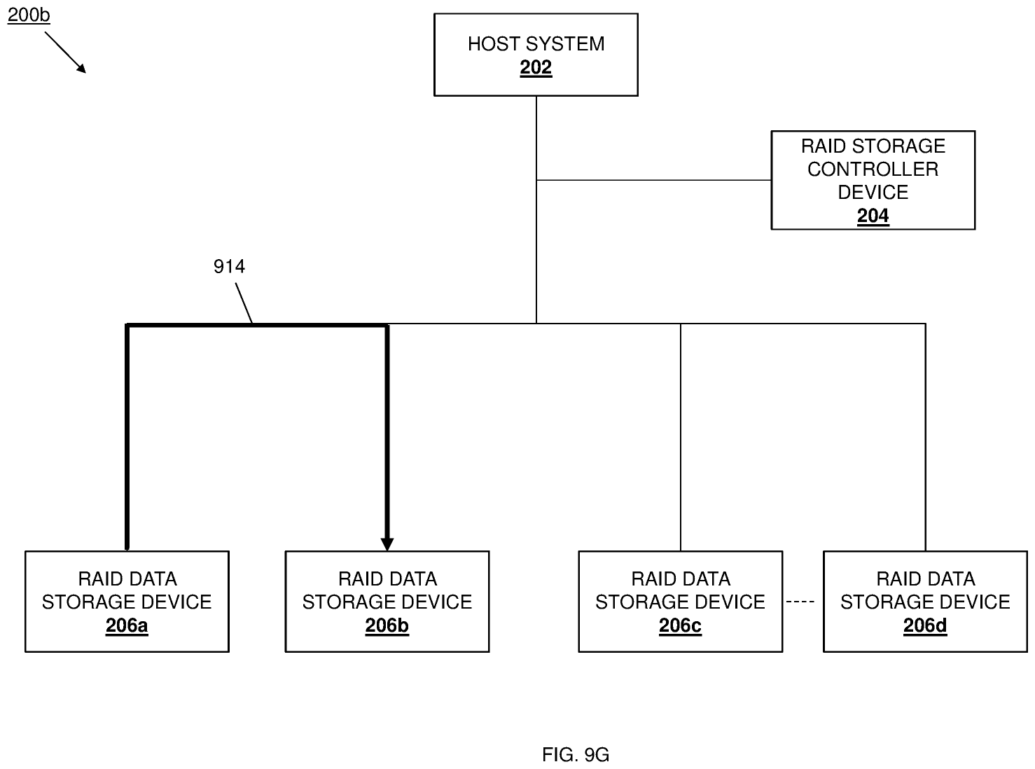

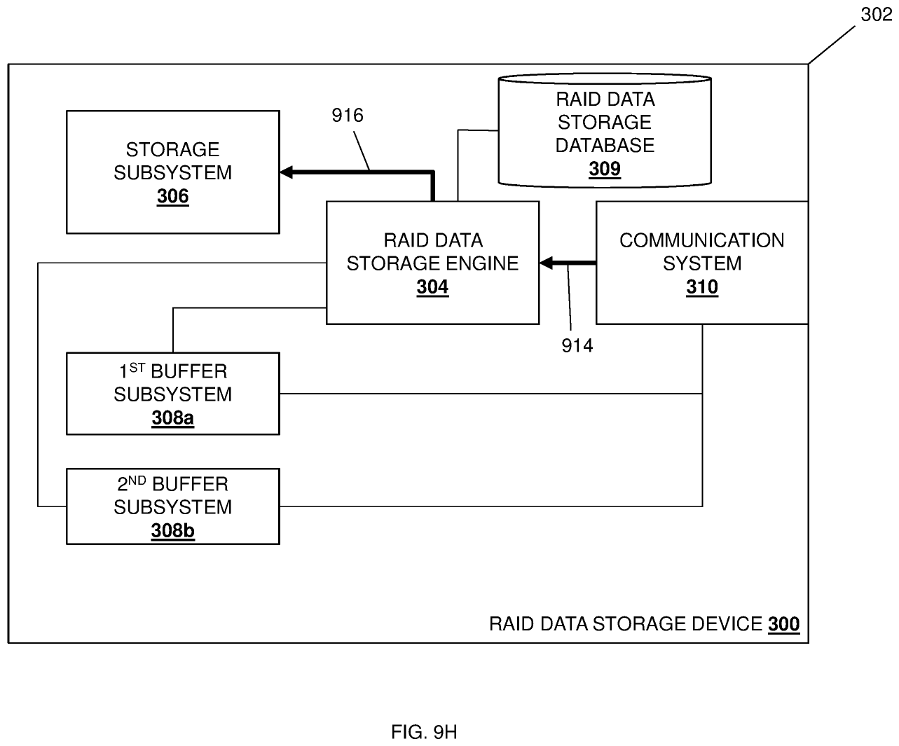

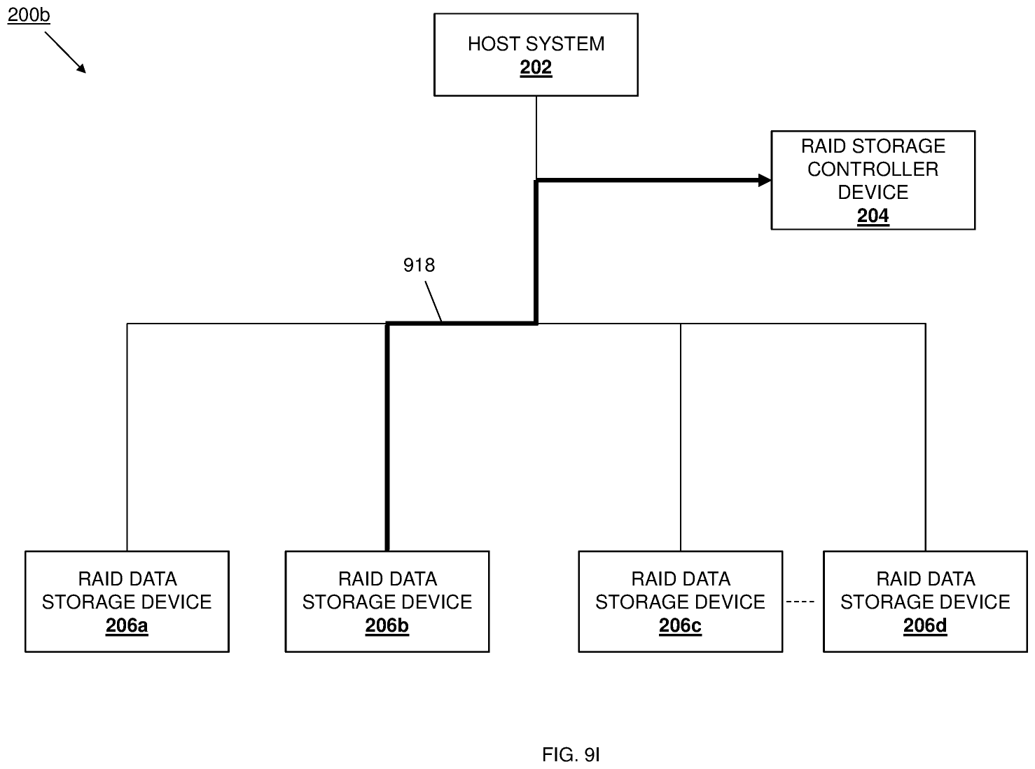

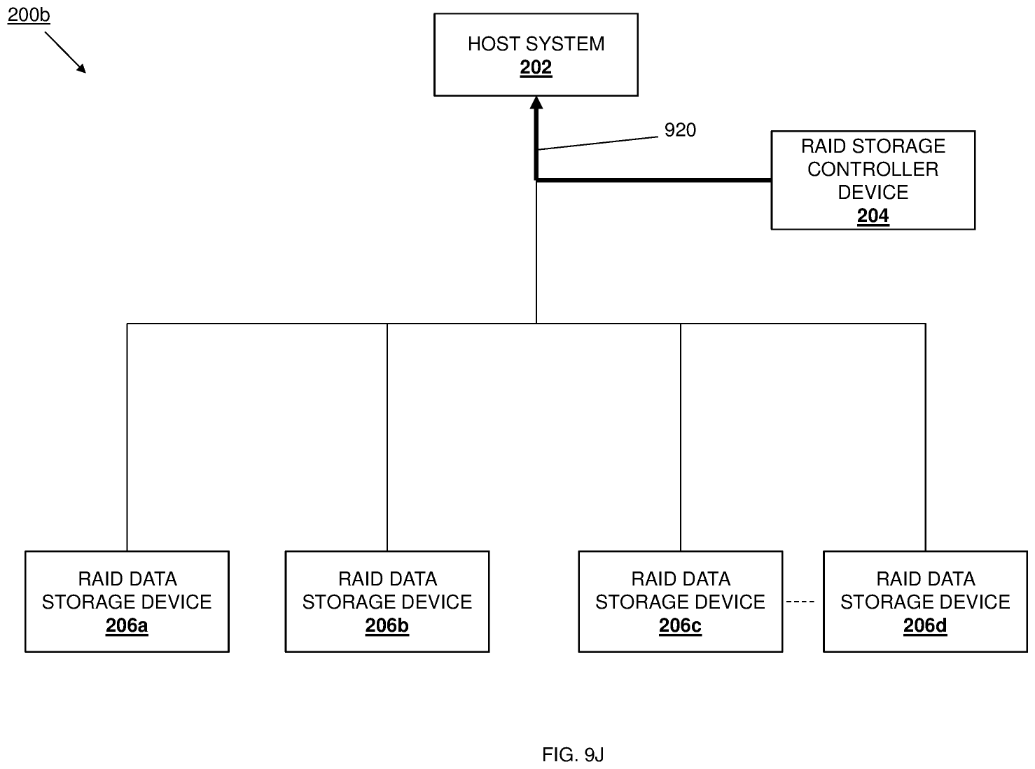

The method 700 begins at block 702 where a RAID storage controller device identifies data for mirroring in RAID data storage devices. In an embodiment, at block 702, the RAID storage controller engine 404 in the RAID storage controller device 204/400 may identify data for mirroring in the RAID data storage devices 206a-206d. For example, FIGS. 8A and 9A illustrate how the host system 202 may generate and transmit respective write commands 800 and 900 to the RAID storage controller device 204 to write data stored on the host system 202 to the RAID data storage devices 206a-206d. As such, in an embodiment of block 702, the RAID storage controller engine 404 in the RAID storage controller device 204/400 may receive the write command 800 or 900 via its communication system 408 and, in response, identify the data stored on the host system 202 for mirroring in the RAID data storage devices 206a-206d. However, while specific examples of the identification of data for mirroring on RAID data storage devices has been described, one of skill in the art in possession of the present disclosure will appreciate that a variety of data stored in a variety of locations may be identified for mirroring in RAID data storage devices while remaining within the scope of the present disclosure as well. In embodiments like the RAID storage system 200a that utilizes the “in-line” RAID storage controller device configuration, the RAID storage controller device 204/400 may retrieve the data identified at block 702 and store that data in its RAID storage controller storage subsystem 406. For example, FIGS. 8B and 8C illustrates the RAID storage controller device 204/400 performing data retrieval operations 802 to retrieve the data in the host system 202 that was identified at block 702 via its communication system 408, and performing data storage operations 804 to store that data in its RAID storage controller storage subsystem 406.

The method 700 then proceeds to block 704 where the RAID storage controller device transmits an instruction to a primary RAID data storage device to store a first copy of the data. In an embodiment, at block 704, the RAID storage controller engine 404 in the RAID storage controller device 204/400 may generate a data storage instruction that identifies the data for storage, and transmit that data storage instructions to the RAID storage data device 206a (a “primary” RAID data storage device in this example.) For example, FIGS. 8D and 9B illustrate how the RAID storage controller engine 404 in the RAID storage controller device 204/400 may generate and transmit respective storage commands 806 and 902 to the RAID data storage device 206a to store the data identified at block 702 on the RAID data storage device 206a. In some embodiments, the commands 806 and 902 may be multi-operation commands like those described in U.S. patent application Ser. No. 16/585,296, attorney docket no. 16356.2084US01, filed on Sep. 27, 2019. In a specific example, at block 704 the RAID storage controller device 204 may submit the storage command 806 or 902 to the submission queue in the communication system 310 of the RAID data storage device 206a, and then ring the doorbell of the RAID data storage device 206a. As such, in an embodiment of block 704, the RAID data storage engine 304 in the RAID data storage device 206a/300 may receive the storage command 806 or 902 via its communication system 310 and, in some embodiments, may identify the multiple operations instructed by those commands 806 or 902 (as described in U.S. patent application Ser. No. 16/585,296, attorney docket no. 16356.2084US01, filed on Sep. 27, 2019.) However, while specific examples of the instructing of a RAID data storage device to retrieve data for storage has been described, one of skill in the art in possession of the present disclosure will appreciate that data storage instructions may be provided to a RAID data storage device in a variety of manners while remaining within the scope of the present disclosure as well.

The method 700 then proceeds to block 706 where the primary RAID data storage device retrieves and stores the data. In an embodiment, at block 706, the RAID data storage engine 304 in the RAID data storage device 206a/300 may operate to retrieve the data identified in the storage command received at block 704 and, in response, retrieve and storage that data. For example, FIGS. 8E and 8F illustrate how the RAID data storage engine 304 in the RAID data storage device 206a/300 may retrieve the storage command 806 from the submission queue in its communication system 310 and, in response, may execute that storage command 806 and perform a Direct Memory Access (DMA) operation 808 to retrieve the data from the RAID storage controller storage subsystem 406 in the RAID storage controller device 204/400 (e.g., via the direct link between the communication system 408 and the RAID storage controller storage subsystem 406), perform a first storage operation 810 to store the data in the its storage subsystem 306, and perform a second storage operation 812 to store the data in its second buffer subsystem 308b.

In another example, FIGS. 9C and 9D illustrate how the RAID data storage engine 304 in the RAID data storage device 206a/300 may retrieve the storage command 902 from the submission queue in its communication system 310 and, in response, may execute that storage command 902 and perform a DMA operation 904 to retrieve the data directly from the host system 202 (e.g., a memory system in the host system 202 that stores the data), perform a first storage operation 906 to store the data in the its storage subsystem 306, and perform a second storage operation 908 to store the data in its second buffer subsystem 308b. As will be appreciated by one of skill in the art in possession of the present disclosure, the “look-aside” RAID storage controller device configuration in the RAID storage system 200b allows the RAID data storage device 206a direct access to the host system 202 for the data retrieval operations at block 706, thus offloading processing operations (data retrieval and data access) and memory operations (data storage) from the RAID storage controller device 204 relative to the “in-line” RAID storage controller device configuration in the RAID storage system 200a.

Subsequent to storing the data in its storage subsystem 306 and second buffer subsystem 308b, the RAID data storage engine 304 in the RAID data storage device 206a/300 may generate and transmit a completion communication to the RAID storage controller device 204. For example, FIGS. 8G and 9E illustrate how the RAID data storage engine 304 in the RAID data storage device 206a/300 may generate and transmit a completion communication 814 or 910 via its communication system 310 to the RAID storage controller device 204 in response to storing the data in its storage subsystem 306 and second buffer subsystem 308b. As such, at block 706, the RAID storage controller engine 404 in the RAID storage controller device 204/400 may receive the completion communication 814 or 910 via its communication system 408. However, while specific examples of the retrieval of data for storage in a primary RAID data storage device have been described, one of skill in the art in possession of the present disclosure will appreciate that data may be retrieved and stored in a primary RAID data storage device in a variety of manner that will fall within the scope of the present disclosure as well.

The method 700 then proceeds to block 708 where the RAID storage controller device transmits an instruction to a secondary RAID data storage device to store a second copy of the data. In an embodiment, at block 708 and in response to receiving the completion communication from the primary RAID storage device 206a, the RAID storage controller engine 404 in the RAID storage controller device 204/400 may generate a data storage instruction that identifies the data for back up or “mirroring”, and transmit that data storage instructions to the RAID data storage device 206b (a “secondary” RAID data storage device in this example.) For example, FIGS. 8H and 9F illustrate how the RAID storage controller engine 404 in the RAID storage controller device 204/400 may generate and transmit respective storage commands 816 and 912 to the RAID data storage device 206b to store the data identified at block 702 on the RAID data storage device 206b. In some embodiments, the commands 816 and 912 may be multi-operation commands like those described in U.S. patent application Ser. No. 16/585,296, attorney docket no. 16356.2084US01, filed on Sep. 27, 2019. In a specific example, at block 708 the RAID storage controller device 204 may submit the storage command 816 or 912 to the submission queue in the communication system 310 of the RAID data storage device 206b, and then ring the doorbell of the RAID data storage device 206b. As such, in an embodiment of block 708, the RAID data storage engine 304 in the RAID data storage device 206a/300 may receive the storage command 816 or 912 via its communication system 310 and, in some embodiments, may identify the multiple operations instructed by those commands 816 or 912 (as described in U.S. patent application Ser. No. 16/585,296, attorney docket no. 16356.2084US01, filed on Sep. 27, 2019.) However, while specific examples of the instructing of a RAID data storage device to retrieve data for mirroring has been described, one of skill in the art in possession of the present disclosure will appreciate that data mirroring instructions may be provided to a RAID data storage device in a variety of manners while remaining within the scope of the present disclosure as well

The method 700 then proceeds to block 710 where the secondary RAID data storage device retrieves and stores the data. In an embodiment, at block 710, the RAID data storage engine 304 in the RAID data storage device 206b/300 may operate to retrieve the data identified in the storage command received at block 708 and, in response, retrieve and store that data. For example, FIGS. 8I and 8J illustrate how the RAID data storage engine 304 in the RAID data storage device 206b/300 may retrieve the storage command 816 from the submission queue in its communication system 310 and, in response, may execute that storage command 816 and perform a DMA operation 818 to retrieve the data directly from the second buffer subsystem 308b in the RAID data storage device 206a/300 (e.g., via the direct link between the communication system 310 and the second buffer subsystem 308b), and perform a storage operation 820 to store the data in its storage subsystem 306.

In another example, FIGS. 9G and 9H illustrate how the RAID data storage engine 304 in the RAID data storage device 206b/300 may retrieve the storage command 912 from the submission queue in its communication system 310 and, in response, may execute that storage command 912 and perform a DMA operation 914 to retrieve the data directly from the second buffer subsystem 308b in the RAID data storage device 206a/300 (e.g., via the direct link between the communication system 310 and the second buffer subsystem 308b), and perform a storage operation 916 to store the data in its storage subsystem 306. As will be appreciated by one of skill in the art in possession of the present disclosure, the direct access and retrieval of the data by the RAID storage device 206b from the second buffer subsystem 308b in the RAID data storage device 206a may offload processing operations and memory operations from the RAID storage controller device 204, thus allowing the RAID storage controller devices to scale with higher performance RAID data storage devices, and/or allowing relatively lower capability RAID storage controller devices to be utilized with the RAID storage system.

Subsequent to storing the data in its storage subsystem 306, the RAID data storage engine 304 in the RAID data storage device 206b/300 may generate and transmit a completion communication to the RAID storage controller device 204. For example, FIGS. 8K and 9I illustrate how the RAID data storage engine 304 in the RAID data storage device 206a/300 may generate and transmit a completion communication 822 or 918 via its communication system 310 to the RAID storage controller device 204 in response to storing the data in its storage subsystem 306. As such, at block 710, the RAID storage controller engine 404 in the RAID storage controller device 204/400 may receive the completion communication 822 or 918 via its communication system 408. However, while specific examples of the retrieval of data for mirroring in a secondary RAID data storage device have been described, one of skill in the art in possession of the present disclosure will appreciate that data may be retrieved and mirrored in a secondary RAID data storage device in a variety of manner that will fall within the scope of the present disclosure as well.

The method 700 then proceeds to block 712 where the RAID storage controller device determines that the data has been mirrored and sends a data mirroring completion communication. As illustrated in FIGS. 8L and 9J, in an embodiment of block 712 and in response to receiving the completion communication from the secondary RAID storage device 206b, the RAID storage controller engine 404 in the RAID storage controller device 204/400 may generate and transmit a completion communication 824 or 920 to the host system 202 that indicates to the host system 202 that the write command 800 or 900 has been executed to store and mirror the data from the host system 200 in the RAID storage devices 206a and 206b.

Thus, systems and methods have been described that provide for data mirroring in a RAID storage system with the assistance of the RAID data storage NVMe SSDs in order to offload processing operations, memory usage, and/or other functionality from the RAID storage controller device. For example, a RAID storage controller device that identifies data for mirroring may send a first instruction to a primary RAID data storage NVMe SSD to store a first copy of the data and, in response, the primary RAID data storage NVMe SSD will retrieve and store that data in its flash storage subsystem as well as its CMB subsystem. The RAID storage controller device may then send a second instruction to a secondary RAID data storage NVMe SSD to store a second copy of the data and, in response, the secondary RAID data storage NVMe SSD will retrieve that data directly from the CMB subsystem in the primary RAID data storage NVMe SSD, and store that data in its flash storage subsystem. As such, some data mirroring operations are offloaded from the RAID storage controller device, thus allowing the RAID storage controller device to scale with higher performance RAID data storage NVMe SSDs, and/or allowing relatively lower capability RAID storage controller devices to be utilized with the RAID storage system.

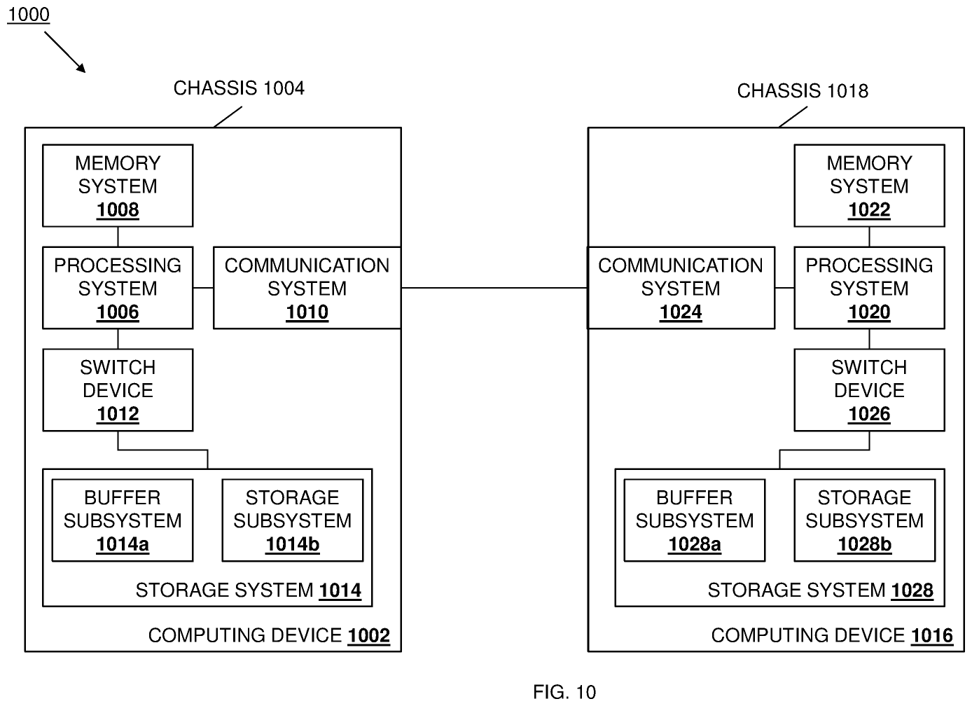

Referring now to FIG. 10, an embodiment of a Software Defined Storage (SDS) data mirroring system 1000 is illustrated. In the illustrated embodiment, the SDS data mirroring system 1000 includes a computing device 1002 that may be provided by the IHS 100 discussed above with reference to FIG. 1 and/or may include some or all of the components of the IHS 100, and in specific embodiments may be provided by a server device. However, while illustrated and discussed as being provided by a server device, one of skill in the art in possession of the present disclosure will recognize that the functionality of the computing device 1002 discussed below may be provided by other devices that are configured to operate similarly as the computing device 1002 discussed below. As will be apparent to one of skill in the art in possession of the present disclosure, the computing device 1002 is described as a “primary” computing device in the examples below to indicate that data is stored on that computing device and backed up or “mirrored” on another computing device in order to provide access to the data in the event one of those computing devices becomes unavailable, but one of skill in the art in possession of the present disclosure will appreciate that such conventions may change for the storage of different data in the SDS data mirroring system of the present disclosure.

In the illustrated embodiment, the computing device 1002 includes a chassis 1004 that houses the components of the computing device 1002, only some of which are illustrated below. For example, the chassis 1004 may house a processing system 1006 (e.g., which may include one or more of the processor 102 discussed above with reference to FIG. 1) and a memory system 1008 (e.g., which may include the memory 114 discussed above with reference to FIG. 1) that is coupled to the processing system 1006. As discussed below, in some embodiments, the processing system 1006 and memory system 1008 may provide different processing subsystems and memory subsystems such as, for example, the SDS processing subsystem and SDS memory subsystem that includes instructions that, when executed by the SDS processing subsystem, cause the SDS processing subsystem to provide an SDS engine (e.g., the SDS data mirroring engine discussed below) that is configured to perform the functionality of the SDS engines and/or computing devices discussed below. As will be appreciated by one of skill in the art in possession of the present disclosure, the processing system 1006 and memory system 1008 may provide a main processing subsystem (e.g., a Central Processing Unit (CPU)) and main memory subsystem (i.e., in addition to the SDS processing subsystem and SDS memory subsystem discussed above) in order to provide the functionality discussed below.

The chassis 1004 may also house a communication system 1010 that is coupled to the processing system 1006 and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. In the illustrated embodiment, the chassis 1004 also houses a storage system 1014 that is coupled to the processing system 1006 by a switch device 1012, and that includes a buffer subsystem 1014a and a storage subsystem 1014b. In a specific example, the storage system 1014 may be provided by a Non-Volatile Memory express (NVMe) SSD storage device (or “drive”), with the buffer subsystem 1014a provided by a Controller Memory Buffer (CMB) subsystem, and the storage subsystem 1014b provided by flash memory device(s). However, one of skill in the art in possession of the present disclosure will recognize that other types of storage systems with similar functionality as the NVMe SSD storage device (e.g., NVMe PCIe add-in cards, NVMe M.2 cards, etc.) may be implemented according to the teachings of the present disclosure and thus will fall within its scope as well. Furthermore, while a specific primary computing device 1002 has been illustrated, one of skill in the art in possession of the present disclosure will recognize that computing devices (or other devices operating according to the teachings of the present disclosure in a manner similar to that described below for the computing device 1002) may include a variety of components and/or component configurations for providing conventional computing device functionality, as well as the functionality discussed below, while remaining within the scope of the present disclosure as well.

In the illustrated embodiment, the SDS data mirroring system 1000 also includes a computing device 1016 that may be provided by the IHS 100 discussed above with reference to FIG. 1 and/or may include some or all of the components of the IHS 100, and in specific embodiments may be provided by a server device. However, while illustrated and discussed as being provided by a server device, one of skill in the art in possession of the present disclosure will recognize that the functionality of the computing device 1016 discussed below may be provided by other devices that are configured to operate similarly as the computing device 1016 discussed below. As will be apparent to one of skill in the art in possession of the present disclosure, the computing device 1016 is described as a “secondary” computing device in the examples below to indicate that data is stored on another computing device and backed up or “mirrored” on that computing device in order to provide access to the data in the event one of those computing devices becomes unavailable, but one of skill in the art in possession of the present disclosure will appreciate that such conventions may change for the storage of different data in the SDS data mirroring system of the present disclosure.

In the illustrated embodiment, the computing device 1016 includes a chassis 1018 that houses the components of the computing device 1016, only some of which are illustrated below. For example, the chassis 1018 may house a processing system 1020 (e.g., which may include one or more of the processor 102 discussed above with reference to FIG. 1) and a memory system 1022 (e.g., which may include the memory 114 discussed above with reference to FIG. 1) that is coupled to the processing system 1020. As discussed below, in some embodiments, the processing system 1020 and memory system 1022 may provide different processing subsystems and memory subsystems such as, for example, the SDS processing subsystem and SDS memory subsystem that includes instructions that, when executed by the SDS processing subsystem, cause the SDS processing subsystem to provide an SDS engine (e.g., the SDS data mirroring engine discussed below) that is configured to perform the functionality of the SDS engines and/or computing devices discussed below. As will be appreciated by one of skill in the art in possession of the present disclosure, the processing system 1020 and memory system 1022 may provide a main processing subsystem (e.g., a CPU) and main memory subsystem (i.e., in addition to the SDS processing subsystem and SDS memory subsystem discussed above) in order to provide the functionality discussed below.

The chassis 1018 may also house a communication system 1024 that is coupled to the communication system 1010 in the computing device 1002 (e.g., via an Ethernet cable), as well as to the processing system 1020, and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. In the illustrated embodiment, the chassis 1018 also houses a storage system 1028 that is coupled to the processing system 1020 by a switch device 1026, and that includes a buffer subsystem 1028a and a storage subsystem 1028b. In a specific example, the storage system 1028 may be provided by a Non-Volatile Memory express (NVMe) SSD storage device, with the buffer subsystem 1028a provided by a Controller Memory Buffer (CMB) subsystem, and the storage subsystem 1028b provided by flash memory device(s). However, one of skill in the art in possession of the present disclosure will recognize that other types of storage systems with similar functionality as the NVMe SSD storage device (e.g., NVMe PCIe add-in cards, NVMe M.2 cards, etc.) may be implemented according to the teachings of the present disclosure and thus will fall within its scope as well. Furthermore, while a specific secondary computing device 1016 has been illustrated, one of skill in the art in possession of the present disclosure will recognize that computing devices (or other devices operating according to the teachings of the present disclosure in a manner similar to that described below for the computing device 1016) may include a variety of components and/or component configurations for providing conventional computing device functionality, as well as the functionality discussed below, while remaining within the scope of the present disclosure as well.

As will be appreciated by one of skill in the art in possession of the present disclosure, the SDS engines provided on the computing devices 1002 and 1016 may coordinate via a variety of SDS protocols (e.g., vendor-specific protocols) to determine where data should be written and what memory locations addresses a computing device should use when issuing remote direct memory access write commands to the other computing device. Furthermore, while a specific SDS data mirroring system 1000 is illustrated and described, one of skill in the art in possession of the present disclosure will recognize that SDS systems (or other systems operating according to the teachings of the present disclosure in a manner similar to that described below for the SDS data mirroring system 1000) may include a variety of components and/or component configurations for providing conventional SDS system functionality, as well as the functionality discussed below, while remaining within the scope of the present disclosure as well. For example, while only two computing devices are illustrated and described in the examples below, one of skill in the art in possession of the present disclosure will appreciate that SDS systems typically include many more computing devices (e.g., common SDS systems may utilize 40 computing devices), and those systems are envisioned as falling within the scope of the present disclosure as well.

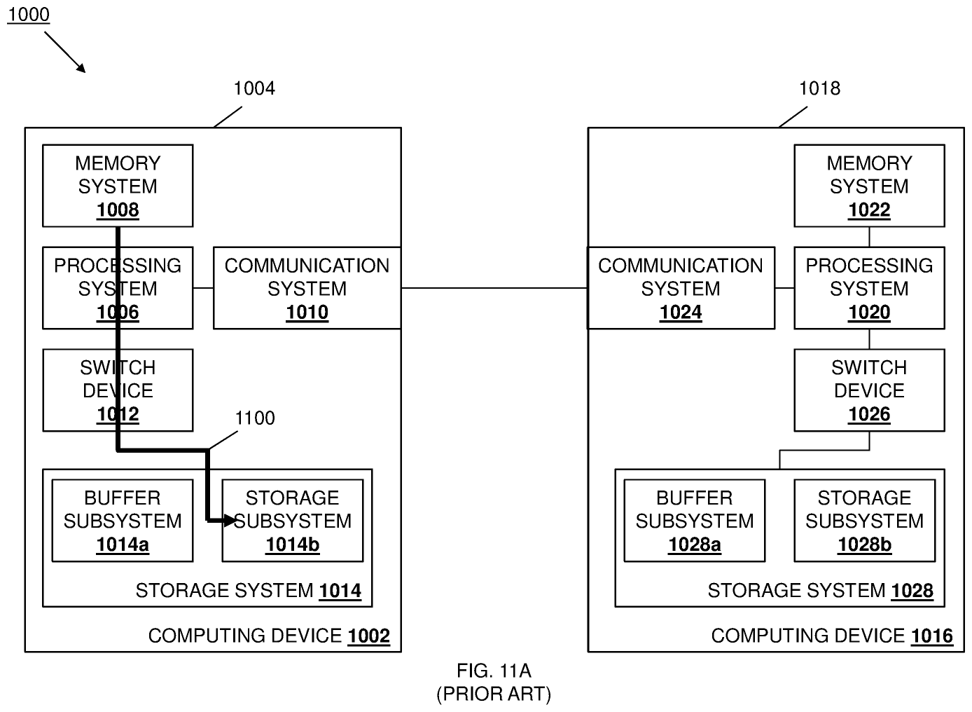

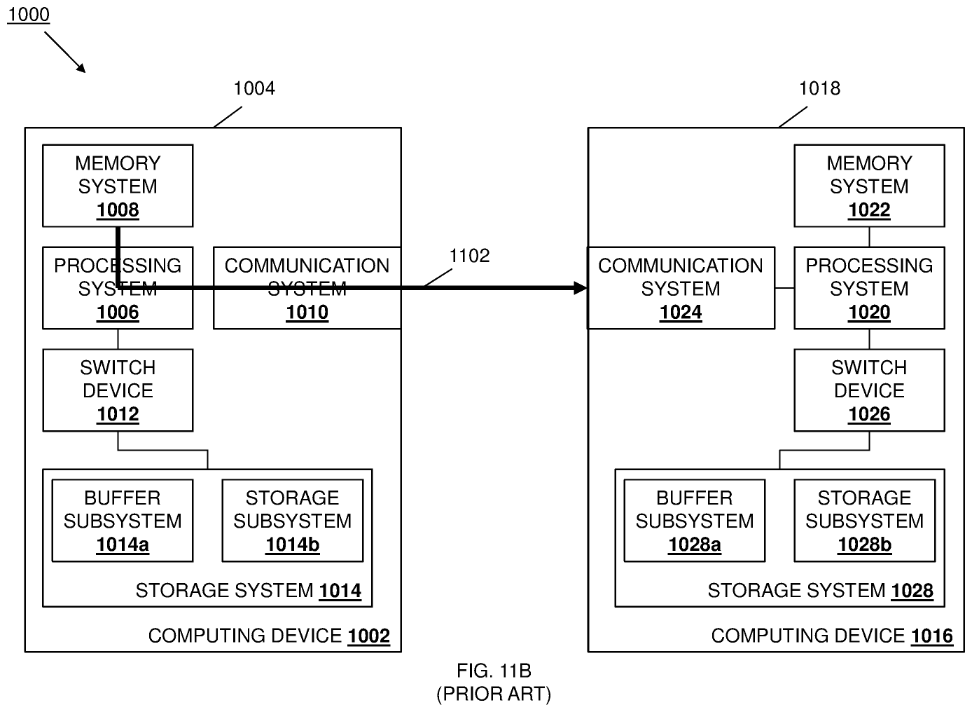

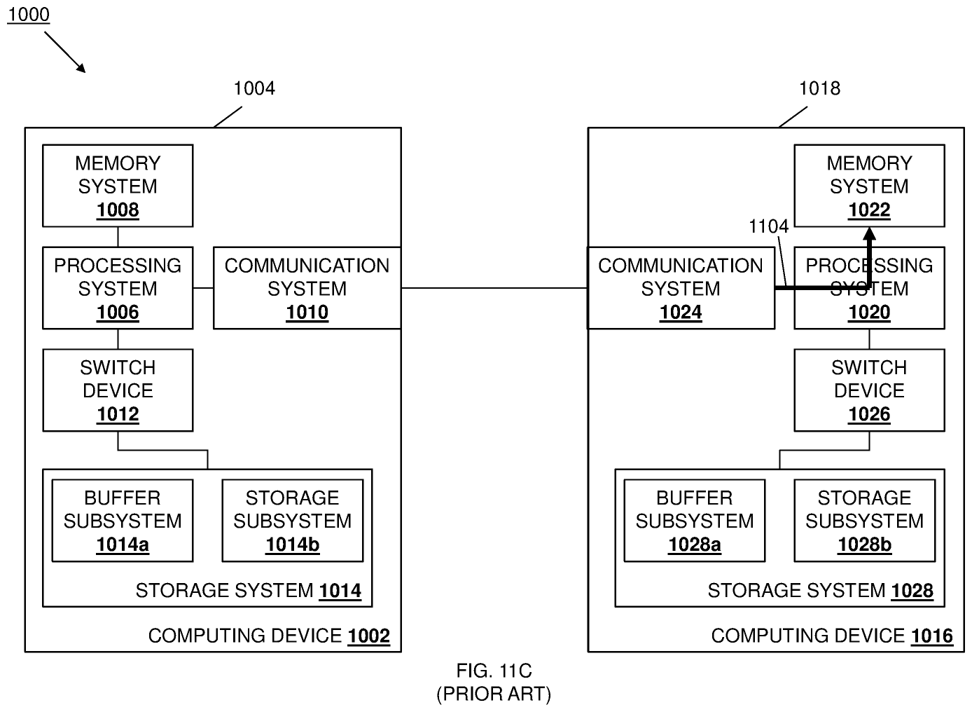

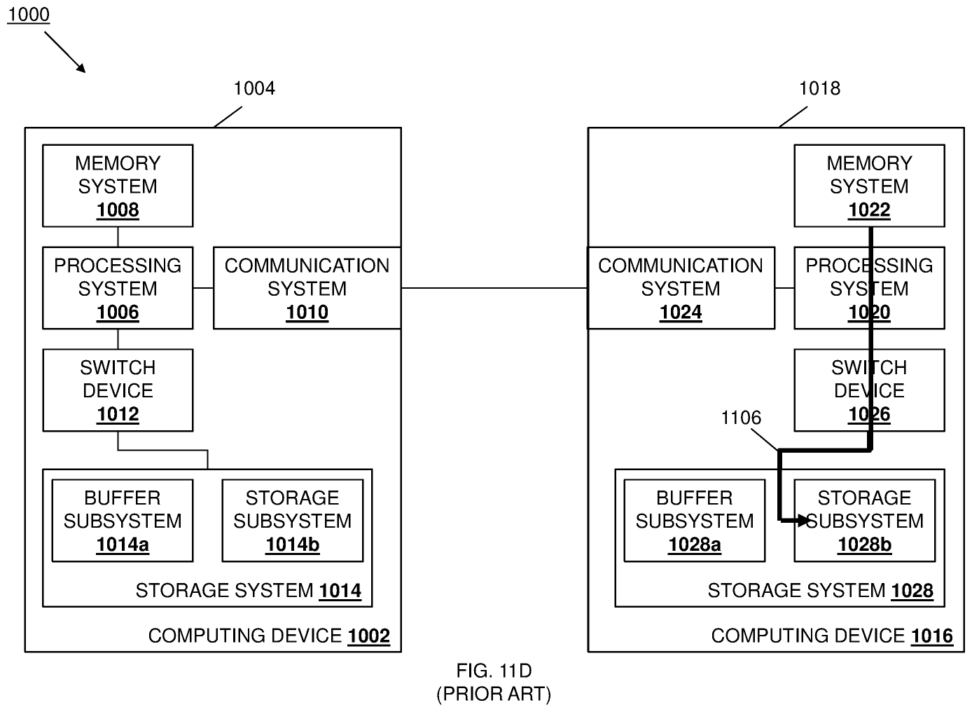

Referring now to FIGS. 11A, 11B, 11C, and 11D, conventional data mirroring operations for the SDS data mirroring system 1000 are briefly described in order to contrast the data mirroring operations of the SDS data mirroring system 1000 that are performed according to the teachings of the present disclosure, discussed in further detail below. As will be appreciated by one of skill in the art in possession of the present disclosure, data may be stored in the primary computing device 1002 by writing that data to the memory system 1008 (e.g., the main memory subsystem in the memory system 1008), and FIG. 11A illustrates how a write operation 1100 may be performed to write that data from the memory system 1008 to the storage subsystem 1014b. As illustrated in FIG. 11B, in order to backup or “mirror” that data, a write operation 1102 may then be performed to write that data from the memory system 1008 to the communication system 1010 in order to provide that data to the communication system 1024 in the secondary computing device 1016. As illustrated in FIG. 11C, a write operation 1104 may then be performed on the data received at the communication system 1024 to write that data to the memory system 1022. Finally, FIG. 11D illustrates how a write operation 1106 may then be performed to write that data from the memory system 1022 to the storage subsystem 1028b.

As will be appreciated by one of skill in the art in possession of the present disclosure, the conventional data mirroring operations discussed above involve four data transfers (a first data transfer from the memory system 1008 to the storage system 1014, a second data transfer from the memory system 1008 to the communication system 1024, a third data transfer from the communication system 1024 to the memory system 1022, and a fourth data transfer from the memory system 1022 to the storage system 1028), two storage system commands (a first write command to the storage system 1014, and a second write command to the storage system 1028), and four memory system access operations (a first memory access operation to write the data from the memory system 1008 to the storage system 1014, a second memory access operation to write the data from the memory system 1008 for transmission to the communication system 1024, a third memory access operation to write the data to the memory system 1022, and a fourth memory access operation to write the data from the memory system 1022 to the storage system 1028.) As discussed below, the systems and methods of the present disclosure provide for a reduction in the number of data transfers and memory access operations, thus providing for a more efficient data mirroring process.

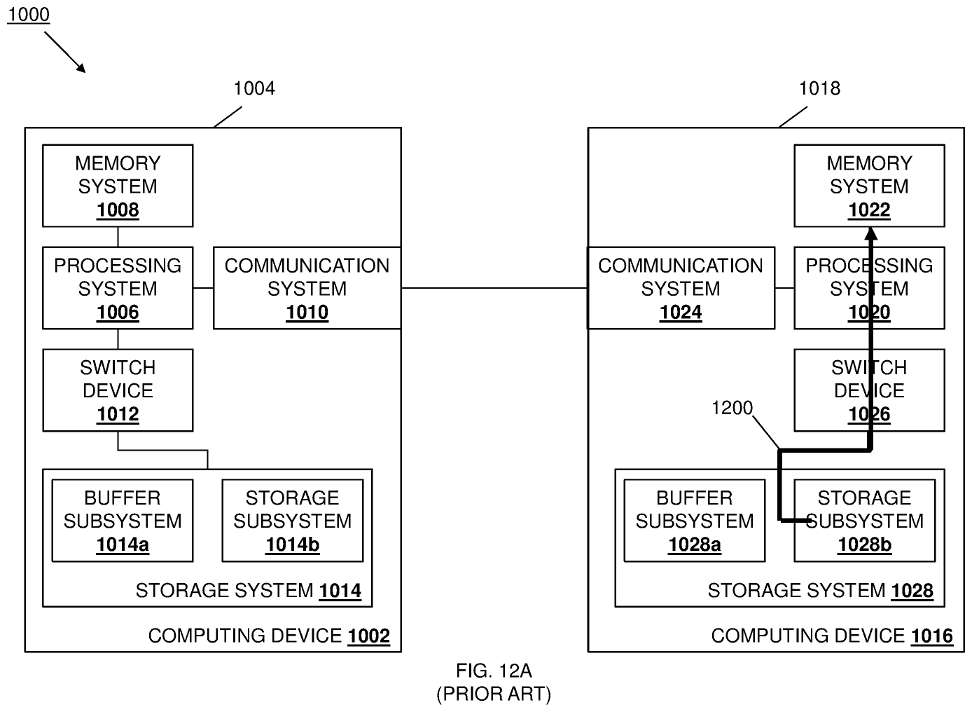

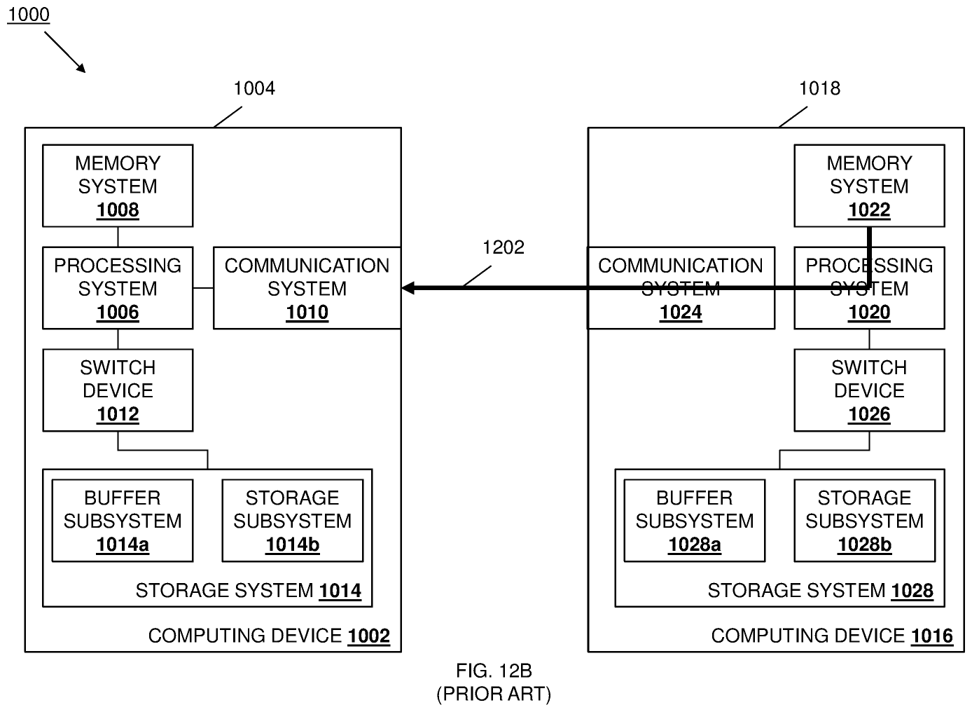

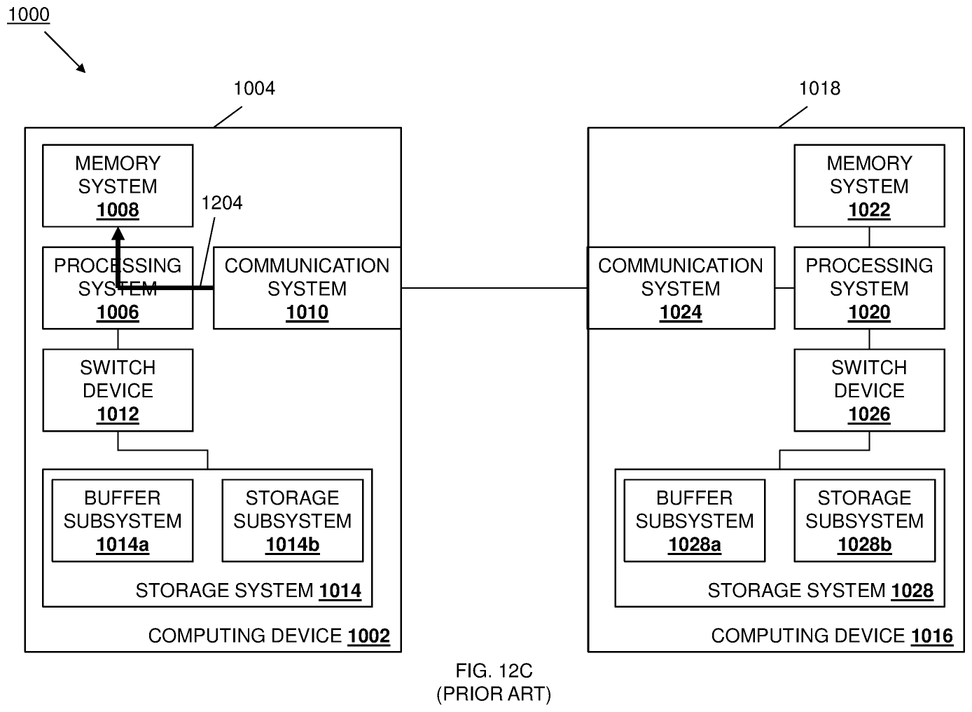

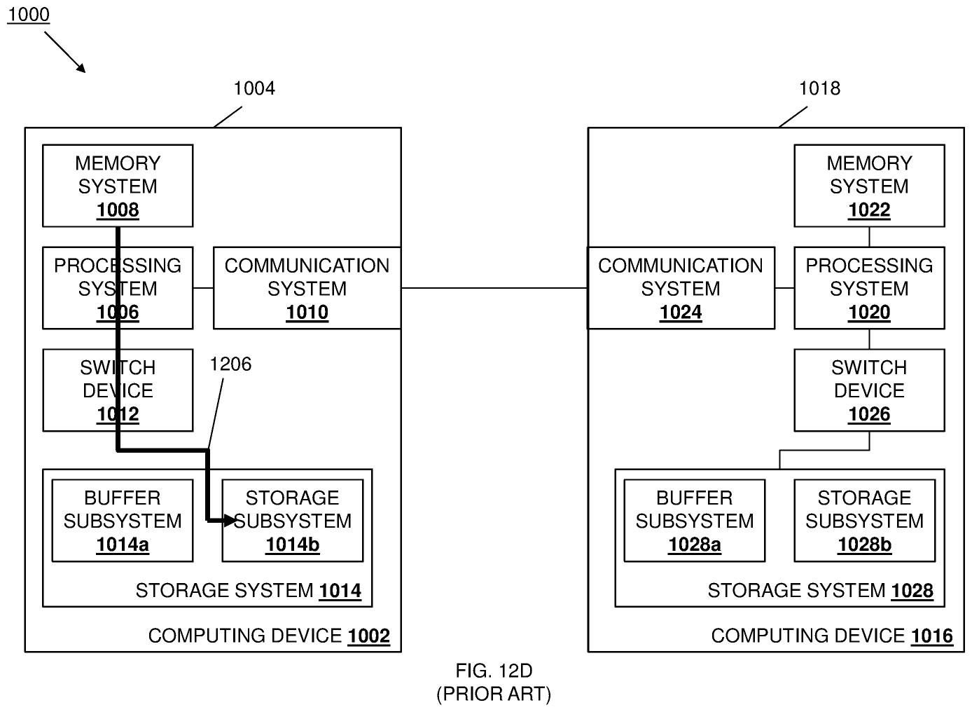

Referring now to FIGS. 12A, 12B, 12C, and 12D, conventional data recovery/rebuild/rebalance operations for the SDS data mirroring system 1000 are briefly described in order to contrast the data recovery/rebuild/rebalance operations of the SDS data mirroring system 1000 that are performed according to the teachings of the present disclosure, discussed in further detail below. As will be appreciated by one of skill in the art in possession of the present disclosure, data may need to be recovered, rebuilt, or rebalanced in the primary computing device 1002 in some situations such as, for example, a data corruption situation, a period of unavailability of the primary computing device, etc. FIG. 12A illustrates how, in response to such a situation, a read operation 1200 may be performed to read data from the storage subsystem 1028b and provide it on the memory system 1022. As illustrated in FIG. 12B, a read operation 1202 may then be performed to read that data from the memory system 1022 and provide it to the communication system 1024 in order to provide that data to the communication system 1010 in the primary computing device 1002. As illustrated in FIG. 12C, a write operation 1204 may then be performed on the data received via the communication system 1010 to write that data to the memory system 1008. Finally, FIG. 12D illustrates how a write operation 1206 may then be performed to write that data from the memory system 1008 to the storage subsystem 1014b.

As will be appreciated by one of skill in the art in possession of the present disclosure, the conventional data recovery/rebuild/rebalance operations discussed above involve four data transfers (a first data transfer from the storage system 1028 to the memory subsystem 1022, a second data transfer from the memory system 1022 to the communication system 1010, a third data transfer from the communication system 1010 to the memory system 1008, and a fourth data transfer from the memory system 1008 to the storage system 1014), two storage system commands (a read command from the storage system 1028, and a write command to the storage system 1014), and four memory system access operations (a first memory access operation to read the data from the storage system 1028 to the memory system 1022, a second memory access operation to read the data from the memory system 1022 for transmission to the communication system 1010, a third memory access operation to write the data to the memory system 1008, and a fourth memory access operation to write the data from the memory system 1008 to the storage system 1014.) As discussed below, the systems and methods of the present disclosure provide for a reduction in the number of data transfers and memory access operations, thus providing for a more efficient data recovery/rebuild/rebalance process.

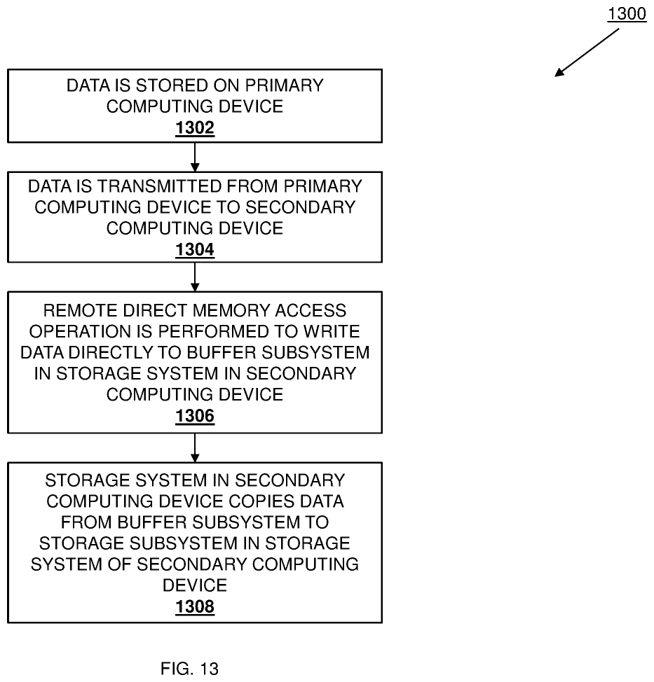

Referring now to FIG. 13, an embodiment of a method 1300 for SDS data mirroring is illustrated. As discussed below, the systems and methods of the present disclosure provide for data mirroring in an SDS system using remote direct memory access operations in order to reduce the number of data transfer operations and memory system access operations required to achieve the data mirroring relative to conventional SDS systems. For example, a primary computing device may write data to a primary memory system in the primary computing device, copy the data from the primary memory system to a primary storage system in the primary computing device, and transmit the data to a secondary computing device using a primary communication system in the primary computing device. The secondary computing device may then receive the data from the primary computing device at a secondary communication system in the secondary computing device, perform a remote direct memory access operation to write the data to a secondary buffer subsystem in a secondary storage system in the secondary computing device such that the data is not stored in a secondary memory system in the secondary computing device, and then copy the data from the secondary buffer subsystem in the secondary storage system in the secondary computing device to the secondary storage subsystem in the secondary storage system in the secondary computing device. As such, the number of data transfer operations and memory system access operations required to achieve data mirroring is reduced relative to conventional SDS systems.

In an embodiment, prior to or during the method 1300, a secondary SDS engine in the secondary computing device 1016 (e.g., the secondary SDS engine provided by the SDS processing system and SDS memory system in the secondary computing device 1016 discussed above) may operate to identify, to a primary SDS engine in the primary computing device 1002 (e.g., the primary SDS engine provided by the SDS processing system and SDS memory system in the primary computing device 1002 discussed above), the buffer subsystem 1028a in its storage system 1028 as a target for Remote Direct Memory Access (RDMA) write operations, which one of skill in the art in possession of the present disclosure will recognize enables SDS engines to write to a remote memory system. As will be appreciated by one of skill in the art in possession of the present disclosure, the conventional target of write operations by the primary computing device 1002 to the secondary computing device 1016 is the memory system 1022 in the secondary computing device 1016, and thus the identification of the buffer subsystem 1028a in the storage system 1028 of the secondary computing device 1016 as the target for RDMA write operations may override such conventional write operation target settings.

In a specific example, the secondary SDS engine in the secondary computing device 1016 may operate to identify to the primary SDS engine in the primary computing device 1002 one or more addresses in the buffer subsystem 1028a (e.g., CMB subsystem address(es)) as part of communications between the primary and secondary SDS engines. For example, the primary SDS engine in the primary computing device 1002 may specify those address(es) in a list of addresses (e.g., a Scatter Gather List (SGL)) as part of the RDMA Write operations or an RDMA Send in a Work Queue Entry (WQE). One of skill in the art in possession of the present disclosure will appreciate how the primary and secondary SDS engines may use RDMA semantics and/or other techniques to communicate in order to establish a destination buffer address (e.g., in a CMB subsystem), which allows the use of RDMA commands to transfer the data from the memory system 1008 in the primary computing device 1002 to the destination buffer address in the buffer subsystem 1028a in the secondary computing device 1016, as discussed in further detail below. However, while a few examples of configuration operations that are performed to allow the functionality provided via the systems and methods of the present disclosure, one of skill in the art in possession of the present disclosure will appreciate that other configuration operations may be performed to enable similar functionality while remaining within the scope of the present disclosure as well. Furthermore, while specific actions/operations are discussed herein as being performed by the primary SDS engine in the primary computing device 1002 and the secondary SDS engine in the secondary computing device 1016, one of skill in the art in possession of the present disclosure will appreciate that some of the SDS engine actions/operations/commands discussed herein may be generated by either SDS engine in either computing device 1002 or 1016 while remaining within the scope of the present disclosure as well.

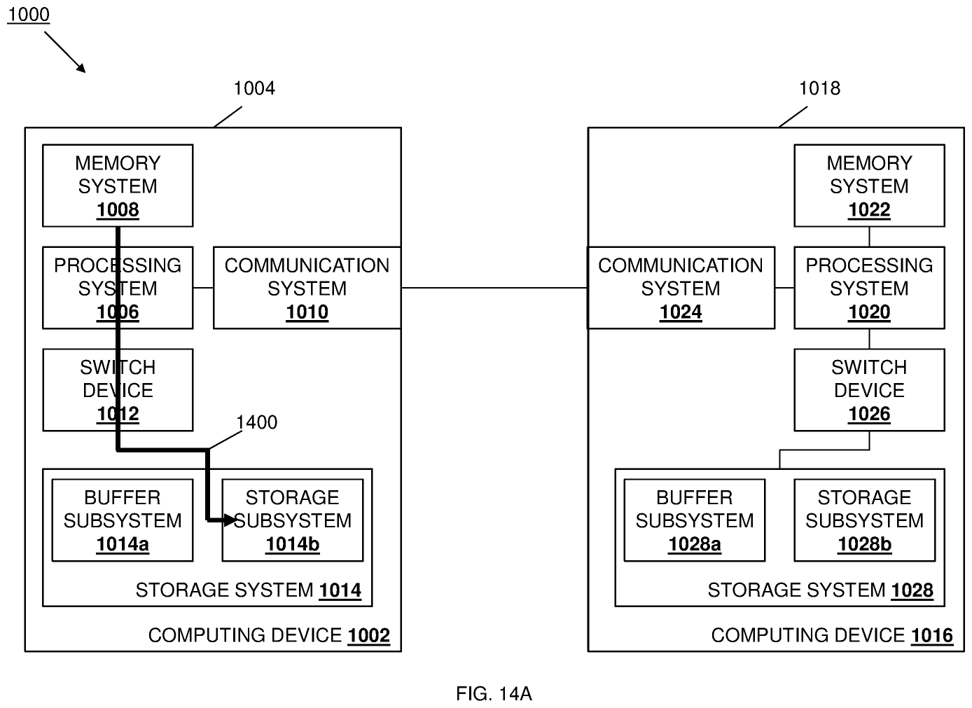

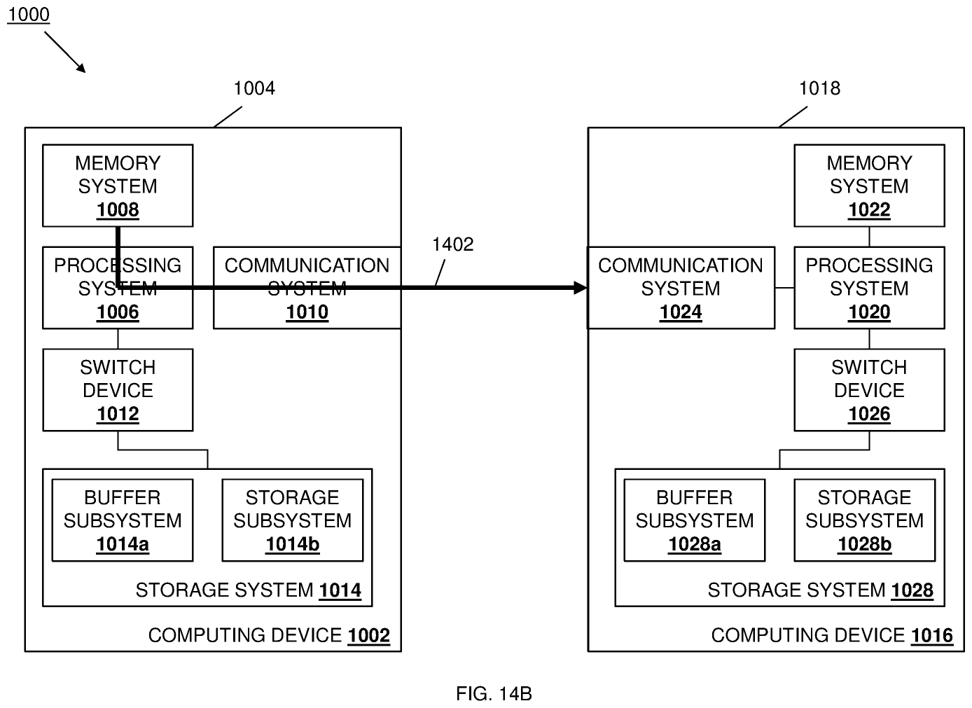

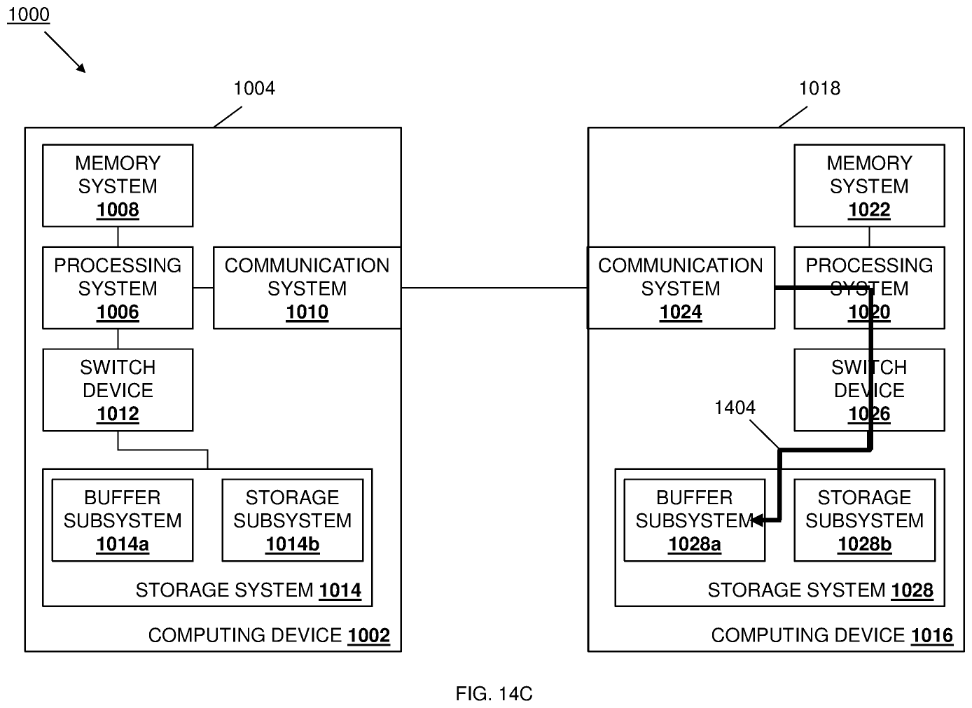

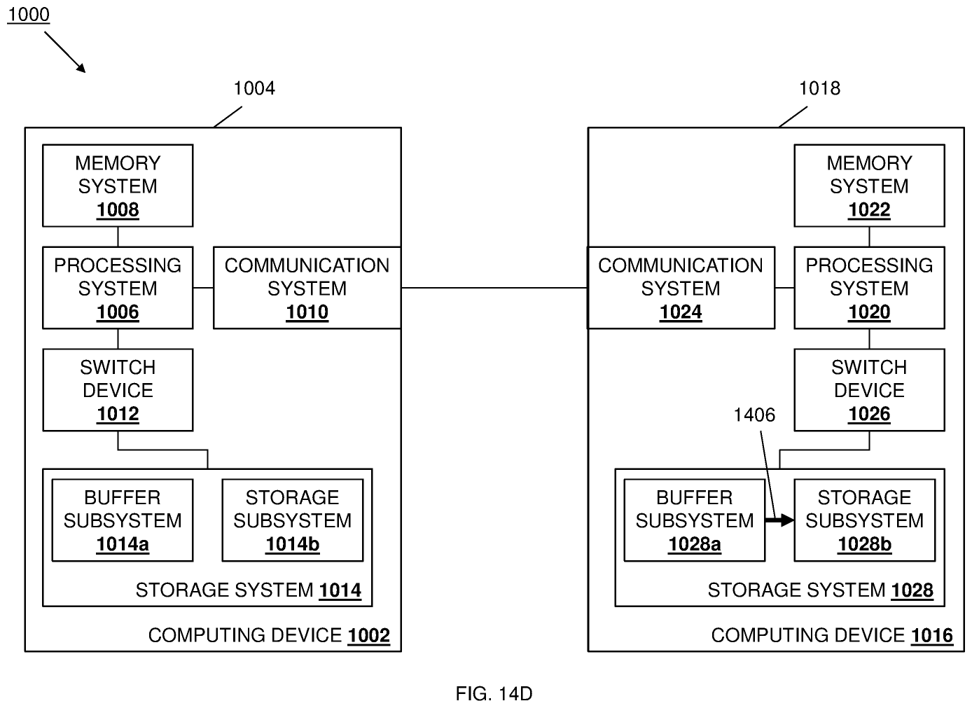

The method 1300 begins at block 1302 where data is stored on a primary computing device. In an embodiment, at block 1302, data may be stored on the memory system 1008 in the computing device 1002, which operates as a “primary computing device” that stores data that is mirrored via the method 1300 on the computing device 1016 that operates as a “secondary computing device” in this example. As will be appreciated by one of skill in the art in possession of the present disclosure, the data that is stored in the memory system 1008 at block 1302 may be any data generated by a variety of computing devices that utilize the SDS system 1000 for data storage, and thus may be generated by the primary computing device 1002 in some embodiments, or by computing devices other than the primary computing device 1002 in other embodiments. As illustrated in FIG. 14A, in an embodiment of block 1302 and in response to the data being stored on the memory system 1008, the storage system 1014 in the primary computing device 1002 may operate to perform a DMA read operation 1400 to read the data from the memory system 1008 to the storage subsystem 1014b in the storage system 1014. For example, in embodiments in which the storage subsystem 1014 is an NVMe SSD storage device 1014, block 1302 of the method 1300 may include the NVMe SSD storage device 1014 performing the DMA read operation 1400 to read the data from the memory system 1008 to the flash storage subsystem 1014b in the NVMe SSD storage device 1014.

The method 1300 then proceeds to block 1304 where the data is transmitted to a secondary computing device. As illustrated in FIG. 14B, in an embodiment of block 1304, the primary SDS engine in the primary computing device 1002 may operate to perform an SDS remote direct memory access write operation 1402 to transmit the data from the memory system 1008 and via the communication system 1010 in the primary computing device 1002 to the communication system 1024 in the secondary computing device 1016.

The method 1300 then proceeds to block 1306 where the remote direct memory access operation continues with the writing of the data directly to a buffer subsystem in a storage system in the secondary computing device. As illustrated in FIG. 14C, in an embodiment of block 1306, the secondary SDS engine in the secondary computing device 1016 may operate to perform an SDS RDMA write operation 1404 to write the data received at the communication system 1024 directly to the buffer subsystem 1028a in the storage system 1028 of the secondary computing device 1016 while bypassing the memory system 1022 in the secondary computing device 1016 (e.g., based on the designation of the buffer subsystem 1028a as the target for RDMA operations as discussed above.) For example, in embodiments in which the storage subsystem 1028 in the secondary computing device 1016 is an NVMe SSD storage device 1028, block 1306 of the method 1300 may include the secondary SDS engine in the secondary computing device 1016 performing the SDS write operation 1404 to write the data that was received at the communication system 1024 in the secondary computing device 1016 directly to the CMB subsystem 1028a in the NVMe SSD storage device 1028 in the secondary computing device 1016 (e.g., based on the designation of the CMB subsystem 1028a as the target for RDMA operations as discussed above.) As will be appreciated by one of skill in the art in possession of the present disclosure, the direct write of the data to the buffer subsystem 1028a in the secondary computing device 1016 may bypass a main processing subsystem in the secondary computing device 1016 (in addition to the memory system 1022.)

In an embodiment, in response to writing the data to the buffer subsystem 1028a in the storage system 1028 of the secondary computing device 1016, the secondary SDS engine in the secondary computing device 1016 may provide a write completion communication to the primary computing device 1002. For example, in response to writing the data to the buffer subsystem 1028a in the storage system 1028 of the secondary computing device 1016, the secondary SDS engine in the secondary computing device 1016 may provide a completion queue entry for the RDMA write operation to the primary computing system 1002. In response to receiving the write completion communication, the primary computing device 1002 may generate and transmit a write completion communication to the secondary computing device 1016 that indicates that the data has been written to the buffer subsystem 1028a in the storage system 1028 of the secondary computing device 1016. For example, in response to receiving the completion queue from the secondary SDS engine in the secondary computing device 1016, the primary computing device 1002 may generate and transmit a message to the secondary computing device 1016 that indicates that the data has been written to the buffer subsystem 1028a in the storage system 1028 of the secondary computing device 1016. As will be appreciate by one of skill in the art in possession of the present disclosure, the bypassing of the main processing subsystem in the secondary computing device 1016 via the direct write of the data to the buffer subsystem 1028a in the storage system 1028 of the secondary computing device 1016 prevents the main processing subsystem in the secondary computing device 1016 from being aware that the data is stored in the buffer subsystem 1028a in the storage system 1028 of the secondary computing device 1016 and, as such, the write completion communication from the primary computing device 1002 may serve the function of informing the secondary computing device 1016 of the presence of the data in the buffer subsystem 1028a in the storage system 1028 of the secondary computing device 1016.

The method 1300 then proceeds to block 1308 where the storage system in the secondary computing device copies the data from the buffer subsystem to a storage subsystem in the storage system. In an embodiment, at block 1308 and in response to the data being written to the buffer subsystem 1028a in the storage system 1028 of the secondary computing device 1016 (e.g., in response to being informed that the data has been written to the buffer subsystem 1028a in the storage system 1028 of the secondary computing device 1016), the secondary SDS engine in the secondary computing device 1016 may instruct its storage subsystem 1028 to copy the data from the buffer subsystem 1028a to the storage subsystem 1028b in the storage system 1028 of the secondary computing device 1016. For example, the secondary SDS engine in the secondary computing device 1016 may generate and transmit an NVMe write command to the storage system 1028 that identifies the data in the buffer subsystem 1028a as the source of the requested NVMe write operation.

As illustrated in FIG. 14D, in response to receiving the instruction to copy the data from the buffer subsystem 1028a to the storage subsystem 1028b in the storage system 1028 of the secondary computing device 1016, the storage system 1028 may perform a write operation 1406 to write the data from the buffer subsystem 1028a to the storage subsystem 1028b in the storage system 1028 of the secondary computing device 1016. For example, in embodiments in which the storage system 1028 is an NVMe SSD storage device 1028, block 1308 of the method 1300 may include the NVMe SSD storage device 1028 writing the data from the CMB subsystem 1028a to the flash storage subsystem 1028b in the NVMe SSD storage device 1028.

Thus, systems and methods have been described that provide for data mirroring in an SDS system using remote direct memory access operations in order to reduce the number of data transfer operations and memory system access operations required to achieve the data mirroring relative to conventional SDS systems. As will be appreciated by one of skill in the art in possession of the present disclosure, the data mirroring operations discussed above involve three data transfers (a first data transfer from the memory system 1008 to the storage system 1014, a second data transfer from the memory system 1008 to the communication system 1024, and a third data transfer from the communication system 1024 to the storage system 1028), two storage subsystem commands (a first write command to the storage system 1014, and a second write command to the storage subsystem 1028), and two memory system access operations (a first memory access operation to write the data from the memory system 1008 to the storage system 1014, and a second memory access operation to write the data from the memory system 1008 for transmission to the communication system 1024.) As such, the systems and methods of the present disclosure provide for a reduction in the number of data transfers (three data transfers vs. four data transfers in conventional SDS data mirroring systems) and memory access operations (two memory access operations vs. four memory access operations in conventional SDS data mirroring systems), thus providing for a more efficient data mirroring process.

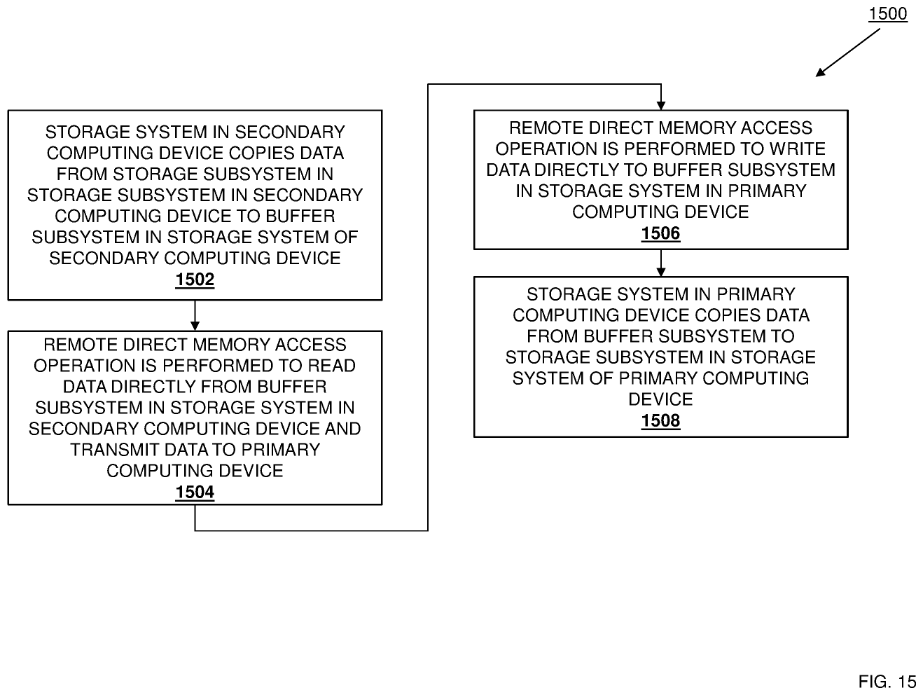

Referring now to FIG. 15, an embodiment of a method 1500 for SDS data recovery/rebuild/rebalance is illustrated. As discussed below, the systems and methods of the present disclosure provide for data recovery/rebuilding/rebalancing in an SDS system using remote direct memory access operations in order to reduce the number of data transfer operations and memory system access operations required to achieve the data mirroring relative to conventional SDS systems. For example, a secondary computing device may copy data from a secondary storage subsystem in a secondary storage system in the secondary computing device to a secondary buffer subsystem in the secondary storage system in the secondary computing device. The secondary computing device may then perform a remote direct memory access operation to read data from the secondary buffer subsystem and transmit the data to a primary computing device. The primary computing device may then perform a remote direct memory access operation to write the data directly to a primary buffer subsystem in a primary storage system in the primary computing device, with the primary storage system then writing the data from the primary buffer subsystem to a primary storage subsystem in the primary storage system in the primary computing device. As such, the number of data transfer operations and memory system access operations required to achieve data recovery/rebuilding/rebalancing is reduced relative to conventional SDS systems.

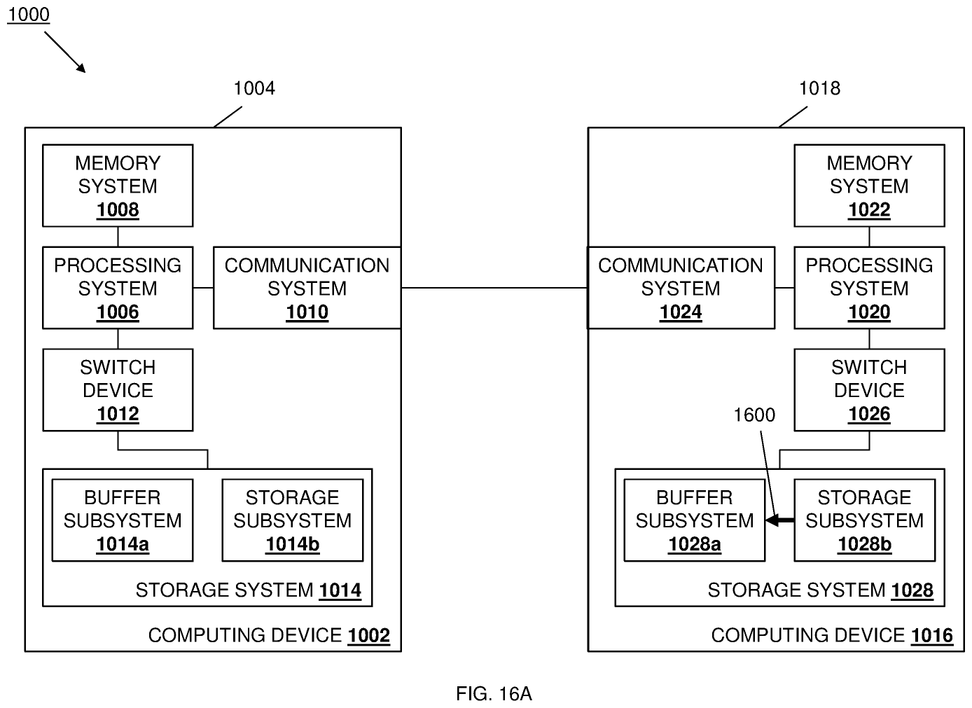

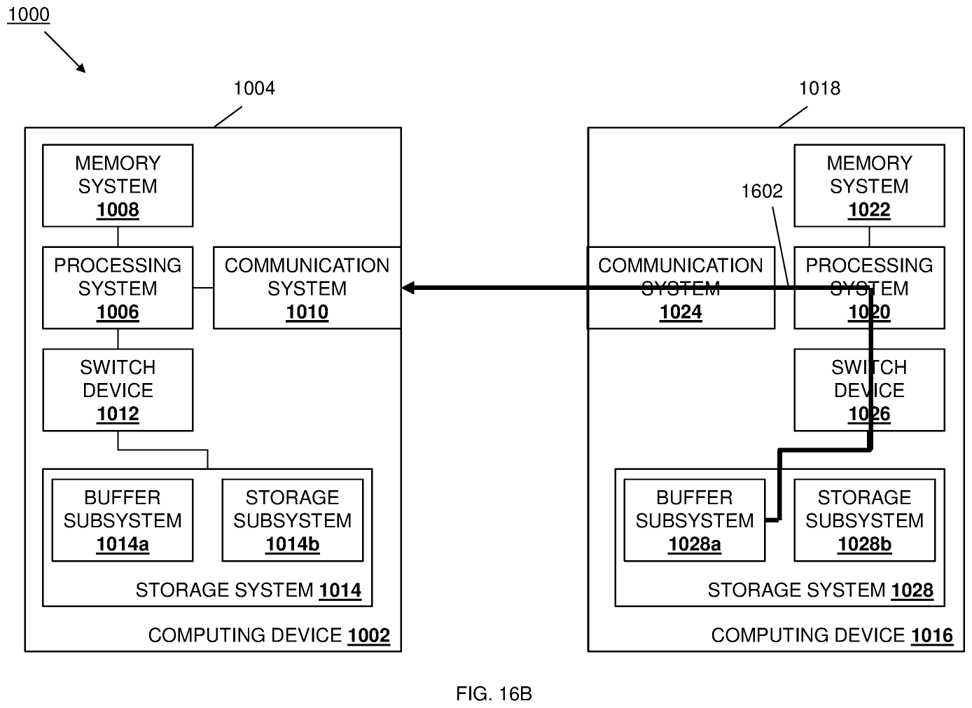

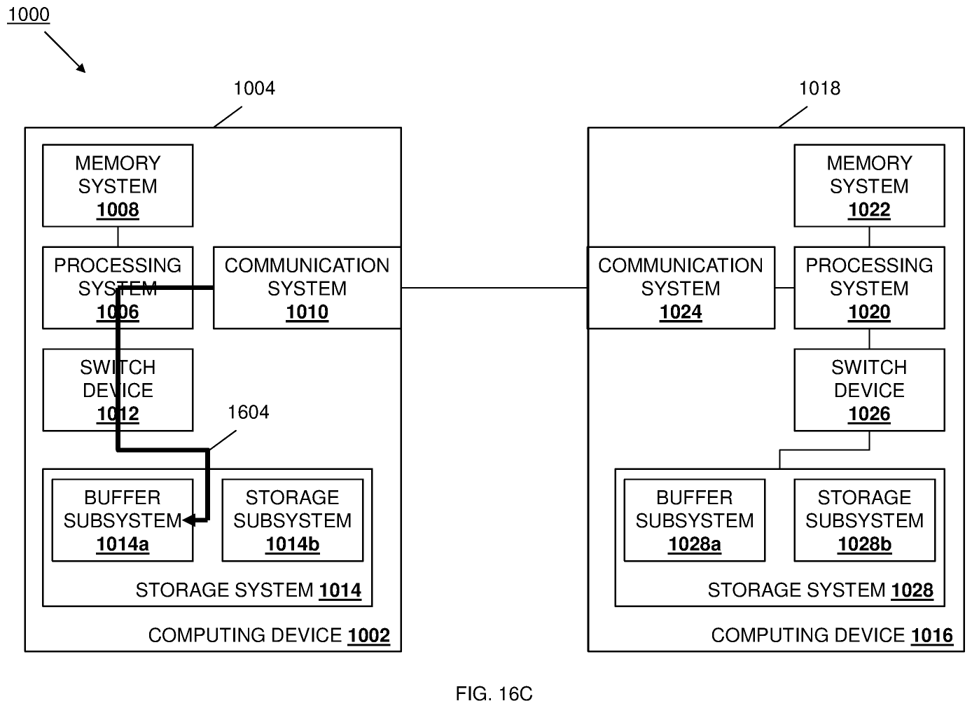

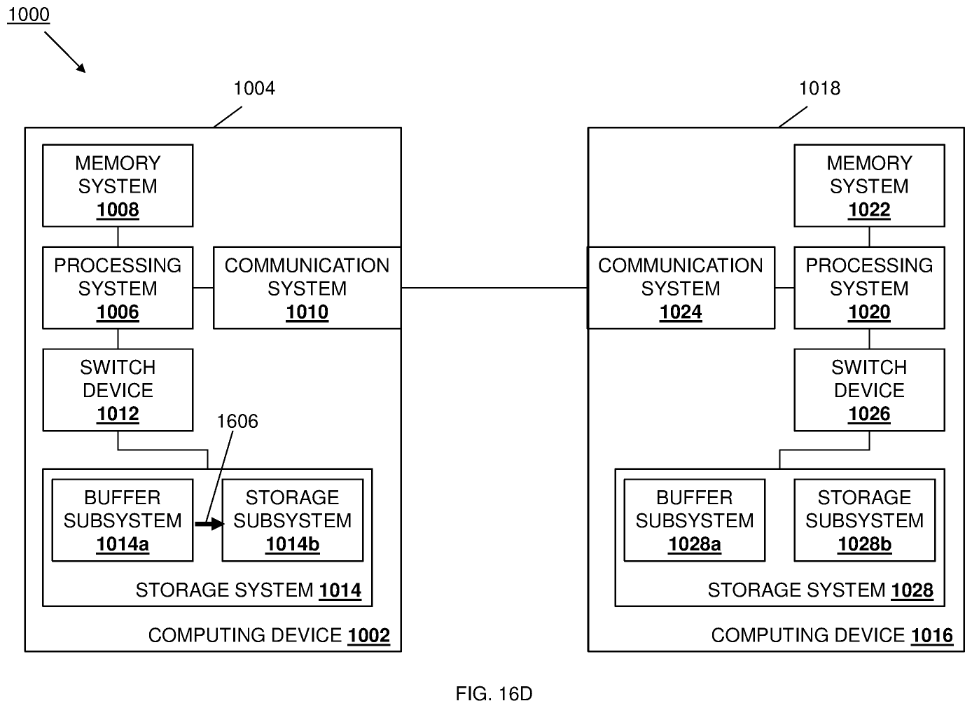

The method 1500 begins at block 1502 where data stored in a storage subsystem in a storage system on a secondary computing device is copied to a buffer subsystem in the storage system on the secondary computing device. In an embodiment, at block 1502 and in response to a data recovery/rebuild/rebalance instruction (e.g., in response to being informed that data on stored on the primary computing has become corrupted or otherwise unavailable, differs from the data stored on the secondary computing device in some way, and/or a variety of data recovery/rebuilding/rebalancing scenarios known in the art), the secondary SDS engine in the secondary computing device 1016 may instruct its storage subsystem 1028 to read the data from the storage subsystem 1028b to the buffer subsystem 1028a in the storage system 1028 of the secondary computing device 1016. As illustrated in FIG. 16A, in response to receiving the data recovery/rebuild/rebalance instruction, the storage system 1028 may perform a read operation 1600 to read the data from the storage subsystem 1028b to the buffer subsystem 1028a in the storage system 1028 of the secondary computing device 1016. For example, in embodiments in which the storage system 1028 is an NVMe SSD storage device 1028, block 1502 of the method 1500 may include the NVMe SSD storage device 1028 reading the data from flash storage subsystem 1028b to the CMB subsystem 1028a in the NVMe SSD storage device 1028.

The method 1500 then proceeds to block 1504 where a remote direct memory access operation is performed to read the data from the buffer subsystem in the storage system of the secondary computing device and transmit the data to the primary computing device. As illustrated in FIG. 16B, in an embodiment of block 1504, the secondary SDS engine in the secondary computing device 1016 may operate to perform an SDS RDMA Write operation 1602 that sources the data directly from the buffer subsystem 1028a in the storage system 1028 of the secondary computing device 1016 while bypassing the memory system 1022 in the secondary computing device 1016 (e.g., based on the designation of the buffer subsystem 1028a as a target for RDMA operations, similarly as discussed above.) For example, in embodiments in which the storage system 1028 in the secondary computing device 1016 is an NVMe SSD storage device 1028, block 1504 of the method 1500 may include the secondary SDS engine in the secondary computing device 1016 performing the SDS Write operation 1602 that sources the data directly from the CMB subsystem 1028a in the NVMe SSD storage device 1028 in the secondary computing device 1016 (e.g., based on the designation of the CMB subsystem 1028a as a target for RDMA operations, similarly as discussed above.)

The method 1500 then proceeds to block 1506 where the remote direct memory access operation continues with the writing of the data directly to a buffer subsystem in a storage system in the primary computing device. As illustrated in FIG. 16C, in an embodiment of block 1506, the primary SDS engine in the primary computing device 1002 may operate to perform an SDS RDMA write operation 1604 to write the data received at the communication system 1010 directly to the buffer subsystem 1014a in the storage system 1014 of the primary computing device 1002 while bypassing the memory system 1008 in the primary computing device 1002. For example, in embodiments in which the storage system 1014 in the secondary computing device 1016 is an NVMe SSD storage device 1014, block 1506 of the method 1500 may include the primary SDS engine in the primary computing device 1002 performing the SDS write operation 1604 to write the data that was received at the communication system 1010 in the primary computing device 1002 directly to the CMB subsystem 1014a in the NVMe SSD storage device 1014 in the primary computing device 1002.

The method 1500 then proceeds to block 1508 where the storage system in the primary computing device copies the data from the buffer subsystem to a storage subsystem in the storage system. In an embodiment, at block 1508 and in response to the data being written to the buffer subsystem 1014a in the storage system 1014 of the primary computing device 1002, the primary SDS engine in the primary computing device 1002 may instruct its storage subsystem 1014 to copy the data from the buffer subsystem 1014a to the storage subsystem 1014b in the storage system 1014 of the primary computing device 1002. For example, the primary SDS engine in the primary computing device 1002 may generate and transmit an NVMe write command to the storage system 1014 that identifies the data in the buffer subsystem 1014a as the source of the requested NVMe write operation

As illustrated in FIG. 16D, in response to receiving the instruction to copy the data from the buffer subsystem 1014a to the storage subsystem 1014b in the storage system 1014 of the primary computing device 1002, the storage system 1014 may perform a write operation 1606 to write the data from the buffer subsystem 1014a to the storage subsystem 1014b in the storage system 1014 of the primary computing device 1014. For example, in embodiments in which the storage system 1014 is an NVMe SSD storage device 1014, block 1508 of the method 1500 may include the NVMe SSD storage device 1014 writing the data from the CMB subsystem 1014a to the flash storage subsystem 1014b in the NVMe SSD storage device 1014.

Thus, systems and methods have been described that provide for data recovery/rebuild/rebalance in an SDS system using remote direct memory access operations in order to reduce the number of data transfer operations and memory system access operations required to achieve the data recovery/rebuilding/rebalancing relative to conventional SDS systems. As will be appreciated by one of skill in the art in possession of the present disclosure, the data recovery/rebuild/rebalance operations discussed above involve two data transfers (a first data transfer from the storage system 1028, and a second data transfer to the storage system 1014), two storage subsystem commands (a first read command from the storage system 1028, and a second write command to the storage subsystem 1014), and zero memory system access operations. As such, the systems and methods of the present disclosure provide for a reduction in the number of data transfers (two data transfers vs. four data transfers in conventional SDS data recovery/rebuild/rebalance systems) and memory access operations (zero memory access operations vs. four memory access operations in conventional SDS data recovery/rebuild/rebalance systems), thus providing for a more efficient data recovery/rebuild/rebalance process.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A data mirroring system, comprising:
a primary computing device that includes a primary memory system, a primary storage system, and a primary communication system, wherein the primary computing device is configured to:
write data to the primary memory system;
copy the data from the primary memory system to the primary storage system; and
transmit the data using the primary communication system; and
a secondary computing device that is coupled to the primary computing device, that includes a secondary memory system, a secondary storage system having a secondary buffer subsystem and a secondary storage subsystem, and a secondary communication system, wherein the secondary computing system is configured to:
receive the data at the secondary communication system;
perform a remote direct memory access operation to write the data to the secondary buffer subsystem in the secondary storage system such that the data is not stored in the secondary memory system; and
copy the data from the secondary buffer subsystem in the secondary storage system to the secondary storage subsystem in the secondary storage system.

2. The system of claim 1, wherein the secondary buffer subsystem in the secondary storage system is a Controller Memory Buffer (CMB) subsystem.

3. The system of claim 1, wherein the secondary computing device is configured to:
identify, to the primary computing device, the secondary buffer subsystem in the secondary storage system as a target for the remote direct memory access operation.

4. The system of claim 3, wherein the primary computing device is configured to:
identify, based on the identification of the secondary buffer subsystem as the target for remote direct memory access operations, a Scatter Gather List (SGL) as part of the remote direct memory access operation

5. The system of claim 1, wherein the secondary computing device is configured to:
transmit, to the primary computing device in response to writing the data to the secondary buffer subsystem in the secondary storage system, a first completion communication.

6. The system of claim 5, wherein the primary computing device is configured to:
transmit, to the secondary computing device in response to receiving the first completion communication, a second completion communication, wherein the secondary computing device is configured to copy the data from the secondary buffer subsystem in the secondary storage system to the secondary storage subsystem in the secondary storage system in response to receiving the second completion communication.

7. The system of claim 1, wherein the primary storage system is provided by a primary Non-Volatile Memory express (NVMe) storage system, and the secondary storage system is provided by a secondary NVMe storage system.

8. An Information Handling System (IHS), comprising:
a chassis;
a Software Defined Storage (SDS) processing system that is included in the chassis; and
an SDS memory subsystem that is included in the chassis, coupled to the SDS processing system, and that includes instructions that, when executed by the SDS processing system, cause the SDS processing system to provide a data mirroring engine that is configured to:
receive, from a primary computing device via a communication system that is included in the chassis, data that has been stored in the primary computing device;
perform a remote direct memory access operation to write the data to a buffer subsystem in a storage system that is included in the chassis such that the data is not stored in a main memory subsystem that is included in the chassis; and
copy the data from the buffer subsystem in the storage system to a storage subsystem in the storage system.

9. The IHS of claim 8, wherein the buffer subsystem in the storage system is a Controller Memory Buffer (CMB) subsystem.

10. The IHS of claim 8, wherein the data mirroring engine is configured to:
identify, to the primary computing device, the buffer subsystem in the storage system as a target for the remote direct memory access operation.

11. The IHS of claim 8, wherein the data mirroring engine is configured to:
transmit, to the primary computing device in response to writing the data to the buffer subsystem in the storage system, a first completion communication.

12. The IHS of claim 11, wherein the data mirroring engine is configured to:
receive, from the primary computing device subsequent to transmitting the first completion communication, a second completion communication; and
copy the data from the buffer subsystem in the storage system to the storage subsystem in the storage system in response to receiving the second completion communication.

13. The IHS of claim 8, wherein the storage system is provided by a Non-Volatile Memory express (NVMe) storage system.

14. A method for mirroring data, comprising:
receiving, by a secondary computing device from a primary computing device via a secondary communication system that is included in the secondary computing device, data that has been stored in the primary computing device;
performing, by the secondary computing device, a remote direct memory access operation to write the data to a secondary buffer subsystem in a secondary storage system that is included in the secondary computing device such that the data is not stored in a secondary memory subsystem that is included in the secondary computing device; and
copying, by the secondary computing device, the data from the secondary buffer subsystem in the secondary storage system to a secondary storage subsystem in the secondary storage system.

15. The method of claim 14, wherein the secondary buffer subsystem in the secondary storage system is a Controller Memory Buffer (CMB) subsystem.

16. The method of claim 14, further comprising:
identifying, by the secondary computing device to the primary computing device, the secondary buffer subsystem in the secondary storage system as a target for the remote direct memory access operation.

17. The method of claim 16, further comprising:
identifying, by the primary computing device based on the identification of the secondary buffer subsystem as the target for remote direct memory access operations, a Scatter Gather List (SGL) as part of the remote direct memory access operation.

18. The method of claim 14, further comprising:
transmitting, by the secondary computing device to the primary computing device in response to writing the data to the secondary buffer subsystem in the secondary storage system, a first completion communication.

19. The method of claim 18, further comprising:
receiving, by the secondary computing device from the primary computing device subsequent to transmitting the first completion communication, a second completion communication; and
copying, by the secondary computing device, the data from the buffer subsystem in the storage system to the storage subsystem in the storage system in response to receiving the second completion communication.

20. The method of claim 14, wherein the secondary storage system is provided by a Non-Volatile Memory express (NVMe) storage system.
